(19) United States
(12) Patent Application Publication
(10) Pub. No.: US 2024/0334222 A1
(43) Pub. Date: Oct. 3, 2024

(54) Packet Performance Measurement

(71) Applicant: Ofinno, LLC, Reston, VA (US)

(72) Inventors: Peyman Talebi Fard, Vienna, VA (US); SungDuck Chun, Fairfax, VA (US); Esmael Hejazi Dinan, McLean, VA (US)

(73) Assignee: Ofinno, LLC, Reston, VA (US)

(21) Appl. No.: 18/620,378

(22) Filed: Mar. 28, 2024

Related U.S. Application Data
(60) Provisional application No. 63/456,285, filed on Mar. 31, 2023.

(51) Int. Cl. H04W 24/08

(52) U.S. Cl. CPC H04W 24/08

(57) ABSTRACT

A user plane function (UPF) receives, from a network node, a message requesting a per packet performance measurement, the message comprising a parameter indicating configuration of the per packet performance measurement.

### CROSS-REFERENCE TO RELATED APPLICATIONS

This application claims the benefit of U.S. Provisional Application No. 63/456,285, filed Mar. 31, 2023, which is hereby incorporated by reference in its entirety.

### BRIEF DESCRIPTION OF THE DRAWINGS

Examples of several of the various embodiments of the present disclosure are described herein with reference to the drawings.

FIG. 1A and FIG. 1B illustrate example communication networks including an access network and a core network.

FIG. 2A, FIG. 2B, FIG. 2C, and FIG. 2D illustrate various examples of a framework for a service-based architecture within a core network.

FIG. 3 illustrates an example communication network including core network functions.

FIG. 4A and FIG. 4B illustrate example of core network architecture with multiple user plane functions and untrusted access.

FIG. 5 illustrates an example of a core network architecture for a roaming scenario.

FIG. 6 illustrates an example of network slicing.

FIG. 7A, FIG. 7B, and FIG. 7C illustrate a user plane protocol stack, a control plane protocol stack, and services provided between protocol layers of the user plane protocol stack.

FIG. 8 illustrates an example of a quality of service model for data exchange.

FIG. 9A, FIG. 9B, FIG. 9C, and FIG. 9D illustrate example states and state transitions of a wireless device.

FIG. 10 illustrates an example of a registration procedure for a wireless device.

FIG. 11 illustrates an example of a service request procedure for a wireless device.

FIG. 12 illustrates an example of a protocol data unit session establishment procedure for a wireless device.

FIG. 13 illustrates examples of components of the elements in a communications network.

FIG. 14A, FIG. 14B, FIG. 14C, and FIG. 14D illustrate various examples of physical core network deployments, each having one or more network functions or portions thereof.

FIG. 15 illustrates an example embodiment of a present disclosure.

FIG. 16 illustrates an example embodiment of a present disclosure.

FIG. 17 illustrates an example embodiment of a present disclosure.

FIG. 18 illustrates an example embodiment of a present disclosure.

FIG. 19 illustrates an example embodiment of a present disclosure.

FIG. 20 illustrates an example embodiment of a present disclosure.

FIG. 21 illustrates an example embodiment of a present disclosure.

FIG. 22 illustrates an example embodiment of a present disclosure.

FIG. 23 illustrates an example embodiment of a present disclosure.

FIG. 24 illustrates an example embodiment of a present disclosure.

FIG. 25 illustrates an example embodiment of a present disclosure.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. In fact, after reading the description, it will be apparent to one skilled in the relevant art how to implement alternative embodiments. The present embodiments should not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a wireless device, a base station, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

A base station may communicate with a mix of wireless devices. Wireless devices and/or base stations may support multiple technologies, and/or multiple releases of the same technology. Wireless devices may have one or more specific capabilities. When this disclosure refers to a base station communicating with a plurality of wireless devices, this disclosure may refer to a subset of the total wireless devices in a coverage area. This disclosure may refer to, for example, a plurality of wireless devices of a given LTE or 5G release with a given capability and in a given sector of the base station. The plurality of wireless devices in this disclosure may refer to a selected plurality of wireless devices, and/or a subset of total wireless devices in a coverage area which perform according to disclosed methods, and/or the like. There may be a plurality of base stations or a plurality of wireless devices in a coverage area that may not comply with the disclosed methods, for example, those wireless devices or base stations may perform based on older releases of LTE or 5G technology.

In this disclosure, “a” and “an” and similar phrases refer to a single instance of a particular element, but should not be interpreted to exclude other instances of that element. For example, a bicycle with two wheels may be described as having “a wheel”. Any term that ends with the suffix “(s)” is to be interpreted as “at least one” and/or “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described.

The phrases “based on”, “in response to”, “depending on”, “employing”, “using”, and similar phrases indicate the presence and/or influence of a particular factor and/or condition on an event and/or action, but do not exclude unenumerated factors and/or conditions from also being present and/or influencing the event and/or action. For example, if action X is performed “based on” condition Y, this is to be interpreted as the action being performed “based at least on” condition Y. For example, if the performance of action X is performed when conditions Y and Z are both satisfied, then the performing of action X may be described as being “based on Y”.

The term “configured” may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, a parameter may comprise one or more information objects, and an information object may comprise one or more other objects. For example, if parameter J comprises parameter K, and parameter K comprises parameter L, and parameter L comprises parameter M, then J comprises L, and J comprises M. A parameter may be referred to as a field or information element. In an example embodiment, when one or more messages comprise a plurality of parameters, it implies that a parameter in the plurality of parameters is in at least one of the one or more messages, but does not have to be in each of the one or more messages.

This disclosure may refer to possible combinations of enumerated elements. For the sake of brevity and legibility, the present disclosure does not explicitly recite each and every permutation that may be obtained by choosing from a set of optional features. The present disclosure is to be interpreted as explicitly disclosing all such permutations. For example, the seven possible combinations of enumerated elements A, B, C consist of: (1) “A”; (2) “B”; (3) “C”; (4) “A and B”; (5) “A and C”; (6) “B and C”; and (7) “A, B, and C”. For the sake of brevity and legibility, these seven possible combinations may be described using any of the following interchangeable formulations: “at least one of A, B, and C”; “at least one of A, B, or C”; “one or more of A, B, and C”; “one or more of A, B, or C”; “A, B, and/or C”. It will be understood that impossible combinations are excluded. For example, “X and/or not-X” should be interpreted as “X or not-X”. It will be further understood that these formulations may describe alternative phrasings of overlapping and/or synonymous concepts, for example, “identifier, identification, and/or ID number”.

This disclosure may refer to sets and/or subsets. As an example, set X may be a set of elements comprising one or more elements. If every element of X is also an element of Y, then X may be referred to as a subset of Y. In this disclosure, only non-empty sets and subsets are considered. For example, if Y consists of the elements Y1, Y2, and Y3, then the possible subsets of Y are {Y1, Y2, Y3}, {Y1, Y2}, {Y1, Y3}, {Y2, Y3}, {Y1}, {Y2}, and {Y3}.

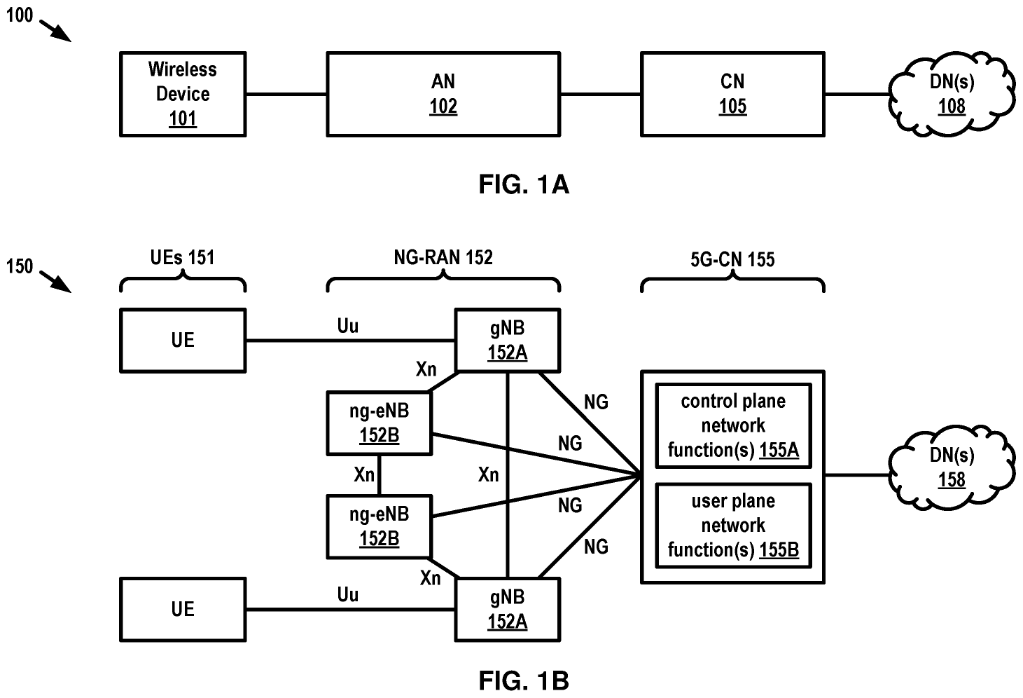

FIG. 1A illustrates an example of a communication network 100 in which embodiments of the present disclosure may be implemented. The communication network 100 may comprise, for example, a public land mobile network (PLMN) run by a network operator. As illustrated in FIG. 1A, the communication network 100 includes a wireless device 101, an access network (AN) 102, a core network (CN) 105, and one or more data network (DNs) 108.

The wireless device 101 may communicate with DNs 108 via AN 102 and CN 105.

In the present disclosure, the term wireless device may refer to and encompass any mobile device or fixed (non-mobile) device for which wireless communication is needed or usable. For example, a wireless device may be a telephone, smart phone, tablet, computer, laptop, sensor, meter, wearable device, Internet of Things (IoT) device, vehicle road side unit (RSU), relay node, automobile, unmanned aerial vehicle, urban air mobility, and/or any combination thereof. The term wireless device encompasses other terminology, including user equipment (UE), user terminal (UT), access terminal (AT), mobile station, handset, wireless transmit and receive unit (WTRU), and/or wireless communication device.

The AN 102 may connect wireless device 101 to CN 105 in any suitable manner. The communication direction from the AN 102 to the wireless device 101 is known as the downlink and the communication direction from the wireless device 101 to AN 102 is known as the uplink. Downlink transmissions may be separated from uplink transmissions using frequency division duplexing (FDD), time-division duplexing (TDD), and/or some combination of the two duplexing techniques. The AN 102 may connect to wireless device 101 through radio communications over an air interface. An access network that at least partially operates over the air interface may be referred to as a radio access network (RAN). The CN 105 may set up one or more end-to-end connection between wireless device 101 and the one or more DNs 108. The CN 105 may authenticate wireless device 101 and provide charging functionality.

In the present disclosure, the term base station may refer to and encompass any element of AN 102 that facilitates communication between wireless device 101 and AN 102. Access networks and base stations have many different names and implementations. The base station may be a terrestrial base station fixed to the earth. The base station may be a mobile base station with a moving coverage area. The base station may be in space, for example, on board a satellite. For example, WiFi and other standards may use the term access point. As another example, the Third-Generation Partnership Project (3GPP) has produced specifications for three generations of mobile networks, each of which uses different terminology. Third Generation (3G) and/or Universal Mobile Telecommunications System (UMTS) standards may use the term Node B. 4G, Long Term Evolution (LTE), and/or Evolved Universal Terrestrial Radio Access (E-UTRA) standards may use the term Evolved Node B (eNB). 5G and/or New Radio (NR) standards may describe AN 102 as a next-generation radio access network (NG-RAN) and may refer to base stations as Next Generation eNB (ng-eNB) and/or Generation Node B (gNB). Future standards (for example, 6G, 7G, 8G) may use new terminology to refer to the elements which implement the methods described in the present disclosure (e.g., wireless devices, base stations, ANs, CNs, and/or components thereof). A base station may be implemented as a repeater or relay node used to extend the coverage area of a donor node. A repeater node may amplify and rebroadcast a radio signal received from a donor node. A relay node may perform the same/similar functions as a repeater node but may decode the radio signal received from the donor node to remove noise before amplifying and rebroadcasting the radio signal.

The AN 102 may include one or more base stations, each having one or more coverage areas. The geographical size and/or extent of a coverage area may be defined in terms of a range at which a receiver of AN 102 can successfully receive transmissions from a transmitter (e.g., wireless device 101) operating within the coverage area (and/or vice-versa). The coverage areas may be referred to as sectors or cells (although in some contexts, the term cell refers to the carrier frequency used in a particular coverage area, rather than the coverage area itself). Base stations with large coverage areas may be referred to as macrocell base stations. Other base stations cover smaller areas, for example, to provide coverage in areas with weak macrocell coverage, or to provide additional coverage in areas with high traffic (sometimes referred to as hotspots). Examples of small cell base stations include, in order of decreasing coverage area, microcell base stations, picocell base stations, and femtocell base stations or home base stations. Together, the coverage areas of the base stations may provide radio coverage to wireless device 101 over a wide geographic area to support wireless device mobility.

A base station may include one or more sets of antennas for communicating with the wireless device 101 over the air interface. Each set of antennas may be separately controlled by the base station. Each set of antennas may have a corresponding coverage area. As an example, a base station may include three sets of antennas to respectively control three coverage areas on three different sides of the base station. The entirety of the base station (and its corresponding antennas) may be deployed at a single location. Alternatively, a controller at a central location may control one or more sets of antennas at one or more distributed locations. The controller may be, for example, a baseband processing unit that is part of a centralized or cloud RAN architecture. The baseband processing unit may be either centralized in a pool of baseband processing units or virtualized. A set of antennas at a distributed location may be referred to as a remote radio head (RRH).

FIG. 1B illustrates another example communication network 150 in which embodiments of the present disclosure may be implemented. The communication network 150 may comprise, for example, a PLMN run by a network operator. As illustrated in FIG. 1B, communication network 150 includes UEs 151, a next generation radio access network (NG-RAN) 152, a 5G core network (5G-CN) 155, and one or more DNs 158. The NG-RAN 152 includes one or more base stations, illustrated as generation node Bs (gNBs) 152A and next generation evolved Node Bs (ng eNBs) 152B. The 5G-CN 155 includes one or more network functions (NFs), including control plane functions 155A and user plane functions 155B. The one or more DNs 158 may comprise public DNs (e.g., the Internet), private DNs, and/or intra-operator DNs. Relative to corresponding components illustrated in FIG. 1A, these components may represent specific implementations and/or terminology.

The base stations of the NG-RAN 152 may be connected to the UEs 151 via Uu interfaces. The base stations of the NG-RAN 152 may be connected to each other via Xn interfaces. The base stations of the NG-RAN 152 may be connected to 5G CN 155 via NG interfaces. The Uu interface may include an air interface. The NG and Xn interfaces may include an air interface, or may consist of direct physical connections and/or indirect connections over an underlying transport network (e.g., an internet protocol (IP) transport network).

Each of the Uu, Xn, and NG interfaces may be associated with a protocol stack. The protocol stacks may include a user plane (UP) and a control plane (CP). Generally, user plane data may include data pertaining to users of the UEs 151, for example, internet content downloaded via a web browser application, sensor data uploaded via a tracking application, or email data communicated to or from an email server. Control plane data, by contrast, may comprise signaling and messages that facilitate packaging and routing of user plane data so that it can be exchanged with the DN(s). The NG interface, for example, may be divided into an NG user plane interface (NG-U) and an NG control plane interface (NG-C). The NG-U interface may provide delivery of user plane data between the base stations and the one or more user plane network functions 155B. The NG-C interface may be used for control signaling between the base stations and the one or more control plane network functions 155A. The NG-C interface may provide, for example, NG interface management, UE context management, UE mobility management, transport of NAS messages, paging, PDU session management, and configuration transfer and/or warning message transmission. In some cases, the NG-C interface may support transmission of user data (for example, a small data transmission for an IoT device).

One or more of the base stations of the NG-RAN 152 may be split into a central unit (CU) and one or more distributed units (DUs). A CU may be coupled to one or more DUs via an F1 interface. The CU may handle one or more upper layers in the protocol stack and the DU may handle one or more lower layers in the protocol stack. For example, the CU may handle RRC, PDCP, and SDAP, and the DU may handle RLC, MAC, and PHY. The one or more DUs may be in geographically diverse locations relative to the CU and/or each other. Accordingly, the CU/DU split architecture may permit increased coverage and/or better coordination.

The gNBs 152A and ng-eNBs 152B may provide different user plane and control plane protocol termination towards the UEs 151. For example, the gNB 154A may provide new radio (NR) protocol terminations over a Uu interface associated with a first protocol stack. The ng-eNBs 152B may provide Evolved UMTS Terrestrial Radio Access (E-UTRA) protocol terminations over a Uu interface associated with a second protocol stack.

The 5G-CN 155 may authenticate UEs 151, set up end-to-end connections between UEs 151 and the one or more DNs 158, and provide charging functionality. The 5G-CN 155 may be based on a service-based architecture, in which the NFs making up the 5G-CN 155 offer services to each other and to other elements of the communication network 150 via interfaces. The 5G-CN 155 may include any number of other NFs and any number of instances of each NF.

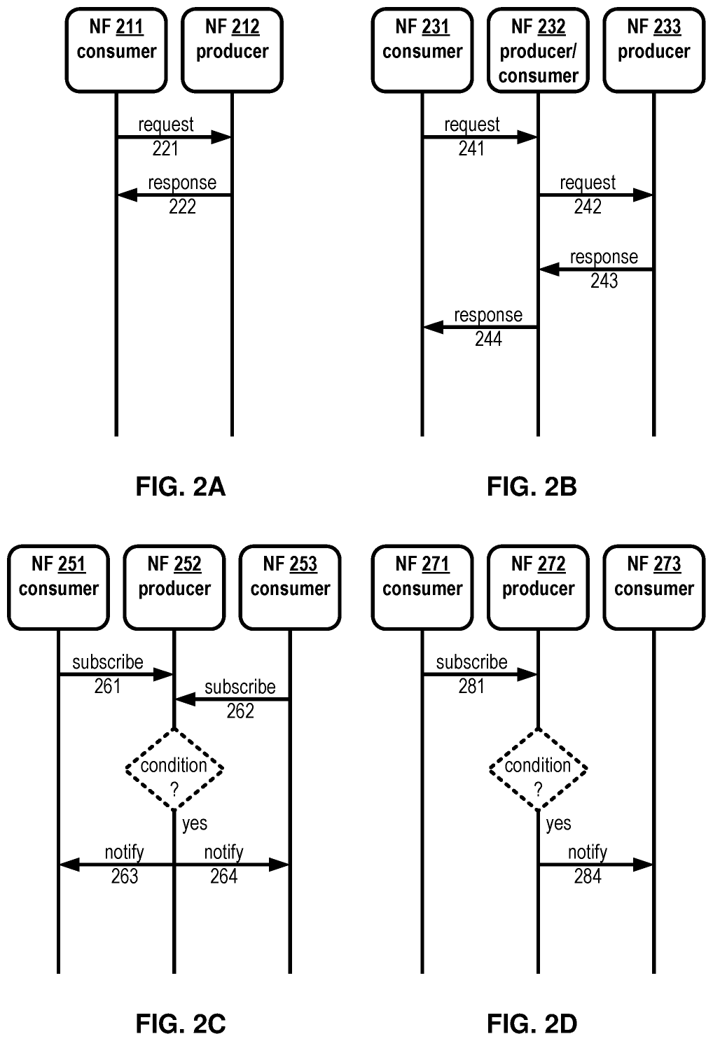

FIG. 2A, FIG. 2B, FIG. 2C, and FIG. 2D illustrate various examples of a framework for a service-based architecture within a core network. In a service-based architecture, a service may be sought by a service consumer and provided by a service producer. Prior to obtaining a particular service, an NF may determine where such as service can be obtained. To discover a service, the NF may communicate with a network repository function (NRF). As an example, an NF that provides one or more services may register with a network repository function (NRF). The NRF may store data relating to the one or more services that the NF is prepared to provide to other NFs in the service-based architecture. A consumer NF may query the NRF to discover a producer NF (for example, by obtaining from the NRF a list of NF instances that provide a particular service).

In the example of FIG. 2A, an NF 211 (a consumer NF in this example) may send a request 221 to an NF 212 (a producer NF). The request 221 may be a request for a particular service and may be sent based on a discovery that NF 212 is a producer of that service. The request 221 may comprise data relating to NF 211 and/or the requested service. The NF 212 may receive request 221, perform one or more actions associated with the requested service (e.g., retrieving data), and provide a response 221. The one or more actions performed by the NF 212 may be based on request data included in the request 221, data stored by NF 212, and/or data retrieved by NF 212. The response 222 may notify NF 211 that the one or more actions have been completed. The response 222 may comprise response data relating to NF 212, the one or more actions, and/or the requested service.

In the example of FIG. 2B, an NF 231 sends a request 241 to an NF 232. In this example, part of the service produced by NF 232 is to send a request 242 to an NF 233. The NF 233 may perform one or more actions and provide a response 243 to NF 232. Based on response 243, NF 232 may send a response 244 to NF 231. It will be understood from FIG. 2B that a single NF may perform the role of producer of services, consumer of services, or both. A particular NF service may include any number of nested NF services produced by one or more other NFs.

FIG. 2C illustrates examples of subscribe-notify interactions between a consumer NF and a producer NF. In FIG. 2C, an NF 251 sends a subscription 261 to an NF 252. An NF 253 sends a subscription 262 to the NF 252. Two NFs are shown in FIG. 2C for illustrative purposes (to demonstrate that the NF 252 may provide multiple subscription services to different NFs), but it will be understood that a subscribe-notify interaction only requires one subscriber. The NFs 251, 253 may be independent from one another. For example, the NFs 251, 253 may independently discover NF 252 and/or independently determine to subscribe to the service offered by NF 252. In response to receipt of a subscription, the NF 252 may provide a notification to the subscribing NF. For example, NF 252 may send a notification 263 to NF 251 based on subscription 261 and may send a notification 264 to NF 253 based on subscription 262.

As shown in the example illustration of FIG. 2C, the sending of the notifications 263, 264 may be based on a determination that a condition has occurred. For example, the notifications 263, 264 may be based on a determination that a particular event has occurred, a determination that a particular condition is outstanding, and/or a determination that a duration of time associated with the subscription has elapsed (for example, a period associated with a subscription for periodic notifications). As shown in the example illustration of FIG. 2C, NF 252 may send notifications 263, 264 to NFs 251, 253 simultaneously and/or in response to the same condition. However, it will be understood that the NF 252 may provide notifications at different times and/or in response to different notification conditions. In an example, the NF 251 may request a notification when a certain parameter, as measured by the NF 252, exceeds a first threshold, and the NF 252 may request a notification when the parameter exceeds a second threshold different from the first threshold. In an example, a parameter of interest and/or a corresponding threshold may be indicated in the subscriptions 261, 262.

FIG. 2D illustrates another example of a subscribe-notify interaction. In FIG. 2D, an NF 271 sends a subscription 281 to an NF 272. In response to receipt of subscription 281 and/or a determination that a notification condition has occurred, NF 272 may send a notification 284. The notification 284 may be sent to an NF 273. Unlike the example in FIG. 2C (in which a notification is sent to the subscribing NF), FIG. 2D demonstrates that a subscription and its corresponding notification may be associated with different NFs. For example, NF 271 may subscribe to the service provided by NF 272 on behalf of NF 273.

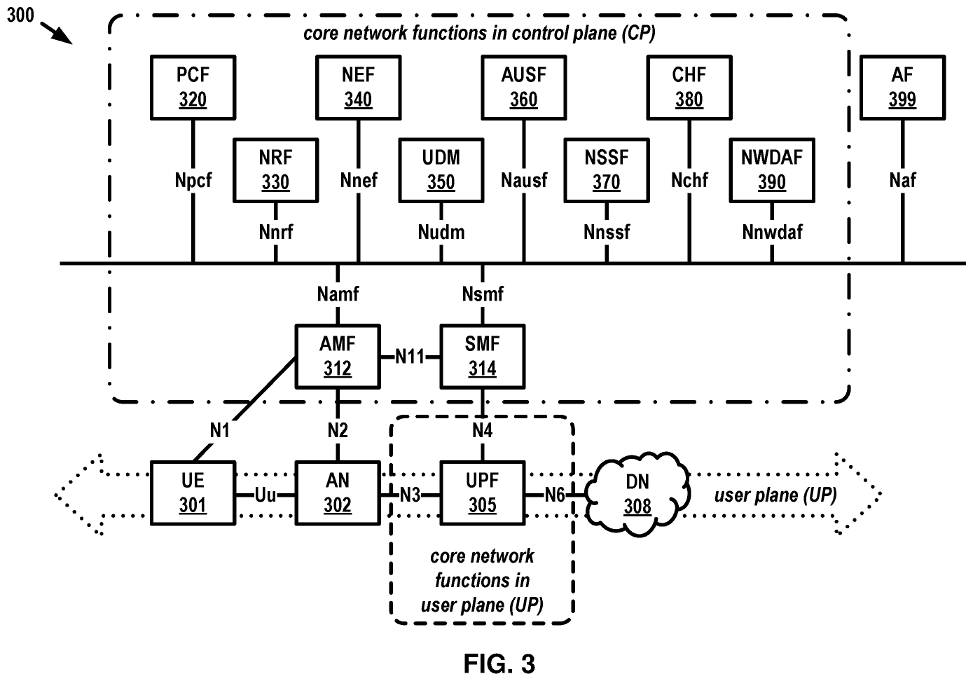

FIG. 3 illustrates another example communication network 300 in which embodiments of the present disclosure may be implemented. Communication network 300 includes a user equipment (UE) 301, an access network (AN) 302, and a data network (DN) 308. The remaining elements depicted in FIG. 3 may be included in and/or associated with a core network. Each element of the core network may be referred to as a network function (NF).

The NFs depicted in FIG. 3 include a user plane function (UPF) 305, an access and mobility management function (AMF) 312, a session management function (SMF) 314, a policy control function (PCF) 320, a network repository function (NRF) 330, a network exposure function (NEF) 340, a unified data management (UDM) 350, an authentication server function (AUSF) 360, a network slice selection function (NSSF) 370, a charging function (CHF) 380, a network data analytics function (NWDAF) 390, and an application function (AF) 399. The UPF 305 may be a user-plane core network function, whereas the NFs 312, 314, and 320-390 may be control-plane core network functions. Although not shown in the example of FIG. 3, the core network may include additional instances of any of the NFs depicted and/or one or more different NF types that provide different services. Other examples of NF type include a gateway mobile location center (GMLC), a location management function (LMF), an operations, administration, and maintenance function (OAM), a public warning system (PWS), a short message service function (SMSF), a unified data repository (UDR), and an unstructured data storage function (UDSF).

Each element depicted in FIG. 3 has an interface with at least one other element. The interface may be a logical connection rather than, for example, a direct physical connection. Any interface may be identified using a reference point representation and/or a service-based representation. In a reference point representation, the letter ‘N’ is followed by a numeral, indicating an interface between two specific elements. For example, as shown in FIG. 3, AN 302 and UPF 305 interface via ‘N3’, whereas UPF 305 and DN 308 interface via ‘N6’. By contrast, in a service-based representation, the letter ‘N’ is followed by letters. The letters identify an NF that provides services to the core network. For example, PCF 320 may provide services via interface ‘Npcf’. The PCF 320 may provide services to any NF in the core network via ‘Npcf’. Accordingly, a service-based representation may correspond to a bundle of reference point representations. For example, the Npcf interface between PCF 320 and the core network generally may correspond to an N7 interface between PCF 320 and SMF 314, an N30 interface between PCF 320 and NEF 340, etc.

The UPF 305 may serve as a gateway for user plane traffic between AN 302 and DN 308. The UE 301 may connect to UPF 305 via a Uu interface and an N3 interface (also described as NG-U interface). The UPF 305 may connect to DN 308 via an N6 interface. The UPF 305 may connect to one or more other UPFs (not shown) via an N9 interface. The UE 301 may be configured to receive services through a protocol data unit (PDU) session, which is a logical connection between UE 301 and DN 308. The UPF 305 (or a plurality of UPFs if desired) may be selected by SMF 314 to handle a particular PDU session between UE 301 and DN 308. The SMF 314 may control the functions of UPF 305 with respect to the PDU session. The SMF 314 may connect to UPF 305 via an N4 interface. The UPF 305 may handle any number of PDU sessions associated with any number of UEs (via any number of ANs). For purposes of handling the one or more PDU sessions, UPF 305 may be controlled by any number of SMFs via any number of corresponding N4 interfaces.

The AMF 312 depicted in FIG. 3 may control UE access to the core network. The UE 301 may register with the network via AMF 312. It may be necessary for UE 301 to register prior to establishing a PDU session. The AMF 312 may manage a registration area of UE 301, enabling the network to track the physical location of UE 301 within the network. For a UE in connected mode, AMF 312 may manage UE mobility, for example, handovers from one AN or portion thereof to another. For a UE in idle mode, AMF 312 may perform registration updates and/or page the UE to transition the UE to connected mode.

The AMF 312 may receive, from UE 301, non-access stratum (NAS) messages transmitted in accordance with NAS protocol. NAS messages relate to communications between UE 301 and the core network. Although NAS messages may be relayed to AMF 312 via AN 302, they may be described as communications via the N1 interface. NAS messages may facilitate UE registration and mobility management, for example, by authenticating, identifying, configuring, and/or managing a connection of UE 301. NAS messages may support session management procedures for maintaining user plane connectivity and quality of service (QoS) of a session between UE 301 and DN 309. If the NAS message involves session management, AMF 312 may send the NAS message to SMF 314. NAS messages may be used to transport messages between UE 301 and other components of the core network (e.g., core network components other than AMF 312 and SMF 314). The AMF 312 may act on a particular NAS message itself, or alternatively, forward the NAS message to an appropriate core network function (e.g., SMF 314, etc.)

The SMF 314 depicted in FIG. 3 may establish, modify, and/or release a PDU session based on messaging received UE 301. The SMF 314 may allocate, manage, and/or assign an IP address to UE 301, for example, upon establishment of a PDU session. There may be multiple SMFs in the network, each of which may be associated with a respective group of wireless devices, base stations, and/or UPFs. A UE with multiple PDU sessions may be associated with a different SMF for each PDU session. As noted above, SMF 314 may select one or more UPFs to handle a PDU session and may control the handling of the PDU session by the selected UPF by providing rules for packet handling (PDR, FAR, QER, etc.). Rules relating to QoS and/or charging for a particular PDU session may be obtained from PCF 320 and provided to UPF 305.

The PCF 320 may provide, to other NFs, services relating to policy rules. The PCF 320 may use subscription data and information about network conditions to determine policy rules and then provide the policy rules to a particular NF which may be responsible for enforcement of those rules. Policy rules may relate to policy control for access and mobility, and may be enforced by the AMF. Policy rules may relate to session management, and may be enforced by the SMF 314. Policy rules may be, for example, network-specific, wireless device-specific, session-specific, or data flow-specific.

The NRF 330 may provide service discovery. The NRF 330 may belong to a particular PLMN. The NRF 330 may maintain NF profiles relating to other NFs in the communication network 300. The NF profile may include, for example, an address, PLMN, and/or type of the NF, a slice identifier, a list of the one or more services provided by the NF, and the authorization required to access the services.

The NEF 340 depicted in FIG. 3 may provide an interface to external domains, permitting external domains to selectively access the control plane of the communication network 300. The external domain may comprise, for example, third-party network functions, application functions, etc. The NEF 340 may act as a proxy between external elements and network functions such as AMF 312, SMF 314, PCF 320, UDM 350, etc. As an example, NEF 340 may determine a location or reachability status of UE 301 based on reports from AMF 312, and provide status information to an external element. As an example, an external element may provide, via NEF 340, information that facilitates the setting of parameters for establishment of a PDU session. The NEF 340 may determine which data and capabilities of the control plane are exposed to the external domain. The NEF 340 may provide secure exposure that authenticates and/or authorizes an external entity to which data or capabilities of the communication network 300 are exposed. The NEF 340 may selectively control the exposure such that the internal architecture of the core network is hidden from the external domain.

The UDM 350 may provide data storage for other NFs. The UDM 350 may permit a consolidated view of network information that may be used to ensure that the most relevant information can be made available to different NFs from a single resource. The UDM 350 may store and/or retrieve information from a unified data repository (UDR). For example, UDM 350 may obtain user subscription data relating to UE 301 from the UDR.

The AUSF 360 may support mutual authentication of UE 301 by the core network and authentication of the core network by UE 301. The AUSF 360 may perform key agreement procedures and provide keying material that can be used to improve security.

The NSSF 370 may select one or more network slices to be used by the UE 301. The NSSF 370 may select a slice based on slice selection information. For example, the NSSF 370 may receive Single Network Slice Selection Assistance Information (S-NSSAI) and map the S-NSSAI to a network slice instance identifier (NSI).

The CHF 380 may control billing-related tasks associated with UE 301. For example, UPF 305 may report traffic usage associated with UE 301 to SMF 314. The SMF 314 may collect usage data from UPF 305 and one or more other UPFs. The usage data may indicate how much data is exchanged, what DN the data is exchanged with, a network slice associated with the data, or any other information that may influence billing. The SMF 314 may share the collected usage data with the CHF. The CHF may use the collected usage data to perform billing-related tasks associated with UE 301. The CHF may, depending on the billing status of UE 301, instruct SMF 314 to limit or influence access of UE 301 and/or to provide billing-related notifications to UE 301.

The NWDAF 390 may collect and analyze data from other network functions and offer data analysis services to other network functions. As an example, NWDAF 390 may collect data relating to a load level for a particular network slice instance from UPF 305, AMF 312, and/or SMF 314. Based on the collected data, NWDAF 390 may provide load level data to the PCF 320 and/or NSSF 370, and/or notify the PC 220 and/or NSSF 370 if load level for a slice reaches and/or exceeds a load level threshold.

The AF 399 may be outside the core network, but may interact with the core network to provide information relating to the QoS requirements or traffic routing preferences associated with a particular application. The AF 399 may access the core network based on the exposure constraints imposed by the NEF 340. However, an operator of the core network may consider the AF 399 to be a trusted domain that can access the network directly.

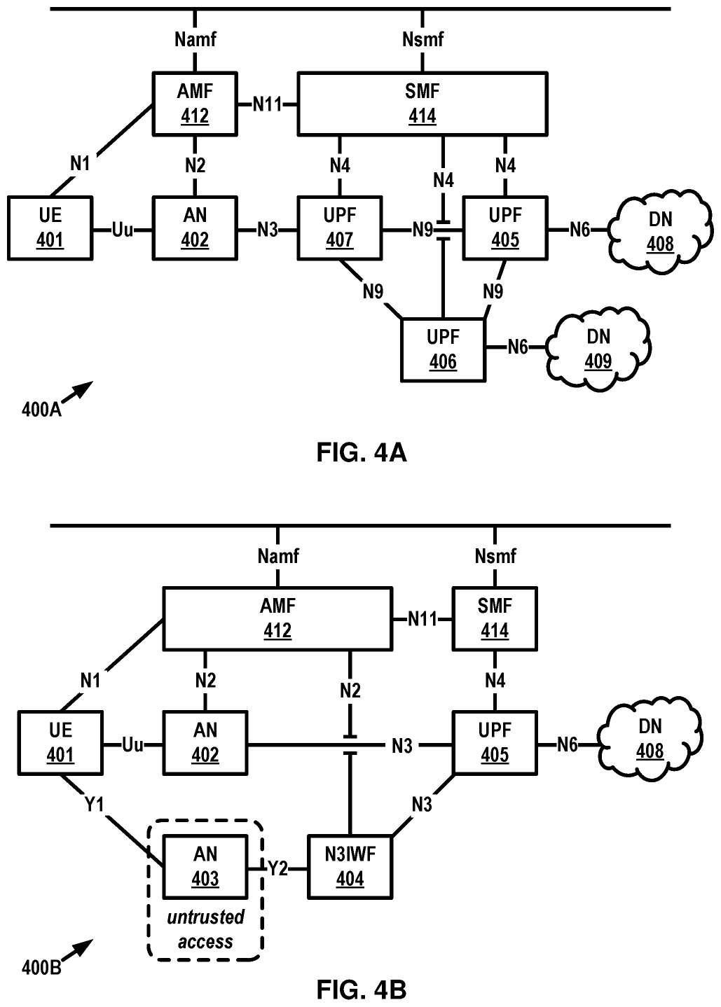

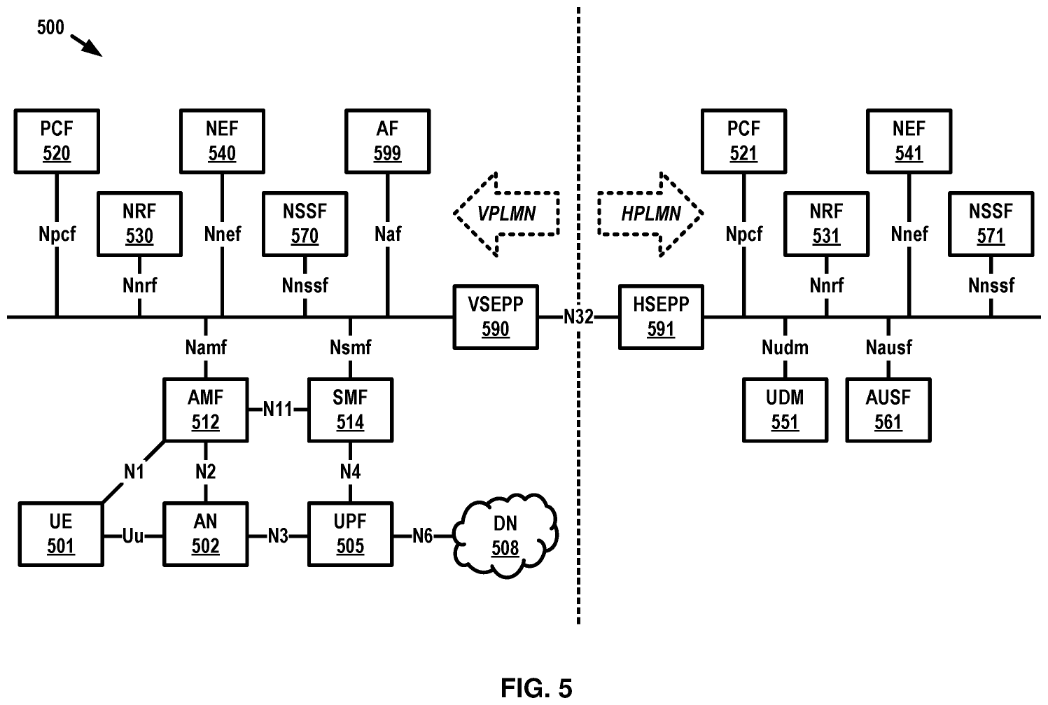

FIGS. 4A, 4B, and 5 illustrate other examples of core network architectures that are analogous in some respects to the core network architecture 300 depicted in FIG. 3. For conciseness, some of the core network elements depicted in FIG. 3 are omitted. Many of the elements depicted in FIGS. 4A, 4B, and 5 are analogous in some respects to elements depicted in FIG. 3. For conciseness, some of the details relating to their functions or operation are omitted.

FIG. 4A illustrates an example of a core network architecture 400A comprising an arrangement of multiple UPFs. Core network architecture 400A includes a UE 401, an AN 402, an AMF 412, and an SMF 414. Unlike previous examples of core network architectures described above, FIG. 4A depicts multiple UPFs, including a UPF 405, a UPF 406, and a UPF 407, and multiple DNs, including a DN 408 and a DN 409. Each of the multiple UPFs 405, 406, 407 may communicate with the SMF 414 via an N4 interface. The DNs 408, 409 communicate with the UPFs 405, 406, respectively, via N6 interfaces. As shown in FIG. 4A, the multiple UPFs 405, 406, 407 may communicate with one another via N9 interfaces.

The UPFs 405, 406, 407 may perform traffic detection, in which the UPFs identify and/or classify packets. Packet identification may be performed based on packet detection rules (PDR) provided by the SMF 414. A PDR may include packet detection information comprising one or more of: a source interface, a UE IP address, core network (CN) tunnel information (e.g., a CN address of an N3/N9 tunnel corresponding to a PDU session), a network instance identifier, a quality of service flow identifier (QFI), a filter set (for example, an IP packet filter set or an ethernet packet filter set), and/or an application identifier.

In addition to indicating how a particular packet is to be detected, a PDR may further indicate rules for handling the packet upon detection thereof. The rules may include, for example, forwarding action rules (FARs), multi-access rules (MARs), usage reporting rules (URRs), QoS enforcement rules (QERs), etc. For example, the PDR may comprise one or more FAR identifiers, MAR identifiers, URR identifiers, and/or QER identifiers. These identifiers may indicate the rules that are prescribed for the handling of a particular detected packet.

The UPF 405 may perform traffic forwarding in accordance with a FAR. For example, the FAR may indicate that a packet associated with a particular PDR is to be forwarded, duplicated, dropped, and/or buffered. The FAR may indicate a destination interface, for example, “access” for downlink or “core” for uplink. If a packet is to be buffered, the FAR may indicate a buffering action rule (BAR). As an example, UPF 405 may perform data buffering of a certain number downlink packets if a PDU session is deactivated.

The UPF 405 may perform QoS enforcement in accordance with a QER. For example, the QER may indicate a guaranteed bitrate that is authorized and/or a maximum bitrate to be enforced for a packet associated with a particular PDR. The QER may indicate that a particular guaranteed and/or maximum bitrate may be for uplink packets and/or downlink packets. The UPF 405 may mark packets belonging to a particular QoS flow with a corresponding QFI. The marking may enable a recipient of the packet to determine a QoS of the packet.

The UPF 405 may provide usage reports to the SMF 414 in accordance with a URR. The URR may indicate one or more triggering conditions for generation and reporting of the usage report, for example, immediate reporting, periodic reporting, a threshold for incoming uplink traffic, or any other suitable triggering condition. The URR may indicate a method for measuring usage of network resources, for example, data volume, duration, and/or event.

As noted above, the DNs 408, 409 may comprise public DNs (e.g., the Internet), private DNs (e.g., private, internal corporate-owned DNs), and/or intra-operator DNs. Each DN may provide an operator service and/or a third-party service. The service provided by a DN may be the Internet, an IP multimedia subsystem (IMS), an augmented or virtual reality network, an edge computing or mobile edge computing (MEC) network, etc. Each DN may be identified using a data network name (DNN). The UE 401 may be configured to establish a first logical connection with DN 408 (a first PDU session), a second logical connection with DN 409 (a second PDU session), or both simultaneously (first and second PDU sessions).

Each PDU session may be associated with at least one UPF configured to operate as a PDU session anchor (PSA, or “anchor”). The anchor may be a UPF that provides an N6 interface with a DN.

In the example of FIG. 4A, UPF 405 may be the anchor for the first PDU session between UE 401 and DN 408, whereas the UPF 406 may be the anchor for the second PDU session between UE 401 and DN 409. The core network may use the anchor to provide service continuity of a particular PDU session (for example, IP address continuity) as UE 401 moves from one access network to another. For example, suppose that UE 401 establishes a PDU session using a data path to the DN 408 using an access network other than AN 402. The data path may include UPF 405 acting as anchor. Suppose further that the UE 401 later moves into the coverage area of the AN 402. In such a scenario, SMF 414 may select a new UPF (UPF 407) to bridge the gap between the newly-entered access network (AN 402) and the anchor UPF (UPF 405). The continuity of the PDU session may be preserved as any number of UPFs are added or removed from the data path. When a UPF is added to a data path, as shown in FIG. 4A, it may be described as an intermediate UPF and/or a cascaded UPF.

As noted above, UPF 406 may be the anchor for the second PDU session between UE 401 and DN 409. Although the anchor for the first and second PDU sessions are associated with different UPFs in FIG. 4A, it will be understood that this is merely an example. It will also be understood that multiple PDU sessions with a single DN may correspond to any number of anchors. When there are multiple UPFs, a UPF at the branching point (UPF 407 in FIG. 4) may operate as an uplink classifier (UL-CL). The UL-CL may divert uplink user plane traffic to different UPFs.

The SMF 414 may allocate, manage, and/or assign an IP address to UE 401, for example, upon establishment of a PDU session. The SMF 414 may maintain an internal pool of IP addresses to be assigned. The SMF 414 may, if necessary, assign an IP address provided by a dynamic host configuration protocol (DHCP) server or an authentication, authorization, and accounting (AAA) server. IP address management may be performed in accordance with a session and service continuity (SSC) mode. In SSC mode 1, an IP address of UE 401 may be maintained (and the same anchor UPF may be used) as the wireless device moves within the network. In SSC mode 2, the IP address of UE 401 changes as UE 401 moves within the network (e.g., the old IP address and UPF may be abandoned and a new IP address and anchor UPF may be established). In SSC mode 3, it may be possible to maintain an old IP address (similar to SSC mode 1) temporarily while establishing a new IP address (similar to SSC mode 2), thus combining features of SSC modes 1 and 2. Applications that are sensitive to IP address changes may operate in accordance with SSC mode 1.

UPF selection may be controlled by SMF 414. For example, upon establishment and/or modification of a PDU session between UE 401 and DN 408, SMF 414 may select UPF 405 as the anchor for the PDU session and/or UPF 407 as an intermediate UPF. Criteria for UPF selection include path efficiency and/or speed between AN 402 and DN 408. The reliability, load status, location, slice support and/or other capabilities of candidate UPFs may also be considered.

FIG. 4B illustrates an example of a core network architecture 400B that accommodates untrusted access. Similar to FIG. 4A, UE 401 as depicted in FIG. 4B connects to DN 408 via AN 402 and UPF 405. The AN 402 and UPF 405 constitute trusted (e.g., 3GPP) access to the DN 408. By contrast, UE 401 may also access DN 408 using an untrusted access network, AN 403, and a non-3GPP interworking function (N3IWF) 404.

The AN 403 may be, for example, a wireless land area network (WLAN) operating in accordance with the IEEE 802.11 standard. The UE 401 may connect to AN 403, via an interface Y1, in whatever manner is prescribed for AN 403. The connection to AN 403 may or may not involve authentication. The UE 401 may obtain an IP address from AN 403. The UE 401 may determine to connect to core network 400B and select untrusted access for that purpose. The AN 403 may communicate with N3IWF 404 via a Y2 interface. After selecting untrusted access, the UE 401 may provide N3IWF 404 with sufficient information to select an AMF. The selected AMF may be, for example, the same AMF that is used by UE 401 for 3GPP access (AMF 412 in the present example). The N3IWF 404 may communicate with AMF 412 via an N2 interface. The UPF 405 may be selected and N3IWF 404 may communicate with UPF 405 via an N3 interface. The UPF 405 may be a PDU session anchor (PSA) and may remain the anchor for the PDU session even as UE 401 shifts between trusted access and untrusted access.

FIG. 5 illustrates an example of a core network architecture 500 in which a UE 501 is in a roaming scenario. In a roaming scenario, UE 501 is a subscriber of a first PLMN (a home PLMN, or HPLMN) but attaches to a second PLMN (a visited PLMN, or VPLMN). Core network architecture 500 includes UE 501, an AN 502, a UPF 505, and a DN 508. The AN 502 and UPF 505 may be associated with a VPLMN. The VPLMN may manage the AN 502 and UPF 505 using core network elements associated with the VPLMN, including an AMF 512, an SMF 514, a PCF 520, an NRF 530, an NEF 540, and an NSSF 570. An AF 599 may be adjacent the core network of the VPLMN.

The UE 501 may not be a subscriber of the VPLMN. The AMF 512 may authorize UE 501 to access the network based on, for example, roaming restrictions that apply to UE 501. In order to obtain network services provided by the VPLMN, it may be necessary for the core network of the VPLMN to interact with core network elements of a HPLMN of UE 501, in particular, a PCF 521, an NRF 531, an NEF 541, a UDM 551, and/or an AUSF 561. The VPLMN and HPLMN may communicate using an N32 interface connecting respective security edge protection proxies (SEPPs). In FIG. 5, the respective SEPPs are depicted as a VSEPP 590 and an HSEPP 591.

The VSEPP 590 and the HSEPP 591 communicate via an N32 interface for defined purposes while concealing information about each PLMN from the other. The SEPPs may apply roaming policies based on communications via the N32 interface. The PCF 520 and PCF 521 may communicate via the SEPPs to exchange policy-related signaling. The NRF 530 and NRF 531 may communicate via the SEPPs to enable service discovery of NFs in the respective PLMNs. The VPLMN and HPLMN may independently maintain NEF 540 and NEF 541. The NSSF 570 and NSSF 571 may communicate via the SEPPs to coordinate slice selection for UE 501. The HPLMN may handle all authentication and subscription related signaling. For example, when the UE 501 registers or requests service via the VPLMN, the VPLMN may authenticate UE 501 and/or obtain subscription data of UE 501 by accessing, via the SEPPs, the UDM 551 and AUSF 561 of the HPLMN.

The core network architecture 500 depicted in FIG. 5 may be referred to as a local breakout configuration, in which UE 501 accesses DN 508 using one or more UPFs of the VPLMN (i.e., UPF 505). However, other configurations are possible. For example, in a home-routed configuration (not shown in FIG. 5), UE 501 may access a DN using one or more UPFs of the HPLMN. In the home-routed configuration, an N9 interface may run parallel to the N32 interface, crossing the frontier between the VPLMN and the HPLMN to carry user plane data. One or more SMFs of the respective PLMNs may communicate via the N32 interface to coordinate session management for UE 501. The SMFs may control their respective UPFs on either side of the frontier.

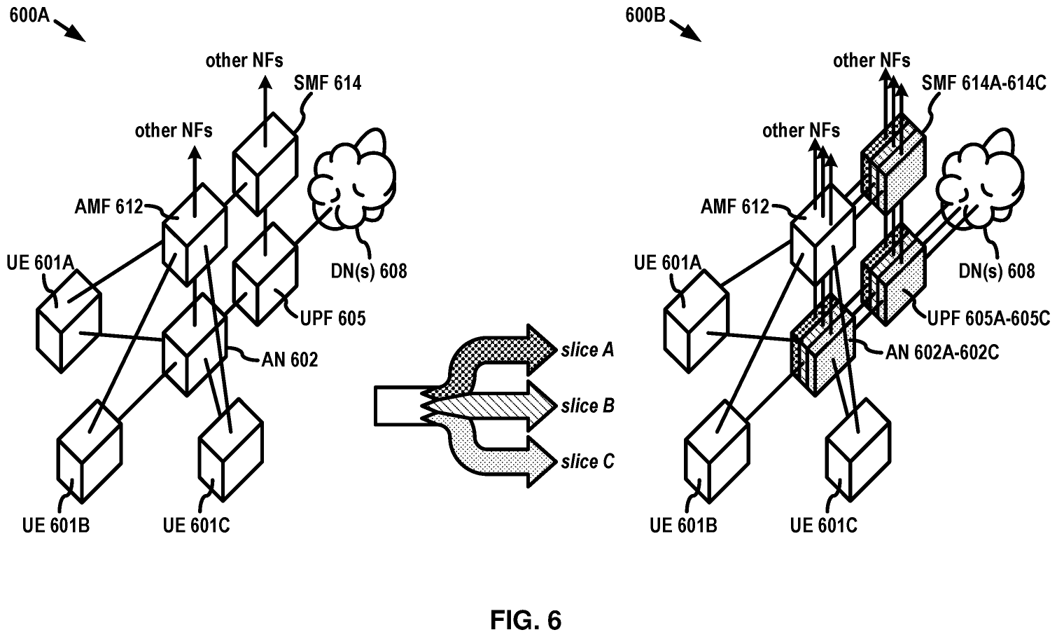

FIG. 6 illustrates an example of network slicing. Network slicing may refer to division of shared infrastructure (e.g., physical infrastructure) into distinct logical networks. These distinct logical networks may be independently controlled, isolated from one another, and/or associated with dedicated resources.

Network architecture 600A illustrates an un-sliced physical network corresponding to a single logical network. The network architecture 600A comprises a user plane wherein UEs 601A, 601B, 601C (collectively, UEs 601) have a physical and logical connection to a DN 608 via an AN 602 and a UPF 605. The network architecture 600A comprises a control plane wherein an AMF 612 and a SMF 614 control various aspects of the user plane.

The network architecture 600A may have a specific set of characteristics (e.g., relating to maximum bit rate, reliability, latency, bandwidth usage, power consumption, etc.). This set of characteristics may be affected by the nature of the network elements themselves (e.g., processing power, availability of free memory, proximity to other network elements, etc.) or the management thereof (e.g., optimized to maximize bit rate or reliability, reduce latency or power bandwidth usage, etc.). The characteristics of network architecture 600A may change over time, for example, by upgrading equipment or by modifying procedures to target a particular characteristic. However, at any given time, network architecture 600A will have a single set of characteristics that may or may not be optimized for a particular use case. For example, UEs 601A, 601B, 601C may have different requirements, but network architecture 600A can only be optimized for one of the three.

Network architecture 600B is an example of a sliced physical network divided into multiple logical networks. In FIG. 6, the physical network is divided into three logical networks, referred to as slice A, slice B, and slice C. For example, UE 601A may be served by AN 602A, UPF 605A, AMF 612, and SMF 614A. UE 601B may be served by AN 602B, UPF 605B, AMF 612, and SMF 614B. UE 601C may be served by AN 602C, UPF 605C, AMF 612, and SMF 614C. Although the respective UEs 601 communicate with different network elements from a logical perspective, these network elements may be deployed by a network operator using the same physical network elements.

Each network slice may be tailored to network services having different sets of characteristics. For example, slice A may correspond to enhanced mobile broadband (eMBB) service. Mobile broadband may refer to internet access by mobile users, commonly associated with smartphones. Slice B may correspond to ultra-reliable low-latency communication (URLLC), which focuses on reliability and speed. Relative to eMBB, URLLC may improve the feasibility of use cases such as autonomous driving and telesurgery. Slice C may correspond to massive machine type communication (mMTC), which focuses on low-power services delivered to a large number of users. For example, slice C may be optimized for a dense network of battery-powered sensors that provide small amounts of data at regular intervals. Many mMTC use cases would be prohibitively expensive if they operated using an eMBB or URLLC network.

If the service requirements for one of the UEs 601 changes, then the network slice serving that UE can be updated to provide better service. Moreover, the set of network characteristics corresponding to eMBB, URLLC, and mMTC may be varied, such that differentiated species of eMBB, URLLC, and mMTC are provided. Alternatively, network operators may provide entirely new services in response to, for example, customer demand.

In FIG. 6, each of the UEs 601 has its own network slice. However, it will be understood that a single slice may serve any number of UEs and a single UE may operate using any number of slices. Moreover, in the example network architecture 600B, the AN 602, UPF 605 and SMF 614 are separated into three separate slices, whereas the AMF 612 is unsliced. However, it will be understood that a network operator may deploy any architecture that selectively utilizes any mix of sliced and unsliced network elements, with different network elements divided into different numbers of slices. Although FIG. 6 only depicts three core network functions, it will be understood that other core network functions may be sliced as well. A PLMN that supports multiple network slices may maintain a separate network repository function (NFR) for each slice, enabling other NFs to discover network services associated with that slice.

Network slice selection may be controlled by an AMF, or alternatively, by a separate network slice selection function (NSSF). For example, a network operator may define and implement distinct network slice instances (NSIs). Each NSI may be associated with single network slice selection assistance information (S-NSSAI). The S-NSSAI may include a particular slice/service type (SST) indicator (indicating eMBB, URLLC, mMTC, etc.). as an example, a particular tracking area may be associated with one or more configured S-NSSAIs. UEs may identify one or more requested and/or subscribed S-NSSAIs (e.g., during registration). The network may indicate to the UE one or more allowed and/or rejected S-NSSAIs.

The S-NSSAI may further include a slice differentiator (SD) to distinguish between different tenants of a particular slice and/or service type. For example, a tenant may be a customer (e.g., vehicle manufacture, service provider, etc.) of a network operator that obtains (for example, purchases) guaranteed network resources and/or specific policies for handling its subscribers. The network operator may configure different slices and/or slice types, and use the SD to determine which tenant is associated with a particular slice.

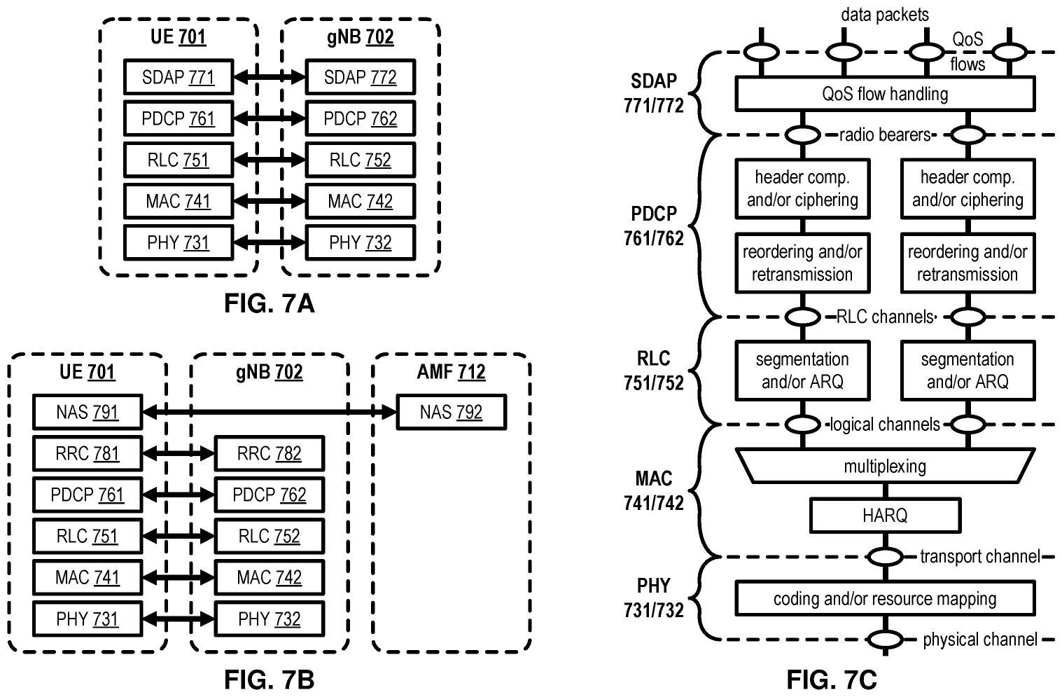

FIG. 7A, FIG. 7B, and FIG. 7C illustrate a user plane (UP) protocol stack, a control plane (CP) protocol stack, and services provided between protocol layers of the UP protocol stack.

The layers may be associated with an open system interconnection (OSI) model of computer networking functionality. In the OSI model, layer 1 may correspond to the bottom layer, with higher layers on top of the bottom layer. Layer 1 may correspond to a physical layer, which is concerned with the physical infrastructure used for transfer of signals (for example, cables, fiber optics, and/or radio frequency transceivers). In New Radio (NR), layer 1 may comprise a physical layer (PHY). Layer 2 may correspond to a data link layer. Layer 2 may be concerned with packaging of data (into, e.g., data frames) for transfer, between nodes of the network, using the physical infrastructure of layer 1. In NR, layer 2 may comprise a media access control layer (MAC), a radio link control layer (RLC), a packet data convergence layer (PDCP), and a service data application protocol layer (SDAP).

Layer 3 may correspond to a network layer. Layer 3 may be concerned with routing of the data which has been packaged in layer 2. Layer 3 may handle prioritization of data and traffic avoidance. In NR, layer 3 may comprise a radio resource control layer (RRC) and a non-access stratum layer (NAS). Layers 4 through 7 may correspond to a transport layer, a session layer, a presentation layer, and an application layer. The application layer interacts with an end user to provide data associated with an application. In an example, an end user implementing the application may generate data associated with the application and initiate sending of that information to a targeted data network (e.g., the Internet, an application server, etc.). Starting at the application layer, each layer in the OSI model may manipulate and/or repackage the information and deliver it to a lower layer. At the lowest layer, the manipulated and/or repackaged information may be exchanged via physical infrastructure (for example, electrically, optically, and/or electromagnetically). As it approaches the targeted data network, the information will be unpackaged and provided to higher and higher layers, until it once again reaches the application layer in a form that is usable by the targeted data network (e.g., the same form in which it was provided by the end user). To respond to the end user, the data network may perform this procedure in reverse.

FIG. 7A illustrates a user plane protocol stack. The user plane protocol stack may be a new radio (NR) protocol stack for a Uu interface between a UE 701 and a gNB 702. In layer 1 of the UP protocol stack, the UE 701 may implement PHY 731 and the gNB 702 may implement PHY 732. In layer 2 of the UP protocol stack, the UE 701 may implement MAC 741, RLC 751, PDCP 761, and SDAP 771. The gNB 702 may implement MAC 742, RLC 752, PDCP 762, and SDAP 772.

FIG. 7B illustrates a control plane protocol stack. The control plane protocol stack may be an NR protocol stack for the Uu interface between the UE 701 and the gNB 702 and/or an N1 interface between the UE 701 and an AMF 712. In layer 1 of the CP protocol stack, the UE 701 may implement PHY 731 and the gNB 702 may implement PHY 732. In layer 2 of the CP protocol stack, the UE 701 may implement MAC 741, RLC 751, PDCP 761, RRC 781, and NAS 791. The gNB 702 may implement MAC 742, RLC 752, PDCP 762, and RRC 782. The AMF 712 may implement NAS 792.

The NAS may be concerned with the non-access stratum, in particular, communication between the UE 701 and the core network (e.g., the AMF 712). Lower layers may be concerned with the access stratum, for example, communication between the UE 701 and the gNB 702. Messages sent between the UE 701 and the core network may be referred to as NAS messages. In an example, a NAS message may be relayed by the gNB 702, but the content of the NAS message (e.g., information elements of the NAS message) may not be visible to the gNB 702.

FIG. 7C illustrates an example of services provided between protocol layers of the NR user plane protocol stack illustrated in FIG. 7A. The UE 701 may receive services through a PDU session, which may be a logical connection between the UE 701 and a data network (DN). The UE 701 and the DN may exchange data packets associated with the PDU session. The PDU session may comprise one or more quality of service (QoS) flows. SDAP 771 and SDAP 772 may perform mapping and/or demapping between the one or more QoS flows of the PDU session and one or more radio bearers (e.g., data radio bearers). The mapping between the QoS flows and the data radio bearers may be determined in the SDAP 772 by the gNB 702, and the UE 701 may be notified of the mapping (e.g., based on control signaling and/or reflective mapping). For reflective mapping, the SDAP 772 of the gNB 220 may mark downlink packets with a QoS flow indicator (QFI) and deliver the downlink packets to the UE 701. The UE 701 may determine the mapping based on the QFI of the downlink packets.

PDCP 761 and PDCP 762 may perform header compression and/or decompression. Header compression may reduce the amount of data transmitted over the physical layer. The PDCP 761 and PDCP 762 may perform ciphering and/or deciphering. Ciphering may reduce unauthorized decoding of data transmitted over the physical layer (e.g., intercepted on an air interface), and protect data integrity (e.g., to ensure control messages originate from intended sources). The PDCP 761 and PDCP 762 may perform retransmissions of undelivered packets, in-sequence delivery and reordering of packets, duplication of packets, and/or identification and removal of duplicate packets. In a dual connectivity scenario, PDCP 761 and PDCP 762 may perform mapping between a split radio bearer and RLC channels.

RLC 751 and RLC 752 may perform segmentation, retransmission through Automatic Repeat Request (ARQ). The RLC 751 and RLC 752 may perform removal of duplicate data units received from MAC 741 and MAC 742, respectively. The RLCs 213 and 223 may provide RLC channels as a service to PDCPs 214 and 224, respectively.

MAC 741 and MAC 742 may perform multiplexing and/or demultiplexing of logical channels. MAC 741 and MAC 742 may map logical channels to transport channels. In an example, UE 701 may, in MAC 741, multiplex data units of one or more logical channels into a transport block. The UE 701 may transmit the transport block to the gNB 702 using PHY 731. The gNB 702 may receive the transport block using PHY 732 and demultiplex data units of the transport blocks back into logical channels. MAC 741 and MAC 742 may perform error correction through Hybrid Automatic Repeat Request (HARQ), logical channel prioritization, and/or padding.

PHY 731 and PHY 732 may perform mapping of transport channels to physical channels. PHY 731 and PHY 732 may perform digital and analog signal processing functions (e.g., coding/decoding and modulation/demodulation) for sending and receiving information (e.g., transmission via an air interface). PHY 731 and PHY 732 may perform multi-antenna mapping.

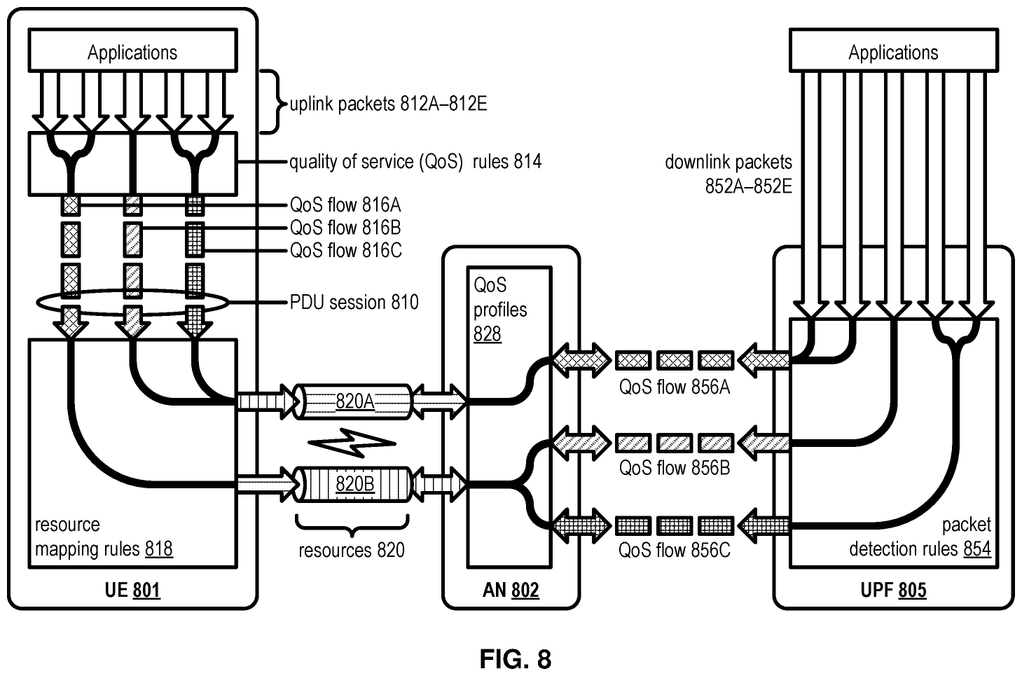

FIG. 8 illustrates an example of a quality of service (QoS) model for differentiated data exchange. In the QoS model of FIG. 8, there are a UE 801, a AN 802, and a UPF 805. The QoS model facilitates prioritization of certain packet or protocol data units (PDUs), also referred to as packets. For example, higher-priority packets may be exchanged faster and/or more reliably than lower-priority packets. The network may devote more resources to exchange of high-QoS packets.

In the example of FIG. 8, a PDU session 810 is established between UE 801 and UPF 805. The PDU session 810 may be a logical connection enabling the UE 801 to exchange data with a particular data network (for example, the Internet). The UE 801 may request establishment of the PDU session 810. At the time that the PDU session 810 is established, the UE 801 may, for example, identify the targeted data network based on its data network name (DNN). The PDU session 810 may be managed, for example, by a session management function (SMF, not shown). In order to facilitate exchange of data associated with the PDU session 810, between the UE 801 and the data network, the SMF may select the UPF 805 (and optionally, one or more other UPFs, not shown).

One or more applications associated with UE 801 may generate uplink packets 812A-812E associated with the PDU session 810. In order to work within the QoS model, UE 801 may apply QoS rules 814 to uplink packets 812A-812E. The QoS rules 814 may be associated with PDU session 810 and may be determined and/or provided to the UE 801 when PDU session 810 is established and/or modified. Based on QoS rules 814, UE 801 may classify uplink packets 812A-812E, map each of the uplink packets 812A-812E to a QoS flow, and/or mark uplink packets 812A-812E with a QoS flow indicator (QFI). As a packet travels through the network, and potentially mixes with other packets from other UEs having potentially different priorities, the QFI indicates how the packet should be handled in accordance with the QoS model. In the present illustration, uplink packets 812A, 812B are mapped to QoS flow 816A, uplink packet 812C is mapped to QoS flow 816B, and the remaining packets are mapped to QoS flow 816C.

The QoS flows may be the finest granularity of QoS differentiation in a PDU session. In the figure, three QoS flows 816A-816C are illustrated. However, it will be understood that there may be any number of QoS flows. Some QoS flows may be associated with a guaranteed bit rate (GBR QoS flows) and others may have bit rates that are not guaranteed (non-GBR QoS flows). QoS flows may also be subject to per-UE and per-session aggregate bit rates. One of the QoS flows may be a default QoS flow. The QoS flows may have different priorities. For example, QoS flow 816A may have a higher priority than QoS flow 816B, which may have a higher priority than QoS flow 816C. Different priorities may be reflected by different QoS flow characteristics. For example, QoS flows may be associated with flow bit rates. A particular QoS flow may be associated with a guaranteed flow bit rate (GFBR) and/or a maximum flow bit rate (MFBR). QoS flows may be associated with specific packet delay budgets (PDBs), packet error rates (PERs), and/or maximum packet loss rates. QoS flows may also be subject to per-UE and per-session aggregate bit rates.

In order to work within the QoS model, UE 801 may apply resource mapping rules 818 to the QoS flows 816A-816C. The air interface between UE 801 and AN 802 may be associated with resources 820. In the present illustration, QoS flow 816A is mapped to resource 820A, whereas QoS flows 816B, 816C are mapped to resource 820B. The resource mapping rules 818 may be provided by the AN 802. In order to meet QoS requirements, the resource mapping rules 818 may designate more resources for relatively high-priority QoS flows. With more resources, a high-priority QoS flow such as QoS flow 816A may be more likely to obtain the high flow bit rate, low packet delay budget, or other characteristic associated with QoS rules 814. The resources 820 may comprise, for example, radio bearers. The radio bearers (e.g., data radio bearers) may be established between the UE 801 and the AN 802. The radio bearers in 5G, between the UE 801 and the AN 802, may be distinct from bearers in LTE, for example, Evolved Packet System (EPS) bearers between a UE and a packet data network gateway (PGW), S1 bearers between an eNB and a serving gateway (SGW), and/or an S5/S8 bearer between an SGW and a PGW.

Once a packet associated with a particular QoS flow is received at AN 802 via resource 820A or resource 820B, AN 802 may separate packets into respective QoS flows 856A-856C based on QoS profiles 828. The QoS profiles 828 may be received from an SMF. Each QoS profile may correspond to a QFI, for example, the QFI marked on the uplink packets 812A-812E. Each QoS profile may include QoS parameters such as 5G QoS identifier (5QI) and an allocation and retention priority (ARP). The QoS profile for non-GBR QoS flows may further include additional QoS parameters such as a reflective QoS attribute (RQA).The QoS profile for GBR QoS flows may further include additional QoS parameters such as a guaranteed flow bit rate (GFBR), a maximum flow bit rate (MFBR), and/or a maximum packet loss rate. The 5QI may be a standardized 5QI which have one-to-one mapping to a standardized combination of 5G QoS characteristics per well-known services. The 5QI may be a dynamically assigned 5QI which the standardized 5QI values are not defined. The 5QI may represent 5G QoS characteristics. The 5QI may comprise a resource type, a default priority level, a packet delay budget (PDB), a packet error rate (PER), a maximum data burst volume, and/or an averaging window. The resource type may indicate a non-GBR QoS flow, a GBR QoS flow or a delay-critical GBR QoS flow. The averaging window may represent a duration over which the GFBR and/or MFBR is calculated. ARP may be a priority level comprising pre-emption capability and a pre-emption vulnerability. Based on the ARP, the AN 802 may apply admission control for the QoS flows in a case of resource limitations.

The AN 802 may select one or more N3 tunnels 850 for transmission of the QoS flows 856A-856C. After the packets are divided into QoS flows 856A-856C, the packet may be sent to UPF 805 (e.g., towards a DN) via the selected one or more N3 tunnels 850. The UPF 805 may verify that the QFIs of the uplink packets 812A-812E are aligned with the QoS rules 814 provided to the UE 801. The UPF 805 may measure and/or count packets and/or provide packet metrics to, for example, a PCF.

The figure also illustrates a process for downlink. In particular, one or more applications may generate downlink packets 852A-852E. The UPF 805 may receive downlink packets 852A-852E from one or more DNs and/or one or more other UPFs. As per the QoS model, UPF 805 may apply packet detection rules (PDRs) 854 to downlink packets 852A-852E. Based on PDRs 854, UPF 805 may map packets 852A-852E into QoS flows. In the present illustration, downlink packets 852A, 852B are mapped to QoS flow 856A, downlink packet 852C is mapped to QoS flow 856B, and the remaining packets are mapped to QoS flow 856C.

The QoS flows 856A-856C may be sent to AN 802. The AN 802 may apply resource mapping rules to the QoS flows 856A-856C. In the present illustration, QoS flow 856A is mapped to resource 820A, whereas QoS flows 856B, 856C are mapped to resource 820B. In order to meet QoS requirements, the resource mapping rules may designate more resources to high-priority QoS flows.

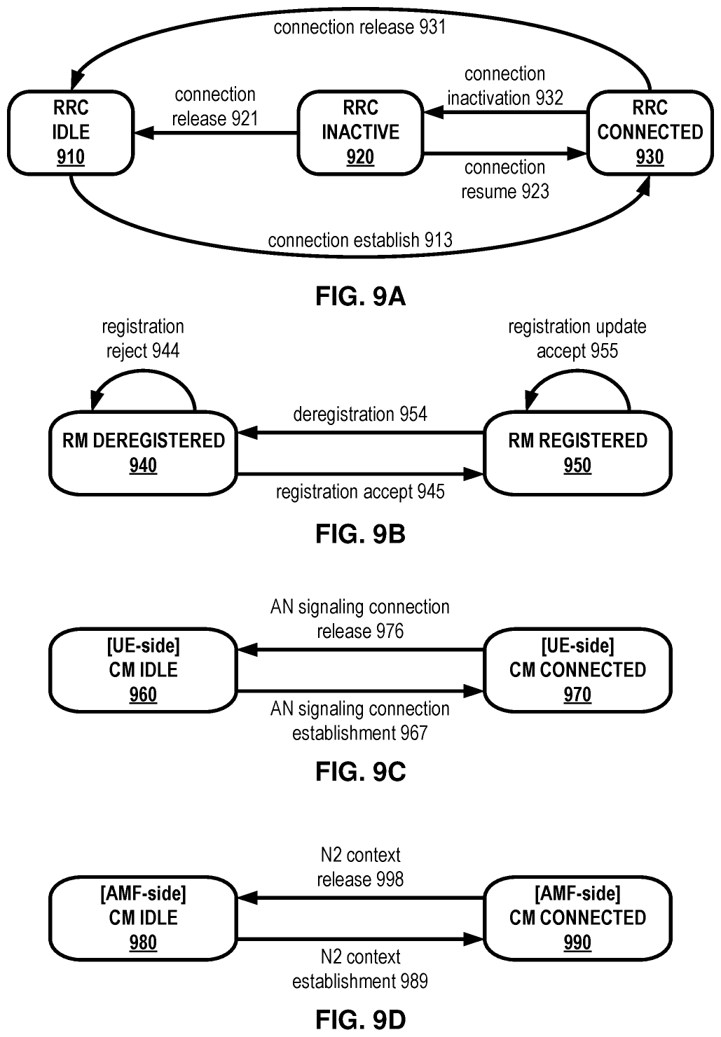

FIGS. 9A-9D illustrate example states and state transitions of a wireless device (e.g., a UE). At any given time, the wireless device may have a radio resource control (RRC) state, a registration management (RM) state, and a connection management (CM) state.

FIG. 9A is an example diagram showing RRC state transitions of a wireless device (e.g., a UE). The UE may be in one of three RRC states: RRC idle 910, (e.g., RRC_IDLE), RRC inactive 920 (e.g., RRC_INACTIVE), or RRC connected 930 (e.g., RRC_CONNECTED). The UE may implement different RAN-related control-plane procedures depending on its RRC state. Other elements of the network, for example, a base station, may track the RRC state of one or more UEs and implement RAN-related control-plane procedures appropriate to the RRC state of each.

In RRC connected 930, it may be possible for the UE to exchange data with the network (for example, the base station). The parameters necessary for exchange of data may be established and known to both the UE and the network. The parameters may be referred to and/or included in an RRC context of the UE (sometimes referred to as a UE context). These parameters may include, for example: one or more AS contexts; one or more radio link configuration parameters; bearer configuration information (e.g., relating to a data radio bearer, signaling radio bearer, logical channel, QoS flow, and/or PDU session); security information; and/or PHY, MAC, RLC, PDCP, and/or SDAP layer configuration information. The base station with which the UE is connected may store the RRC context of the UE.

While in RRC connected 930, mobility of the UE may be managed by the access network, whereas the UE itself may manage mobility while in RRC idle 910 and/or RRC inactive 920. While in RRC connected 930, the UE may manage mobility by measuring signal levels (e.g., reference signal levels) from a serving cell and neighboring cells and reporting these measurements to the base station currently serving the UE. The network may initiate handover based on the reported measurements. The RRC state may transition from RRC connected 930 to RRC idle 910 through a connection release procedure 930 or to RRC inactive 920 through a connection inactivation procedure 932.

In RRC idle 910, an RRC context may not be established for the UE. In RRC idle 910, the UE may not have an RRC connection with a base station. While in RRC idle 910, the UE may be in a sleep state for a majority of the time (e.g., to conserve battery power). The UE may wake up periodically (e.g., once in every discontinuous reception cycle) to monitor for paging messages from the access network. Mobility of the UE may be managed by the UE through a procedure known as cell reselection. The RRC state may transition from RRC idle 910 to RRC connected 930 through a connection establishment procedure 913, which may involve a random access procedure, as discussed in greater detail below.

In RRC inactive 920, the RRC context previously established is maintained in the UE and the base station. This may allow for a fast transition to RRC connected 930 with reduced signaling overhead as compared to the transition from RRC idle 910 to RRC connected 930. The RRC state may transition to RRC connected 930 through a connection resume procedure 923. The RRC state may transition to RRC idle 910 though a connection release procedure 921 that may be the same as or similar to connection release procedure 931.

An RRC state may be associated with a mobility management mechanism. In RRC idle 910 and RRC inactive 920, mobility may be managed by the UE through cell reselection. The purpose of mobility management in RRC idle 910 and/or RRC inactive 920 is to allow the network to be able to notify the UE of an event via a paging message without having to broadcast the paging message over the entire mobile communications network. The mobility management mechanism used in RRC idle 910 and/or RRC inactive 920 may allow the network to track the UE on a cell-group level so that the paging message may be broadcast over the cells of the cell group that the UE currently resides within instead of the entire communication network. Tracking may be based on different granularities of grouping. For example, there may be three levels of cell-grouping granularity: individual cells; cells within a RAN area identified by a RAN area identifier (RAI); and cells within a group of RAN areas, referred to as a tracking area and identified by a tracking area identifier (TAI).

Tracking areas may be used to track the UE at the CN level. The CN may provide the UE with a list of TAIs associated with a UE registration area. If the UE moves, through cell reselection, to a cell associated with a TAI not included in the list of TAIs associated with the UE registration area, the UE may perform a registration update with the CN to allow the CN to update the UE's location and provide the UE with a new the UE registration area.

RAN areas may be used to track the UE at the RAN level. For a UE in RRC inactive 920 state, the UE may be assigned a RAN notification area. A RAN notification area may comprise one or more cell identities, a list of RAIs, and/or a list of TAIs. In an example, a base station may belong to one or more RAN notification areas. In an example, a cell may belong to one or more RAN notification areas. If the UE moves, through cell reselection, to a cell not included in the RAN notification area assigned to the UE, the UE may perform a notification area update with the RAN to update the UE's RAN notification area.

A base station storing an RRC context for a UE or a last serving base station of the UE may be referred to as an anchor base station. An anchor base station may maintain an RRC context for the UE at least during a period of time that the UE stays in a RAN notification area of the anchor base station and/or during a period of time that the UE stays in RRC inactive 920.

FIG. 9B is an example diagram showing registration management (RM) state transitions of a wireless device (e.g., a UE). The states are RM deregistered 940, (e.g., RM-DEREGISTERED) and RM registered 950 (e.g., RM-REGISTERED).

In RM deregistered 940, the UE is not registered with the network, and the UE is not reachable by the network. In order to be reachable by the network, the UE must perform an initial registration. As an example, the UE may register with an AMF of the network. If registration is rejected (registration reject 944), then the UE remains in RM deregistered 940. If registration is accepted (registration accept 945), then the UE transitions to RM registered 950. While the UE is RM registered 950, the network may store, keep, and/or maintain a UE context for the UE. The UE context may be referred to as wireless device context. The UE context corresponding to network registration (maintained by the core network) may be different from the RRC context corresponding to RRC state (maintained by an access network, .e.g., a base station). The UE context may comprise a UE identifier and a record of various information relating to the UE, for example, UE capability information, policy information for access and mobility management of the UE, lists of allowed or established slices or PDU sessions, and/or a registration area of the UE (i.e., a list of tracking areas covering the geographical area where the wireless device is likely to be found).

While the UE is RM registered 950, the network may store the UE context of the UE, and if necessary use the UE context to reach the UE. Moreover, some services may not be provided by the network unless the UE is registered. The UE may update its UE context while remaining in RM registered 950 (registration update accept 955). For example, if the UE leaves one tracking area and enters another tracking area, the UE may provide a tracking area identifier to the network. The network may deregister the UE, or the UE may deregister itself (deregistration 954). For example, the network may automatically deregister the wireless device if the wireless device is inactive for a certain amount of time. Upon deregistration, the UE may transition to RM deregistered 940.

FIG. 9C is an example diagram showing connection management (CM) state transitions of a wireless device (e.g., a UE), shown from a perspective of the wireless device. The UE may be in CM idle 960 (e.g., CM-IDLE) or CM connected 970 (e.g., CM-CONNECTED).

In CM idle 960, the UE does not have a non access stratum (NAS) signaling connection with the network. As a result, the UE can not communicate with core network functions. The UE may transition to CM connected 970 by establishing an AN signaling connection (AN signaling connection establishment 967). This transition may be initiated by sending an initial NAS message. The initial NAS message may be a registration request (e.g., if the UE is RM deregistered 940) or a service request (e.g., if the UE is RM registered 950). If the UE is RM registered 950, then the UE may initiate the AN signaling connection establishment by sending a service request, or the network may send a page, thereby triggering the UE to send the service request.

In CM connected 970, the UE can communicate with core network functions using NAS signaling. As an example, the UE may exchange NAS signaling with an AMF for registration management purposes, service request procedures, and/or authentication procedures. As another example, the UE may exchange NAS signaling, with an SMF, to establish and/or modify a PDU session. The network may disconnect the UE, or the UE may disconnect itself (AN signaling connection release 976). For example, if the UE transitions to RM deregistered 940, then the UE may also transition to CM idle 960. When the UE transitions to CM idle 960, the network may deactivate a user plane connection of a PDU session of the UE.

FIG. 9D is an example diagram showing CM state transitions of the wireless device (e.g., a UE), shown from a network perspective (e.g., an AMF). The CM state of the UE, as tracked by the AMF, may be in CM idle 980 (e.g., CM-IDLE) or CM connected 990 (e.g., CM-CONNECTED). When the UE transitions from CM idle 980 to CM connected 990, the AMF many establish an N2 context of the UE (N2 context establishment 989). When the UE transitions from CM connected 990 to CM idle 980, the AMF many release the N2 context of the UE (N2 context release 998).

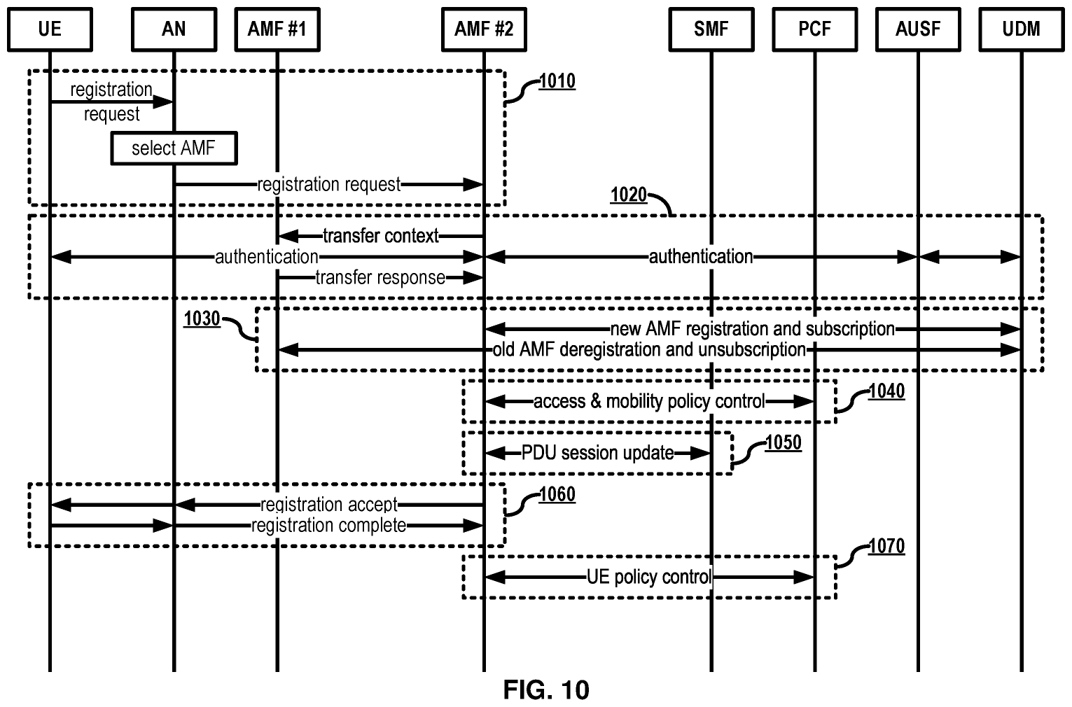

FIGS. 10-12 illustrate example procedures for registering, service request, and PDU session establishment of a UE.

FIG. 10 illustrates an example of a registration procedure for a wireless device (e.g., a UE). Based on the registration procedure, the UE may transition from, for example, RM deregistered 940 to RM registered 950.

Registration may be initiated by a UE for the purposes of obtaining authorization to receive services, enabling mobility tracking, enabling reachability, or other purposes. The UE may perform an initial registration as a first step toward connection to the network (for example, if the UE is powered on, airplane mode is turned off, etc.). Registration may also be performed periodically to keep the network informed of the UE's presence (for example, while in CM-IDLE state), or in response to a change in UE capability or registration area. Deregistration (not shown in FIG. 10) may be performed to stop network access.

At 1010, the UE transmits a registration request to an AN. As an example, the UE may have moved from a coverage area of a previous AMF (illustrated as AMF #1) into a coverage area of a new AMF (illustrated as AMF #2). The registration request may be a NAS message. The registration request may include a UE identifier. The AN may select an AMF for registration of the UE. For example, the AN may select a default AMF. For example, the AN may select an AMF that is already mapped to the UE (e.g., a previous AMF). The NAS registration request may include a network slice identifier and the AN may select an AMF based on the requested slice. After the AMF is selected, the AN may send the registration request to the selected AMF.

At 1020, the AMF that receives the registration request (AMF #2) performs a context transfer. The context may be a UE context, for example, an RRC context for the UE. As an example, AMF #2 may send AMF #1 a message requesting a context of the UE. The message may include the UE identifier. The message may be a Namf_Communication_UEContextTransfer message. AMF #1 may send to AMF #2 a message that includes the requested UE context. This message may be a Namf_Communication_UEContextTransfer message. After the UE context is received, the AMF #2 may coordinate authentication of the UE. After authentication is complete, AMF #2 may send to AMF #1 a message indicating that the UE context transfer is complete. This message may be a Namf_Communication_UEContextTransfer Response message.

Authentication may require participation of the UE, an AUSF, a UDM and/or a UDR (not shown). For example, the AMF may request that the AUSF authenticate the UE. For example, the AUSF may execute authentication of the UE. For example, the AUSF may get authentication data from UDM. For example, the AUSF may send a subscription permanent identifier (SUPI) to the AMF based on the authentication being successful. For example, the AUSF may provide an intermediate key to the AMF. The intermediate key may be used to derive an access-specific security key for the UE, enabling the AMF to perform security context management (SCM). The AUSF may obtain subscription data from the UDM. The subscription data may be based on information obtained from the UDM (and/or the UDR). The subscription data may include subscription identifiers, security credentials, access and mobility related subscription data and/or session related data.

At 1030, the new AMF, AMF #2, registers and/or subscribes with the UDM. AMF #2 may perform registration using a UE context management service of the UDM (Nudm_UECM). AMF #2 may obtain subscription information of the UE using a subscriber data management service of the UDM (Nudm_SDM). AMF #2 may further request that the UDM notify AMF #2 if the subscription information of the UE changes. As the new AMF registers and subscribes, the old AMF, AMF #1, may deregister and unsubscribe. After deregistration, AMF #1 is free of responsibility for mobility management of the UE.

At 1040, AMF #2 retrieves access and mobility (AM) policies from the PCF. As an example, the AMF #2 may provide subscription data of the UE to the PCF. The PCF may determine access and mobility policies for the UE based on the subscription data, network operator data, current network conditions, and/or other suitable information. For example, the owner of a first UE may purchase a higher level of service than the owner of a second UE. The PCF may provide the rules associated with the different levels of service. Based on the subscription data of the respective UEs, the network may apply different policies which facilitate different levels of service.

For example, access and mobility policies may relate to service area restrictions, RAT/frequency selection priority (RFSP, where RAT stands for radio access technology), authorization and prioritization of access type (e.g., LTE versus NR), and/or selection of non-3GPP access (e.g., Access Network Discovery and Selection Policy (ANDSP)). The service area restrictions may comprise a list of tracking areas where the UE is allowed to be served (or forbidden from being served). The access and mobility policies may include a UE route selection policy (URSP)) that influences routing to an established PDU session or a new PDU session. As noted above, different policies may be obtained and/or enforced based on subscription data of the UE, location of the UE (i.e., location of the AN and/or AMF), or other suitable factors.

At 1050, AMF #2 may update a context of a PDU session. For example, if the UE has an existing PDU session, the AMF #2 may coordinate with an SMF to activate a user plane connection associated with the existing PDU session. The SMF may update and/or release a session management context of the PDU session (Nsmf_PDUSession_UpdateSMContext, Nsmf_PDUSession_ReleaseSMContext).

At 1060, AMF #2 sends a registration accept message to the AN, which forwards the registration accept message to the UE. The registration accept message may include a new UE identifier and/or a new configured slice identifier. The UE may transmit a registration complete message to the AN, which forwards the registration complete message to the AMF #2. The registration complete message may acknowledge receipt of the new UE identifier and/or new configured slice identifier.

At 1070, AMF #2 may obtain UE policy control information from the PCF. The PCF may provide an access network discovery and selection policy (ANDSP) to facilitate non-3GPP access. The PCF may provide a UE route selection policy (URSP) to facilitate mapping of particular data traffic to particular PDU session connectivity parameters. As an example, the URSP may indicate that data traffic associated with a particular application should be mapped to a particular SSC mode, network slice, PDU session type, or preferred access type (3GPP or non-3GPP).

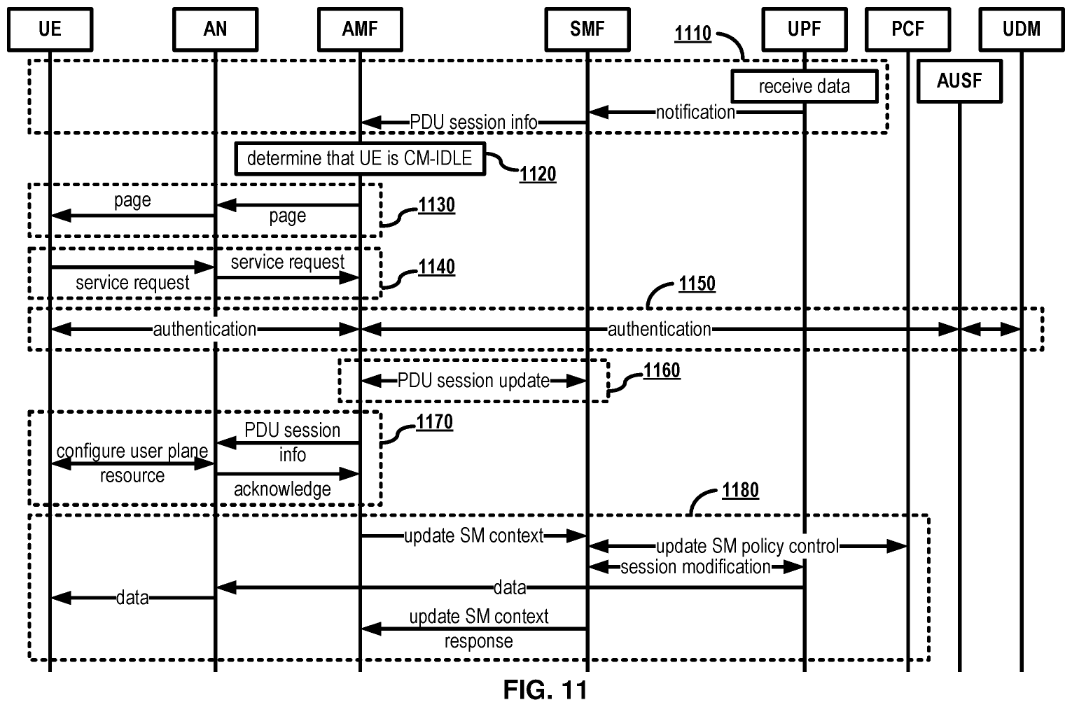

FIG. 11 illustrates an example of a service request procedure for a wireless device (e.g., a UE). The service request procedure depicted in FIG. 11 is a network-triggered service request procedure for a UE in a CM-IDLE state. However, other service request procedures (e.g., a UE-triggered service request procedure) may also be understood by reference to FIG. 11, as will be discussed in greater detail below.

At 1110, a UPF receives data. The data may be downlink data for transmission to a UE. The data may be associated with an existing PDU session between the UE and a DN. The data may be received, for example, from a DN and/or another UPF. The UPF may buffer the received data. In response to the receiving of the data, the UPF may notify an SMF of the received data. The identity of the SMF to be notified may be determined based on the received data. The notification may be, for example, an N4 session report. The notification may indicate that the UPF has received data associated with the UE and/or a particular PDU session associated with the UE. In response to receiving the notification, the SMF may send PDU session information to an AMF. The PDU session information may be sent in an N1N2 message transfer for forwarding to an AN. The PDU session information may include, for example, UPF tunnel endpoint information and/or QoS information.

At 1120, the AMF determines that the UE is in a CM-IDLE state. The determining at 1120 may be in response to the receiving of the PDU session information. Based on the determination that the UE is CM-IDLE, the service request procedure may proceed to 1130 and 1140, as depicted in FIG. 11. However, if the UE is not CM-IDLE (e.g., the UE is CM-CONNECTED), then 1130 and 1140 may be skipped, and the service request procedure may proceed directly to 1150.

At 1130, the AMF pages the UE. The paging at 1130 may be performed based on the UE being CM-IDLE. To perform the paging, the AMF may send a page to the AN. The page may be referred to as a paging or a paging message. The page may be an N2 request message. The AN may be one of a plurality of ANs in a RAN notification area of the UE. The AN may send a page to the UE. The UE may be in a coverage area of the AN and may receive the page.

At 1140, the UE may request service. The UE may transmit a service request to the AMF via the AN. As depicted in FIG. 11, the UE may request service at 1140 in response to receiving the paging at 1130. However, as noted above, this is for the specific case of a network-triggered service request procedure. In some scenarios (for example, if uplink data becomes available at the UE), then the UE may commence a UE-triggered service request procedure. The UE-triggered service request procedure may commence starting at 1140.

At 1150, the network may authenticate the UE. Authentication may require participation of the UE, an AUSF, and/or a UDM, for example, similar to authentication described elsewhere in the present disclosure. In some cases (for example, if the UE has recently been authenticated), the authentication at 1150 may be skipped.

At 1160, the AMF and SMF may perform a PDU session update. As part of the PDU session update, the SMF may provide the AMF with one or more UPF tunnel endpoint identifiers. In some cases (not shown in FIG. 11), it may be necessary for the SMF to coordinate with one or more other SMFs and/or one or more other UPFs to set up a user plane.

At 1170, the AMF may send PDU session information to the AN. The PDU session information may be included in an N2 request message. Based on the PDU session information, the AN may configure a user plane resource for the UE. To configure the user plane resource, the AN may, for example, perform an RRC reconfiguration of the UE. The AN may acknowledge to the AMF that the PDU session information has been received. The AN may notify the AMF that the user plane resource has been configured, and/or provide information relating to the user plane resource configuration.

In the case of a UE-triggered service request procedure, the UE may receive, at 1170, a NAS service accept message from the AMF via the AN. After the user plane resource is configured, the UE may transmit uplink data (for example, the uplink data that caused the UE to trigger the service request procedure).

At 1180, the AMF may update a session management (SM) context of the PDU session. For example, the AMF may notify the SMF (and/or one or more other associated SMFs) that the user plane resource has been configured, and/or provide information relating to the user plane resource configuration. The AMF may provide the SMF (and/or one or more other associated SMFs) with one or more AN tunnel endpoint identifiers of the AN. After the SM context update is complete, the SMF may send an update SM context response message to the AMF.

Based on the update of the session management context, the SMF may update a PCF for purposes of policy control. For example, if a location of the UE has changed, the SMF may notify the PCF of the UE's a new location.

Based on the update of the session management context, the SMF and UPF may perform a session modification. The session modification may be performed using N4 session modification messages. After the session modification is complete, the UPF may transmit downlink data (for example, the downlink data that caused the UPF to trigger the network-triggered service request procedure) to the UE. The transmitting of the downlink data may be based on the one or more AN tunnel endpoint identifiers of the AN.

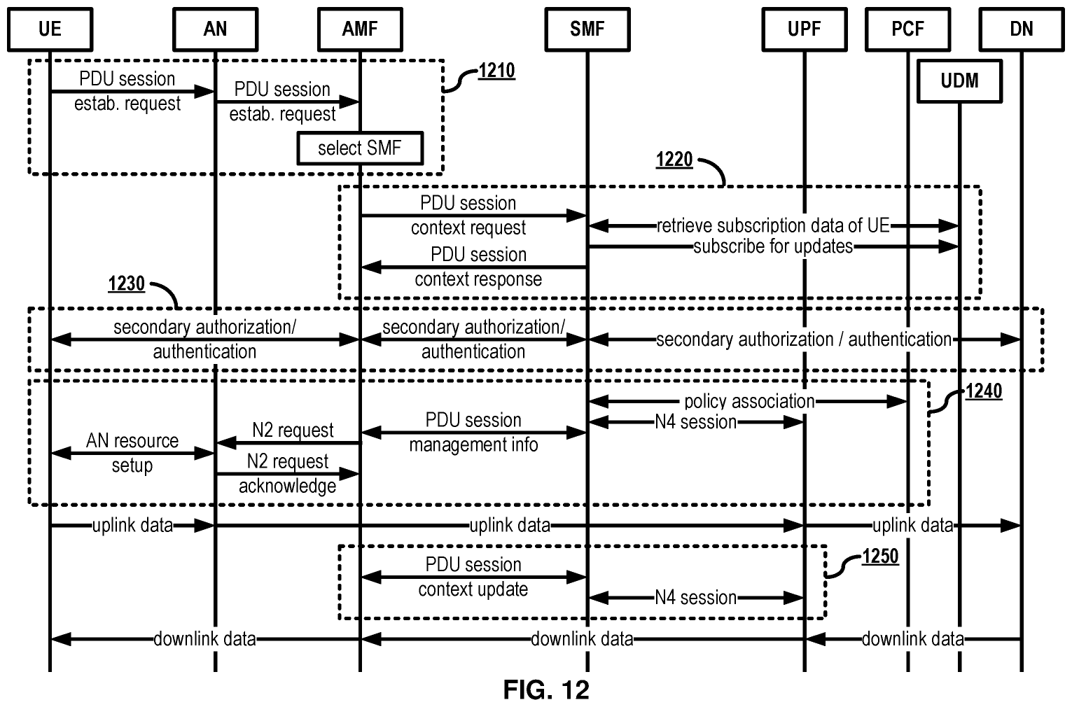

FIG. 12 illustrates an example of a protocol data unit (PDU) session establishment procedure for a wireless device (e.g., a UE). The UE may determine to transmit the PDU session establishment request to create a new PDU session, to hand over an existing PDU session to a 3GPP network, or for any other suitable reason.

At 1210, the UE initiates PDU session establishment. The UE may transmit a PDU session establishment request to an AMF via an AN. The PDU session establishment request may be a NAS message. The PDU session establishment request may indicate: a PDU session ID; a requested PDU session type (new or existing); a requested DN (DNN); a requested network slice (S-NSSAI); a requested SSC mode; and/or any other suitable information. The PDU session ID may be generated by the UE. The PDU session type may be, for example, an Internet Protocol (IP)-based type (e.g., IPv4, IPv6, or dual stack IPv4/IPv6), an Ethernet type, or an unstructured type.

The AMF may select an SMF based on the PDU session establishment request. In some scenarios, the requested PDU session may already be associated with a particular SMF. For example, the AMF may store a UE context of the UE, and the UE context may indicate that the PDU session ID of the requested PDU session is already associated with the particular SMF. In some scenarios, the AMF may select the SMF based on a determination that the SMF is prepared to handle the requested PDU session. For example, the requested PDU session may be associated with a particular DNN and/or S-NSSAI, and the SMF may be selected based on a determination that the SMF can manage a PDU session associated with the particular DNN and/or S-NSSAI.

At 1220, the network manages a context of the PDU session. After selecting the SMF at 1210, the AMF sends a PDU session context request to the SMF. The PDU session context request may include the PDU session establishment request received from the UE at 1210. The PDU session context request may be a Nsmf_PDUSession_CreateSMContext Request and/or a Nsmf_PDUSession_UpdateSMContext Request. The PDU session context request may indicate identifiers of the UE; the requested DN; and/or the requested network slice. Based on the PDU session context request, the SMF may retrieve subscription data from a UDM. The subscription data may be session management subscription data of the UE. The SMF may subscribe for updates to the subscription data, so that the PCF will send new information if the subscription data of the UE changes. After the subscription data of the UE is obtained, the SMF may transmit a PDU session context response to the AMG. The PDU session context response may be a Nsmf_PDUSession_CreateSMContext Response and/or a Nsmf_PDUSession_UpdateSMContext Response. The PDU session context response may include a session management context ID.

At 1230, secondary authorization/authentication may be performed, if necessary. The secondary authorization/authentication may involve the UE, the AMF, the SMF, and the DN. The SMF may access the DN via a Data Network Authentication, Authorization and Accounting (DN AAA) server.

At 1240, the network sets up a data path for uplink data associated with the PDU session. The SMF may select a PCF and establish a session management policy association. Based on the association, the PCF may provide an initial set of policy control and charging rules (PCC rules) for the PDU session. When targeting a particular PDU session, the PCF may indicate, to the SMF, a method for allocating an IP address to the PDU Session, a default charging method for the PDU session, an address of the corresponding charging entity, triggers for requesting new policies, etc. The PCF may also target a service data flow (SDF) comprising one or more PDU sessions. When targeting an SDF, the PCF may indicate, to the SMF, policies for applying QoS requirements, monitoring traffic (e.g., for charging purposes), and/or steering traffic (e.g., by using one or more particular N6 interfaces).

The SMF may determine and/or allocate an IP address for the PDU session. The SMF may select one or more UPFs (a single UPF in the example of FIG. 12) to handle the PDU session. The SMF may send an N4 session message to the selected UPF. The N4 session message may be an N4 Session Establishment Request and/or an N4 Session Modification Request. The N4 session message may include packet detection, enforcement, and reporting rules associated with the PDU session. In response, the UPF may acknowledge by sending an N4 session establishment response and/or an N4 session modification response.

The SMF may send PDU session management information to the AMF. The PDU session management information may be a Namf_Communication_N1N2MessageTransfer message. The PDU session management information may include the PDU session ID. The PDU session management information may be a NAS message. The PDU session management information may include N1 session management information and/or N2 session management information. The N1 session management information may include a PDU session establishment accept message. The PDU session establishment accept message may include tunneling endpoint information of the UPF and quality of service (QoS) information associated with the PDU session.

The AMF may send an N2 request to the AN. The N2 request may include the PDU session establishment accept message. Based on the N2 request, the AN may determine AN resources for the UE. The AN resources may be used by the UE to establish the PDU session, via the AN, with the DN. The AN may determine resources to be used for the PDU session and indicate the determined resources to the UE. The AN may send the PDU session establishment accept message to the UE. For example, the AN may perform an RRC reconfiguration of the UE. After the AN resources are set up, the AN may send an N2 request acknowledge to the AMF. The N2 request acknowledge may include N2 session management information, for example, the PDU session ID and tunneling endpoint information of the AN.

After the data path for uplink data is set up at 1240, the UE may optionally send uplink data associated with the PDU session. As shown in FIG. 12, the uplink data may be sent to a DN associated with the PDU session via the AN and the UPF.

At 1250, the network may update the PDU session context. The AMF may transmit a PDU session context update request to the SMF. The PDU session context update request may be a Nsmf_PDUSession_UpdateSMContext Request. The PDU session context update request may include the N2 session management information received from the AN. The SMF may acknowledge the PDU session context update. The acknowledgement may be a Nsmf_PDUSession_UpdateSMContext Response. The acknowledgement may include a subscription requesting that the SMF be notified of any UE mobility event. Based on the PDU session context update request, the SMF may send an N4 session message to the UPF. The N4 session message may be an N4 Session Modification Request. The N4 session message may include tunneling endpoint information of the AN. The N4 session message may include forwarding rules associated with the PDU session. In response, the UPF may acknowledge by sending an N4 session modification response.

After the UPF receives the tunneling endpoint information of the AN, the UPF may relay downlink data associated with the PDU session. As shown in FIG. 12, the downlink data may be received from a DN associated with the PDU session via the AN and the UPF.

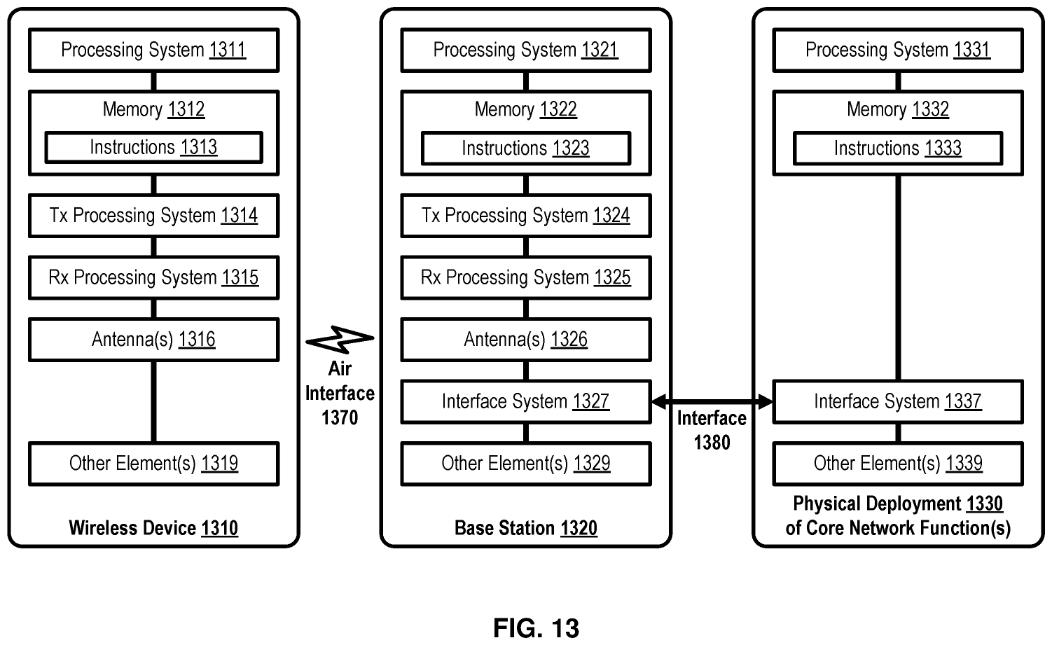

FIG. 13 illustrates examples of components of the elements in a communications network. FIG. 13 includes a wireless device 1310, a base station 1320, and a physical deployment of one or more network functions 1330 (henceforth “deployment 1330”). Any wireless device described in the present disclosure may have similar components and may be implemented in a similar manner as the wireless device 1310. Any other base station described in the present disclosure (or any portion thereof, depending on the architecture of the base station) may have similar components and may be implemented in a similar manner as the base station 1320. Any physical core network deployment in the present disclosure (or any portion thereof, depending on the architecture of the base station) may have similar components and may be implemented in a similar manner as the deployment 1330.

The wireless device 1310 may communicate with base station 1320 over an air interface 1370. The communication direction from wireless device 1310 to base station 1320 over air interface 1370 is known as uplink, and the communication direction from base station 1320 to wireless device 1310 over air interface 1370 is known as downlink. Downlink transmissions may be separated from uplink transmissions using FDD, TDD, and/or some combination of duplexing techniques. FIG. 13 shows a single wireless device 1310 and a single base station 1320, but it will be understood that wireless device 1310 may communicate with any number of base stations or other access network components over air interface 1370, and that base station 1320 may communicate with any number of wireless devices over air interface 1370.

The wireless device 1310 may comprise a processing system 1311 and a memory 1312. The memory 1312 may comprise one or more computer-readable media, for example, one or more non-transitory computer readable media. The memory 1312 may include instructions 1313. The processing system 1311 may process and/or execute instructions 1313. Processing and/or execution of instructions 1313 may cause wireless device 1310 and/or processing system 1311 to perform one or more functions or activities. The memory 1312 may include data (not shown). One of the functions or activities performed by processing system 1311 may be to store data in memory 1312 and/or retrieve previously-stored data from memory 1312. In an example, downlink data received from base station 1320 may be stored in memory 1312, and uplink data for transmission to base station 1320 may be retrieved from memory 1312. As illustrated in FIG. 13, the wireless device 1310 may communicate with base station 1320 using a transmission processing system 1314 and/or a reception processing system 1315. Alternatively, transmission processing system 1314 and reception processing system 1315 may be implemented as a single processing system, or both may be omitted and all processing in the wireless device 1310 may be performed by the processing system 1311. Although not shown in FIG. 13, transmission processing system 1314 and/or reception processing system 1315 may be coupled to a dedicated memory that is analogous to but separate from memory 1312, and comprises instructions that may be processed and/or executed to carry out one or more of their respective functionalities. The wireless device 1310 may comprise one or more antennas 1316 to access air interface 1370.

The wireless device 1310 may comprise one or more other elements 1319. The one or more other elements 1319 may comprise software and/or hardware that provide features and/or functionalities, for example, a speaker, a microphone, a keypad, a display, a touchpad, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, a global positioning sensor (GPS) and/or the like). The wireless device 1310 may receive user input data from and/or provide user output data to the one or more one or more other elements 1319. The one or more other elements 1319 may comprise a power source. The wireless device 1310 may receive power from the power source and may be configured to distribute the power to the other components in wireless device 1310. The power source may comprise one or more sources of power, for example, a battery, a solar cell, a fuel cell, or any combination thereof.

The wireless device 1310 may transmit uplink data to and/or receive downlink data from base station 1320 via air interface 1370. To perform the transmission and/or reception, one or more of the processing system 1311, transmission processing system 1314, and/or reception system 1315 may implement open systems interconnection (OSI) functionality. As an example, transmission processing system 1314 and/or reception system 1315 may perform layer 1 OSI functionality, and processing system 1311 may perform higher layer functionality. The wireless device 1310 may transmit and/or receive data over air interface 1370 using one or more antennas 1316. For scenarios where the one or more antennas 1316 include multiple antennas, the multiple antennas may be used to perform one or more multi-antenna techniques, such as spatial multiplexing (e.g., single-user multiple-input multiple output (MIMO) or multi-user MIMO), transmit/receive diversity, and/or beamforming.

The base station 1320 may comprise a processing system 1321 and a memory 1322. The memory 1322 may comprise one or more computer-readable media, for example, one or more non-transitory computer readable media. The memory 1322 may include instructions 1323. The processing system 1321 may process and/or execute instructions 1323. Processing and/or execution of instructions 1323 may cause base station 1320 and/or processing system 1321 to perform one or more functions or activities. The memory 1322 may include data (not shown). One of the functions or activities performed by processing system 1321 may be to store data in memory 1322 and/or retrieve previously-stored data from memory 1322. The base station 1320 may communicate with wireless device 1310 using a transmission processing system 1324 and a reception processing system 1325. Although not shown in FIG. 13, transmission processing system 1324 and/or reception processing system 1325 may be coupled to a dedicated memory that is analogous to but separate from memory 1322, and comprises instructions that may be processed and/or executed to carry out one or more of their respective functionalities. The wireless device 1320 may comprise one or more antennas 1326 to access air interface 1370.

The base station 1320 may transmit downlink data to and/or receive uplink data from wireless device 1310 via air interface 1370. To perform the transmission and/or reception, one or more of the processing system 1321, transmission processing system 1324, and/or reception system 1325 may implement OSI functionality. As an example, transmission processing system 1324 and/or reception system 1325 may perform layer 1 OSI functionality, and processing system 1321 may perform higher layer functionality. The base station 1320 may transmit and/or receive data over air interface 1370 using one or more antennas 1326. For scenarios where the one or more antennas 1326 include multiple antennas, the multiple antennas may be used to perform one or more multi-antenna techniques, such as spatial multiplexing (e.g., single-user multiple-input multiple output (MIMO) or multi-user MIMO), transmit/receive diversity, and/or beamforming.

The base station 1320 may comprise an interface system 1327. The interface system 1327 may communicate with one or more base stations and/or one or more elements of the core network via an interface 1380. The interface 1380 may be wired and/or wireless and interface system 1327 may include one or more components suitable for communicating via interface 1380. In FIG. 13, interface 1380 connects base station 1320 to a single deployment 1330, but it will be understood that wireless device 1310 may communicate with any number of base stations and/or CN deployments over interface 1380, and that deployment 1330 may communicate with any number of base stations and/or other CN deployments over interface 1380. The base station 1320 may comprise one or more other elements 1329 analogous to one or more of the one or more other elements 1319.

The deployment 1330 may comprise any number of portions of any number of instances of one or more network functions (NFs). The deployment 1330 may comprise a processing system 1331 and a memory 1332. The memory 1332 may comprise one or more computer-readable media, for example, one or more non-transitory computer readable media. The memory 1332 may include instructions 1333. The processing system 1331 may process and/or execute instructions 1333. Processing and/or execution of instructions 1333 may cause the deployment 1330 and/or processing system 1331 to perform one or more functions or activities. The memory 1332 may include data (not shown). One of the functions or activities performed by processing system 1331 may be to store data in memory 1332 and/or retrieve previously-stored data from memory 1332. The deployment 1330 may access the interface 1380 using an interface system 1337. The deployment 1330 may comprise one or more other elements 1339 analogous to one or more of the one or more other elements 1319.

One or more of the systems 1311, 1314, 1315, 1321, 1324, 1325, and/or 1331 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. One or more of the systems 1311, 1314, 1315, 1321, 1324, 1325, and/or 1331 may perform signal coding/processing, data processing, power control, input/output processing, and/or any other functionality that may enable wireless device 1310, base station 1320, and/or deployment 1330 to operate in a mobile communications system.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise computers, microcontrollers, microprocessors, DSPs, ASICs, FPGAs, and complex programmable logic devices (CPLDs). Computers, microcontrollers and microprocessors may be programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

The wireless device 1310, base station 1320, and/or deployment 1330 may implement timers and/or counters. A timer/counter may start at an initial value. As used herein, starting may comprise restarting. Once started, the timer/counter may run. Running of the timer/counter may be associated with an occurrence. When the occurrence occurs, the value of the timer/counter may change (for example, increment or decrement). The occurrence may be, for example, an exogenous event (for example, a reception of a signal, a measurement of a condition, etc.), an endogenous event (for example, a transmission of a signal, a calculation, a comparison, a performance of an action or a decision to so perform, etc.), or any combination thereof. In the case of a timer, the occurrence may be the passage of a particular amount of time. However, it will be understood that a timer may be described and/or implemented as a counter that counts the passage of a particular unit of time. A timer/counter may run in a direction of a final value until it reaches the final value. The reaching of the final value may be referred to as expiration of the timer/counter. The final value may be referred to as a threshold. A timer/counter may be paused, wherein the present value of the timer/counter is held, maintained, and/or carried over, even upon the occurrence of one or more occurrences that would otherwise cause the value of the timer/counter to change. The timer/counter may be un-paused or continued, wherein the value that was held, maintained, and/or carried over begins changing again when the one or more occurrence occur. A timer/counter may be set and/or reset. As used herein, setting may comprise resetting. When the timer/counter sets and/or resets, the value of the timer/counter may be set to the initial value. A timer/counter may be started and/or restarted. As used herein, starting may comprise restarting. In some embodiments, when the timer/counter restarts, the value of the timer/counter may be set to the initial value and the timer/counter may begin to run.

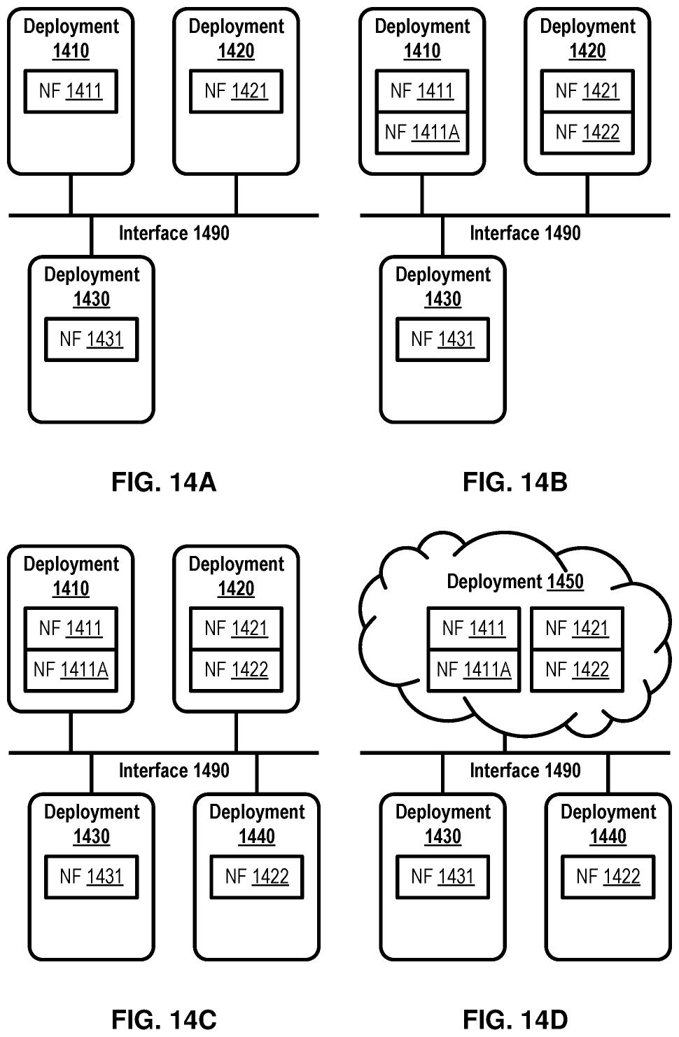

FIGS. 14A, 14B, 14C, and 14D illustrate various example arrangements of physical core network deployments, each having one or more network functions or portions thereof. The core network deployments comprise a deployment 1410, a deployment 1420, a deployment 1430, a deployment 1440, and/or a deployment 1450. Each deployment may be analogous to, for example, the deployment 1330 depicted in FIG. 13. In particular, each deployment may comprise a processing system for performing one or more functions or activities, memory for storing data and/or instructions, and an interface system for communicating with other network elements (for example, other core network deployments). Each deployment may comprise one or more network functions (NFs). The term NF may refer to a particular set of functionalities and/or one or more physical elements configured to perform those functionalities (e.g., a processing system and memory comprising instructions that, when executed by the processing system, cause the processing system to perform the functionalities). For example, in the present disclosure, when a network function is described as performing X, Y, and Z, it will be understood that this refers to the one or more physical elements configured to perform X, Y, and Z, no matter how or where the one or more physical elements are deployed. The term NF may refer to a network node, network element, and/or network device.

As will be discussed in greater detail below, there are many different types of NF and each type of NF may be associated with a different set of functionalities. A plurality of different NFs may be flexibly deployed at different locations (for example, in different physical core network deployments) or in a same location (for example, co-located in a same deployment). A single NF may be flexibly deployed at different locations (implemented using different physical core network deployments) or in a same location. Moreover, physical core network deployments may also implement one or more base stations, application functions (AFs), data networks (DNs), or any portions thereof. NFs may be implemented in many ways, including as network elements on dedicated or shared hardware, as software instances running on dedicated or shared hardware, or as virtualized functions instantiated on a platform (e.g., a cloud-based platform).

FIG. 14A illustrates an example arrangement of core network deployments in which each deployment comprises one network function. A deployment 1410 comprises an NF 1411, a deployment 1420 comprises an NF 1421, and a deployment 1430 comprises an NF 1431. The deployments 1410, 1420, 1430 communicate via an interface 1490. The deployments 1410, 1420, 1430 may have different physical locations with different signal propagation delays relative to other network elements. The diversity of physical locations of deployments 1410, 1420, 1430 may enable provision of services to a wide area with improved speed, coverage, security, and/or efficiency.

FIG. 14B illustrates an example arrangement wherein a single deployment comprises more than one NF. Unlike FIG. 14A, where each NF is deployed in a separate deployment, FIG. 14B illustrates multiple NFs in deployments 1410, 1420. In an example, deployments 1410, 1420 may implement a software-defined network (SDN) and/or a network function virtualization (NFV).

For example, deployment 1410 comprises an additional network function, NF 1411A. The NFs 1411, 1411A may consist of multiple instances of the same NF type, co-located at a same physical location within the same deployment 1410. The NFs 1411, 1411A may be implemented independently from one another (e.g., isolated and/or independently controlled). For example, the NFs 1411, 1411A may be associated with different network slices. A processing system and memory associated with the deployment 1410 may perform all of the functionalities associated with the NF 1411 in addition to all of the functionalities associated with the NF 1411A. In an example, NFs 1411, 1411A may be associated with different PLMNs, but deployment 1410, which implements NFs 1411, 1411A, may be owned and/or operated by a single entity.

Elsewhere in FIG. 14B, deployment 1420 comprises NF 1421 and an additional network function, NF 1422. The NFs 1421, 1422 may be different NF types. Similar to NFs 1411, 1411A, the NFs 1421, 1422 may be co-located within the same deployment 1420, but separately implemented. As an example, a first PLMN may own and/or operate deployment 1420 having NFs 1421, 1422. As another example, the first PLMN may implement NF 1421 and a second PLMN may obtain from the first PLMN (e.g., rent, lease, procure, etc.) at least a portion of the capabilities of deployment 1420 (e.g., processing power, data storage, etc.) in order to implement NF 1422. As yet another example, the deployment may be owned and/or operated by one or more third parties, and the first PLMN and/or second PLMN may procure respective portions of the capabilities of the deployment 1420. When multiple NFs are provided at a single deployment, networks may operate with greater speed, coverage, security, and/or efficiency.

FIG. 14C illustrates an example arrangement of core network deployments in which a single instance of an NF is implemented using a plurality of different deployments. In particular, a single instance of NF 1422 is implemented at deployments 1420, 1440. As an example, the functionality provided by NF 1422 may be implemented as a bundle or sequence of subservices. Each subservice may be implemented independently, for example, at a different deployment. Each subservices may be implemented in a different physical location. By distributing implementation of subservices of a single NF across different physical locations, the mobile communications network may operate with greater speed, coverage, security, and/or efficiency.

FIG. 14D illustrates an example arrangement of core network deployments in which one or more network functions are implemented using a data processing service. In FIG. 14D, NFs 1411, 1411A, 1421, 1422 are included in a deployment 1450 that is implemented as a data processing service. The deployment 1450 may comprise, for example, a cloud network and/or data center. The deployment 1450 may be owned and/or operated by a PLMN or by a non-PLMN third party. The NFs 1411, 1411A, 1421, 1422 that are implemented using the deployment 1450 may belong to the same PLMN or to different PLMNs. The PLMN(s) may obtain (e.g., rent, lease, procure, etc.) at least a portion of the capabilities of the deployment 1450 (e.g., processing power, data storage, etc.). By providing one or more NFs using a data processing service, the mobile communications network may operate with greater speed, coverage, security, and/or efficiency.

As shown in the figures, different network elements (e.g., NFs) may be located in different physical deployments, or co-located in a single physical deployment. It will be understood that in the present disclosure, the sending and receiving of messages among different network elements is not limited to inter-deployment transmission or intra-deployment transmission, unless explicitly indicated.

In an example, a deployment may be a ‘black box’ that is preconfigured with one or more NFs and preconfigured to communicate, in a prescribed manner, with other ‘black box’ deployments (e.g., via the interface 1490). Additionally or alternatively, a deployment may be configured to operate in accordance with open-source instructions (e.g., software) designed to implement NFs and communicate with other deployments in a transparent manner. The deployment may operate in accordance with open RAN (O-RAN) standards.

In an example embodiment, a per packet performance measurement may comprise per packet performance measurement for a packet of a QoS flow. In an example, the per packet performance measurement may comprise measurement of delay, or other measurements applicable to a single packet (e.g., at a per packet granularity, individual packet granularity, and/or the like). The single packet may be part of a PDU session, a QoS flow, or a connection between a UE and an AF/AS. In an example, the per packet performance measurement may comprise per packet performance monitoring, per packet performance reporting, and/or the like.

3GPP systems such as (5G system, 6G systems, and/or the like) may be required to provide specific communication services for different vertical domains e.g., critical infrastructure control, safe and efficient transport, integrated systems, environmental control, etc. Considering the communication QoS will be the key factor to impact vertical applications, it is very important to support QoS monitoring. However, the vertical industry applications have stringent communication service performance requirements. The existing QoS monitoring enabled by the 5G system may not support sufficient monitoring and reporting granularity for network operators and vertical industry users to accurately and instantly determine whether the service fault or interruption is caused by the communication network. For example, motion control may be a typical use case in factory automation and it has stringent requirements in latency, service availability and reliability. Taking 500 s transfer interval and survival time as an example, 2000 messages are delivered per second, and an immediate service disruption will be caused if one message is delayed or failed.

In another example, a high-speed current differential protection may be a typical use case of power distribution automation, which could benefit from support of sub-millisecond fault detection. For example, it could be that a protection relay collects samples at a frequency of 600 Hz, 1200 Hz, 1600 Hz, or 3000 Hz, which indicates that thousands of samples may be delivered in one second. If the protection relay does not receive the remote sample from the remote protection relay within a certain period of time, it will enter blocking mode, which may cause a false trip and further negatively impact a smart grid availability and reliability.

In an example, in some practical applications, the delay problems may not be caused by the communication network. Therefore, the network operators need to prove this for the vertical industry users when there is service fault or disruption for vertical industry applications, such as motion control and high speed current differential protection. In existing technologies, QoS monitoring and measurement result reporting methods do not provide accurate information and may lead to false detections and failure of the network to act in response to exceeding delays, due to not providing measurements and reports at a granularity of per packet level. Existing technologies support QoS monitoring of all the packets in a QoS flow. Therefore, the reported monitoring results may be the average results of several packets, which will lead to inaccurate evaluation and false fault detection. Existing technologies may configure the network to provide a per QoS flow measurement and reporting and may not be accurate. As a result, the network may not perform measurements and reporting on a per packet basis and may lead to service fault and disruption of critical infrastructure control.

Example embodiments improve system performance by signalling enhancements between control plane nodes and user plane nodes for configuration and reporting of per packet measurement reports. Per packet QoS monitoring may be employed to determine whether the delay is caused by the communication network. It may also determine whether the delay is caused by which part inside the 3GPP network, e.g., air interface, CU/DU interface, NG interface, N3 interface, N4 interface, and/or the like. In addition, activation and deactivation of QoS monitoring with per packet granularity may be supported to avoid network burden. In an example, the example embodiments may enhance signalling among control plane nodes.

### Example Embodiments

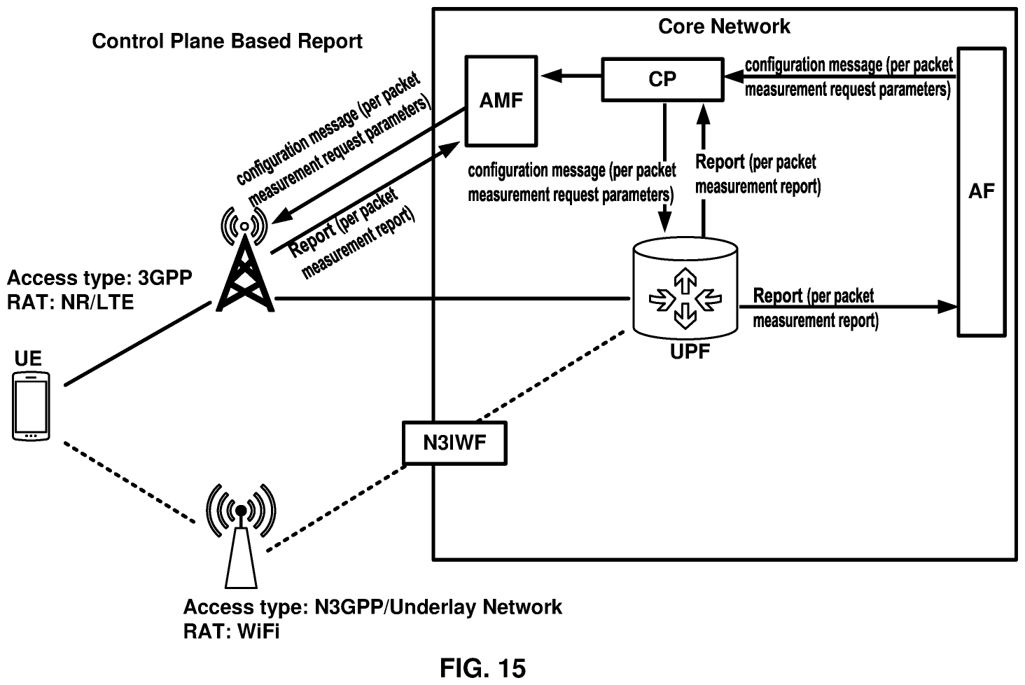

In an example embodiment as depicted in FIG. 15, a network may be configured by a network node such as AS or AF to send a performance measurement report for a single packet of a QoS flow. In an example, a user plane network node such as a UPF of the network may receive a request from a network node e.g., a control plane node (such as SMF, NEF, TSCTSF, PCF, AF, and/or the like) to send the performance measurement report for the single packet. In an example, the AF or the AS may send a request to an NEF to send the performance measurement report for the single packet, wherein the request may comprise a parameter indicating configuration of a per packet performance measurement.

In an example, the request may comprise an identification parameter of a single packet of the QoS flow (e.g., a parameter identifying the single packet for which the measurement and/or reporting is to be performed). In an example, per packet performance measurement may be a per packet QoS measurement/monitoring, per packet delay measurement/monitoring, and/or the like. In an example, per packet performance reporting may be a per packet QoS reporting, per packet delay reporting, and/or the like. In an example, the identification parameter of a single packet of the QoS flow may comprise an identifier of the single packet. The identifier of the single packet may uniquely identify a packet, a frame, a segment, and/or the like. For example if the packet (e.g., the single packet) is an IP packet, the identifier may be an identification field and may be employed for uniquely identifying a group of fragments of a single IP datagram. If a packet is an Ethernet frame, the identifier may be a 802.1Q VLAN tag that may use an 0x8100 EtherType value and the payload following includes a 16-bit tag control identifier (TCI) followed by an Ethernet frame beginning with a second (original) EtherType field for consumption by end stations. In an example, a cyclic redundancy check (CRC) value, checksum, and/or the like of the packet or the frame may be employed to identify the packet or the frame.

In example embodiments, method, and procedures that are applicable to the base station, or RAN, NG-RAN node may be applicable to non-3GPP access and/or N3IWF.

In an example embodiment, a base station (RAN node) may receive a request from a network node e.g., a control plane node (such as AMF, SMF, NEF, PCF, AF, and/or the like) to send the performance measurement report for the single packet. In an example, the network node may send a request to the base station to send the performance measurement report for the single packet, wherein the request may comprise the parameter indicating configuration of a per packet performance measurement.

In an example, the parameter may comprise at least one of an indication to start per packet performance monitoring, an indication to stop per packet performance monitoring, an indication of uplink or downlink direction, a time duration of per packet monitoring, a periodicity of per packet monitoring, a periodicity of per packet reporting, a condition for per packet reporting, a packet count for per packet monitoring, and/or the like. In an example, the parameter may comprise a threshold value for reporting; for example, the parameter may indicate that the reporting of the performance measurement of the single packet to be performed when the delay or estimated delay of the single packet is above, below or equal the threshold value. In an example, the condition for per packet reporting may be based on the threshold wherein the conditional reporting may be implemented at selected network nodes. In an example, the parameter may comprise an identifier of the single packet, the identification parameter of a single packet of the QoS flow, and/or the like. The identifier may uniquely identify a packet, a frame, a segment, and/or the like. For example if the packet is an IP packet, the identifier may be an identification field and may be employed for uniquely identifying a group of fragments of a single IP datagram. If a packet is an ethernet frame, the identifier may be a 802.1Q VLAN tag that may use an 0x8100 EtherType value and the payload following includes a 16-bit tag control identifier (TCI) followed by an Ethernet frame beginning with a second (original) EtherType field for consumption by end stations. In an example, a cyclic redundancy check (CRC) value, checksum, and/or the like of the packet or the frame may be employed to identify the packet or the frame. In an example, the identification parameter may comprise a set of filters such as packet filter sets. For example, for IP PDU Session Type, the Packet Filter Set may support Packet Filters based on at least any combination of:
The identification field, the identifier or the identification parameter of a single packet of the QoS flow.
Source/destination IP address or IPv6 prefix.
Source/destination port number.
Protocol ID of the protocol above IP/Next header type.
Type of Service (TOS) (IPv4)/Traffic class (IPv6) and Mask.
Flow Label (IPv6).
Security parameter index.
Packet Filter direction.

For example, for Ethernet PDU Session Type, the Packet Filter Set may support Packet Filters based on at least any combination of:
The identification field, the identifier or an identification parameter of a single frame of a stream of Ethernet packets.
Source/destination MAC address.
Ethertype as defined in IEEE 802.3.
Customer-VLAN tag (C-TAG) and/or Service-VLAN tag (S-TAG) VID fields as defined in IEEE Std 802.1Q.
Customer-VLAN tag (C-TAG) and/or Service-VLAN tag (S-TAG) PCP/DEI fields as defined in IEEE Std 802.1Q.
IP Packet Filter Set, in the case that Ethertype indicates IPv4/IPv6 payload.
Packet Filter direction.

In an example, the parameter may comprise a (special) packet header field and/or value (for per packet performance measurement) to be employed by the network for detection wherein the detected packets that contain the (special) packet header field and/or value are subject to per packet monitoring, measurement and reporting. In an example, the detection of the packet header field may be preconfigured in the network to be detected and per packet measurement report may be sent for packets that contain the (special) packet header field and/or value.

In an example embodiment, in response to receiving the request and based on the parameter, the UPF may send a report to the control plane network node (e.g., the SMF, NEF, PCF, TSCTSF, AF, and/or the like). In an example, the report may comprise measurement data of the single packet.

In an example embodiment, in response to receiving the request and based on the parameter, the base station (the RAN node) may send a report to the control plane network node (e.g., the AMF, SMF, NEF, PCF, TSCTSF, AF, and/or the like). In an example, the report may comprise measurement data of the single packet.

In an example, the measurement data may comprise at least one of timestamp value of the packet, an identifier of the packet, time synchronization parameters, processing delay at the network node, residence time of the packet at the network node (e.g., time duration (difference) between the packet at the ingress and egress interface (port)), and/or the like.

In an example, if the UPF determines delay value of the single packet, the report may comprise delay measurement data, or a delay value. In an example, if the base station (RAN node) determines delay value of the single packet, the report may comprise delay measurement data, or the delay value.

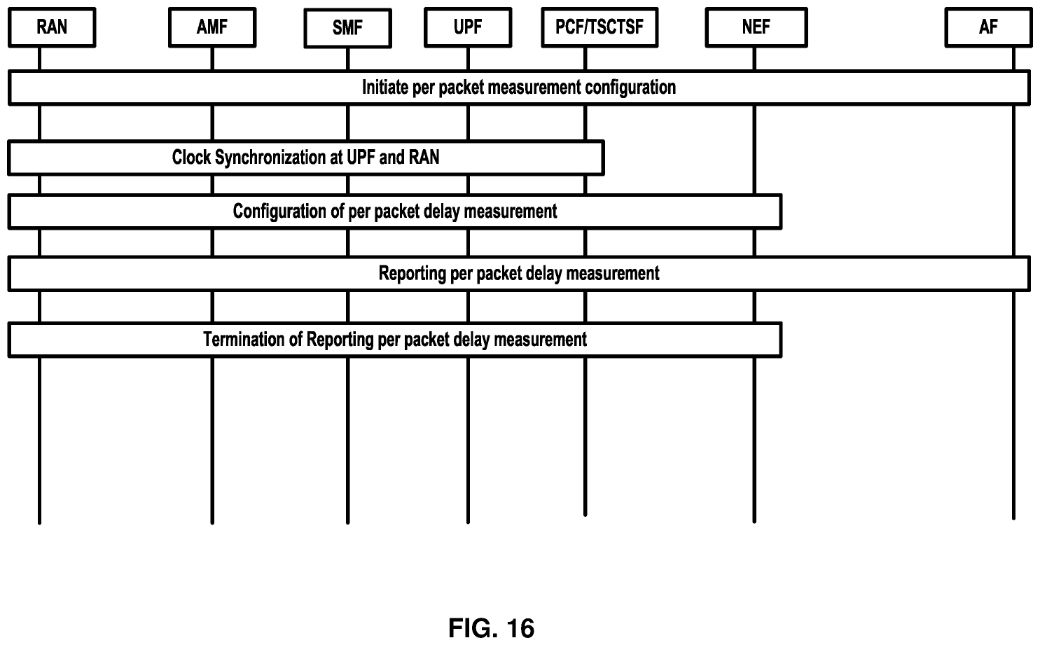

FIG. 16 illustrates an example configuration procedure for information exposure and information reporting in a network in accordance with embodiments of the present disclosure. The example embodiments may enhance the accuracy of the per packet monitoring, measurement and reporting by performing time synchronization procedures for the network nodes that perform monitoring, measurement and reporting. For example, upon receiving a request for configuration of per packet performance measurement, the network may determine the clock quality or clock synchronization quality of the nodes such as the UPF, the RAN node, and/or the like. In an example, time synchronization parameters may be updated or refreshed. In an example, a new time synchronization procedure may be performed. In an example, the network may configure the base station, and the UPF to to send the performance measurement report for the single packet. In an example, based on the configuration and/or the parameter indicating configuration of a per packet performance measurement, the UPF and/or the base station may send the report to the network (e.g., the control plane node).

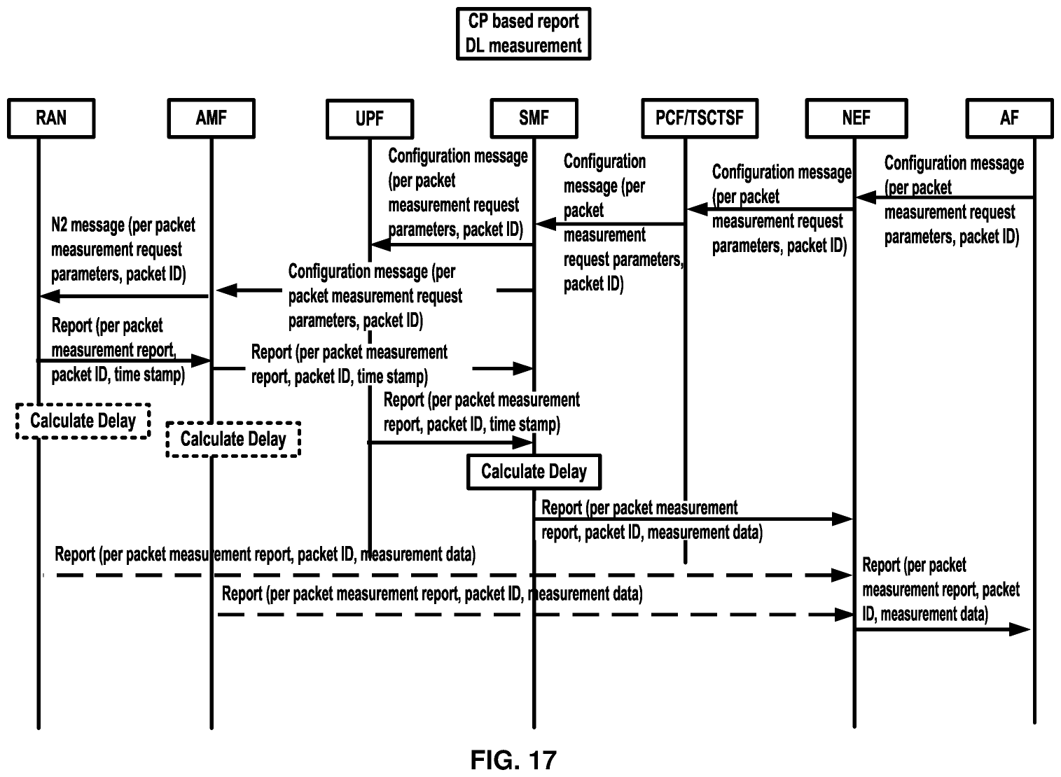

FIG. 17 illustrates an example configuration procedure for information exposure and information reporting in a network in accordance with embodiments of the present disclosure. The example embodiment may enhance the efficient and in time delivery of delay sensitive packets by configuring the UPF to report per packet measurement data of a single packet. In the example embodiment, processing of measured data may be performed by the SMF. Doing so may reduce the overhead of the user plane function and further improve utilization of resources.

In an example embodiment, the AF may send a configuration message to the NEF. In an example, the configuration message may be a message from NEF services e.g., Nnef. In an example, the configuration message may comprise the parameter indicating configuration of a per packet performance measurement. In an example, the configuration message may comprise the identification parameter of the single packet of the QoS flow (e.g., the parameter identifying the single packet for which the measurement and/or reporting is to be performed).

In an example, the AF may provide further parameters associated with the single packet description. For example, the parameters that describe the single packet to be monitored may comprise packet characteristics.

The PCF may generate a PCC Rule with service data flow filter (including IP Packet Filter set) or Ethernet Packet Filter set derived from the Flow Descriptions provided by the AF.

In an example embodiment, the NEF may send a configuration message to at least one of a PCF, a TSCTSF, or SMF. In an example, the configuration message may be Npcf message, Ntsctsf message, Nsmf message, and/or the like. In an example, the configuration message may comprise the parameter indicating configuration of a per packet performance measurement. In an example, the configuration message may comprise the identification parameter of the single packet of the QoS flow (e.g., the parameter identifying the single packet for which the measurement and/or reporting is to be performed).

In an example embodiment, the NEF may send a configuration message to the UPF. The configuration message may employ Nupf messages or services to directly configure the UPF. In an example, the configuration message may be an Nupf message. In an example, the configuration message may comprise the parameter indicating configuration of a per packet performance measurement. In an example, the configuration message may comprise the identification parameter of the single packet of the QoS flow (e.g., the parameter identifying the single packet for which the measurement and/or reporting is to be performed).

In an example embodiment, the SMF may receive the configuration message. In an example, the SMF may determine to perform configuration of the UPF for per packet performance measurement, monitoring, and/or reporting. In an example, the SMF may send to the UPF, a configuration message wherein the configuration message may be an N4 session establishment/setup/modification request message, a PFCP session establishment/setup/modification request message, and/or the like. In an example, the configuration message may be an N4 association establishment/setup/modification request message, a PFCP association establishment/setup/modification request message, and/or the like. In an example, the configuration message may comprise the parameter indicating configuration of a per packet performance measurement. In an example, the configuration message may comprise the identification parameter of the single packet of the QoS flow (e.g., the parameter identifying the single packet for which the measurement and/or reporting is to be performed). In an example, the UPF may send a configuration response message such as an N4 session establishment/setup/modification response message, a PFCP session establishment/setup/modification response message, an N4 association establishment/setup/modification response message, a PFCP association establishment/setup/modification response message, and/or the like.

In an example, the UPF may send a report to the control plane network node (e.g., the SMF, NEF, PCF, TSCTSF, AF, and/or the like). In an example, the report may comprise measurement data of the single packet of the QoS flow or the PDU session. In an example, the measurement data may comprise at least one of a timestamp value of the packet, an identifier of the packet, time synchronization parameters, processing delay at the network node (the UPF), residence time of the packet at the network node (e.g., time duration (difference) between the packet at the ingress and egress interface (port)), and/or the like. In an example, the UPF may send the report to the NEF. In an example, the UPF may send the report to the SMF. In an example, the UPF may send the report to the control plane network node. In an example, the NEF may send the report to the AF. In an example, the control plane node may send the report to the AF. In an example, the report may comprise a delay value of the single packet calculated by a network node such as the SMF, NEF, TSCTSF, PCF, and/or the like.

In an example embodiment, the base station may receive a configuration message from a core network node. In an example, the core network node may be the AMF, SMF, PCF, NEF, TSCTSF, and/or the like. In an example, the configuration message may be an N2 message, NGAP message, a PDU session resource setup message, and/or the like. In an example, the configuration message may comprise the parameter indicating configuration of a per packet performance measurement. In an example, the configuration message may comprise the identification parameter of the single packet of the QoS flow (e.g., the parameter identifying the single packet for which the measurement and/or reporting is to be performed). In an example, the base station may send a configuration response message (for example, a PDU session resource setup response message) to the core network node. In an example embodiment, the base station in response to receiving the configuration message may determine to monitor and perform a per packet measurement (e.g., on a single packet of the QoS flow, or PDU session) based on the parameter indicating configuration of a per packet performance measurement.

In an example, the base station may send a report to the control plane network node (e.g., the AMF, SMF, NEF, PCF, TSCTSF, AF, and/or the like). In an example, the report may comprise measurement data of the single packet of the QoS flow or the PDU session. In an example, the measurement data may comprise at least one of a timestamp value of the packet, an identifier of the packet, time synchronization parameters, processing delay at the network node (the base station), residence time of the packet at the network node (e.g., time duration (difference) between the packet at the ingress and egress interface (port)), and/or the like. In an example, the AMF may receive the report from the base station. In an example, the AMF may send the report to the SMF. In an example, the AMF may send the report to the NEF. In an example, the report may comprise a delay value of the single packet if the AMF or the base station provide the delay value of the single packet. In an example, the report may comprise per packet/individual measurement data of multiple packets.

In an example embodiment, a network node dedicated for per packet performance measurement and reporting may be employed. The network node may be an external application server/function, or a new core network node for example, per packet performance measurement (PPPM) node.

In an example, when a report is sent to the NEF, PCF, TSCTSF, AF, and/or the like, the report may comprise a delay value of the single packet calculated by a network node such as the PPPM, SMF, AMF, UPF, base station, and/or the like.

In an example, the report may be sent to the PPPM, the SMF, the NEF, PCF, TSCTSF, and/or the like. For example, if the SMF receives the per packet performance measurement data, the SMF may process the data and calculate the performance metrics such as delay for the single packet. In an example, the SMF may receive from the UPF a report comprising the measurement data of the single packet at the UPF. In an example, the SMF may receive a report comprising the measurement data of the single packet at the base station. In an example, the SMF may compare the time stamp values for the measurement data with the same identifier of the packet and derive a delay value of the single packet. In an example, delay calculations may be impacted if time synchronization is not done and clocks of the UPF and the base station are not synchronized. In example embodiments, same example procedure may be performed when a different network node such as the PPPM, NEF, PCF, TSCTSF, AF, and/or the like is employed instead of the SMF.

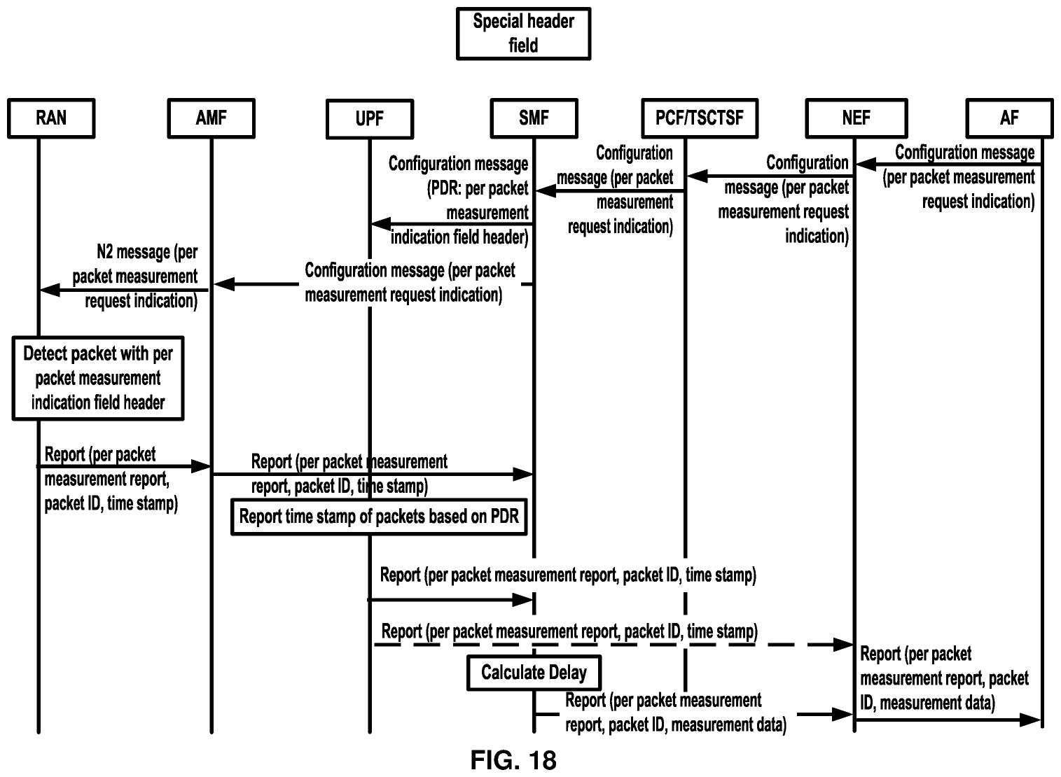

FIG. 18 illustrates an example configuration procedure for information exposure and information reporting in a network in accordance with embodiments of the present disclosure. The example embodiment employs a (special) packet header field and/or value within a packet indicating that the packet is subject to per packet performance measurement and reporting. In an example, (special) packet header field and/or value may be a marker for per packet performance measurement. The marker may be a flag, a byte, a bit indication or another marker e.g., per packet monitoring (PPM), or the like. The example embodiment may be beneficial because of reduced number of information elements in the configuration messages. The (special) packet header field and/or value may be preconfigured in the network to be detected and per packet measurement report may be sent for packets that contain the (special) packet header field and/or value. In an example, when the AF determines to trigger the per packet performance measurement of single packets, the AF may construct selected packets that are subject to per packet performance measurement. The UPF and the base station may detect the packets based on the special header and send individual reports. The UPF and/or the base station may construct a report that may comprise the measurement data (e.g., per packet/individual measurement data) for multiple packets and send the report with a certain frequency or within a set (or a determined) time duration.

In an example embodiment, single packets that are subject to the per packet performance measurement may be marked with the special header field and/or value. In an example, the header field and/or value may be indicated in the configuration message that is transmitted from the network to the UPF and to the base station via the configuration messages as described in the example embodiments. In an example, the parameter indicating configuration of a per packet performance measurement may comprise the (special) packet header field and/or value. In an example, the (special) packet header field and/or value may be preconfigured in the network nodes and upon receiving the request for per packet performance measurement, the single packet with the (special) packet header field and/or value may be detected by the UPF and the base station and reporting for the single packet may be performed. For example, the UPF may detect the single packet with the the (special) packet header field and/or value. The UPF may determine to send a report comprising at least one of a timestamp value of the single packet, and an identifier of the packet. In an example, the detection may be based on packet detection rules (PDR) sent to the UPF by the SMF. For example, the base station may detect the single packet with the the (special) packet header field and/or value. The base station may determine to send a report comprising at least one of a timestamp value of the single packet, and an identifier of the packet.

In an example embodiment, the parameter indicating configuration of a per packet performance measurement may comprise an indication to start per packet performance measurement/monitoring/reporting. The user plane network node may send the report for the single packet (e.g., individual packets or per packet reports) to the control plane network node. In an example, the user plane network node may receive an indication to stop the per packet performance measurement/monitoring/reporting. In an example, in response to receiving the indication to stop the per packet performance measurement/monitoring/reporting, the user plane network node may stop sending the per packet reports. In an example, the message (e.g., the configuration message) may comprise parameters such as frequency of reports, intervals between reports, number of packets to be reported, a time duration for which the user plane node may perform the per packet performance measurement and reporting, and/or the like. For example, the user plane network node in response to receiving the indication to start per packet performance measurement and reporting, may send the report for individual packets for the time duration as specified by the configuration message. For example, the user plane network node in response to receiving the indication to start per packet performance measurement and reporting, may send the report for individual packets based on the frequency as specified by the configuration message e.g., send the report every n seconds wherein n is an integer value. For example, the user plane network node in response to receiving the indication to start per packet performance measurement and reporting, may send the report for individual packets for a number of packets as specified by the packet count value e.g., send the report for k number of packets wherein k is an integer value.

In an example embodiment, per packet performance measurement/monitoring/reporting may be performed based on an event, an indication, and/or the like. For example, the control plane network node (e.g., the SMF, NEF, PCF, AF, AMF, TSCTSF, and/or the like) may send a message (e.g., the configuration message) to the user plane network node (e.g., the base station, the UPF, and/or the like). In an example, the message or the parameter indicating configuration of a per packet performance measurement may comprise an indication to start per packet performance measurement/monitoring/reporting. The user plane network node may send the report for the single packet (e.g., individual packets or per packet reports) to the control plane network node. In an example, the user plane network node may receive an indication to stop the per packet performance measurement/monitoring/reporting. In an example, in response to receiving the indication to stop the per packet performance measurement/monitoring/reporting, the user plane network node may stop sending the per packet reports. In an example, the message (e.g., the configuration message) may comprise parameters such as frequency of reports, intervals between reports, number of packets to be reported, time duration for which the user plane node may perform the per packet performance measurement and reporting, and/or the like.

In an example, the report may comprise a delay value of the single packet calculated by a network node such as the PPPM, SMF, NEF, TSCTSF, PCF, and/or the like. In an example, the report may comprise measurement data or delay value of multiple packets. For example, the report may comprise individual tuples such as (packet 1, measurement data of packet 1); (packet 2, measurement data of packet 2); (packet k, measurement data of packet k); (packet n, measurement data of packet n).

An example embodiment may enhance the signaling performance of the network by configuring the UPF to report per packet measurement data of a single packet. In an example, the single packet may be part of a QoS flow. In an example, the QoS flow may be associated with a PDU session. In an example, the configuration may be performed based on node level signaling. Doing so may reduce the signaling overload by avoiding session level signaling and hence reduce the number of signaling messages as the number of the UEs and session increase. The example embodiment, employs node level configuration via PCF service as well as PFCP association procedures for configuration of the UPF by the SMF. In an example, the UPF may be configured to send a performance measurement report for a single packet (e.g., per packet granularity) of a QoS flow. In an example, the single placket may be of the QoS flow, a PDU session, a GTP-U path, a GTP-U connection, and/or the like. In an example, the reporting may be performed for a time duration as specified during the configuration. In an example, the reporting may be performed at a frequency or rate as specified by the configuration. In an example, the reporting may be performed for a number of packets such as packet count as specified by the configuration. In an example, the reporting may be performed on a packet identified by the core network (e.g., the AF, NEF, PCF, SMF, and/or the like). In an example, the packet may be identified by a unique identifier indicated in a field of the packet header. In an example, the NEF may employ event exposure service of the PCF to configure the UPF to send the performance measurement report for the single packet. In an example, the NEF or the AF may employ the event exposure service of the PCF to configure the UPF to send the performance measurement report for the single packet e.g., the report (event) as described in an example embodiment.

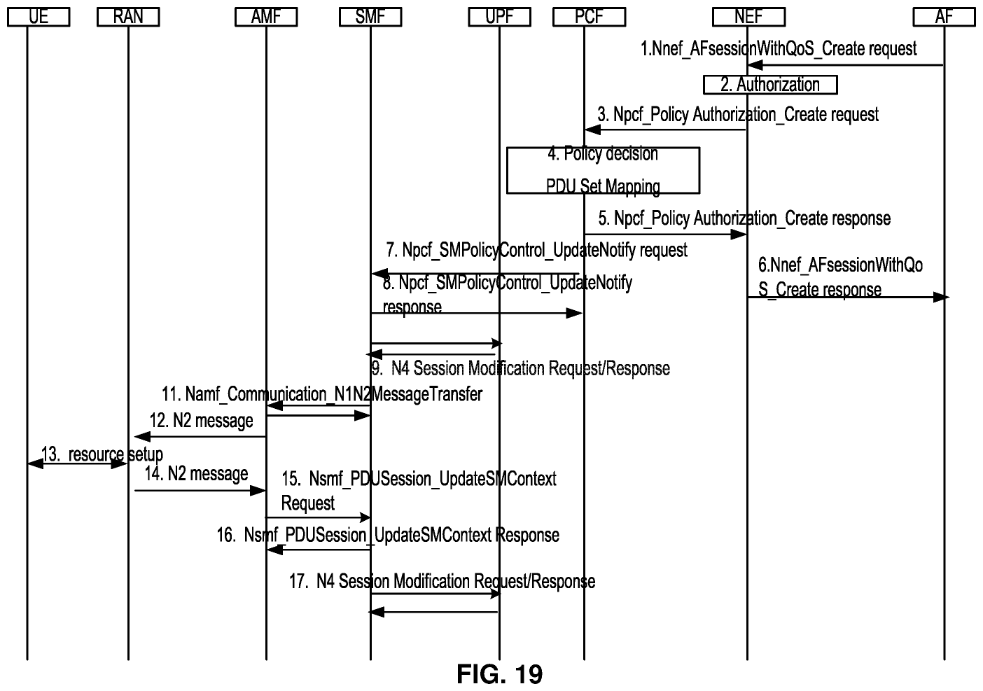

FIG. 19 illustrates an example event exposure subscription procedure in a network in accordance with embodiments of the present disclosure. In an example, the AF may subscribe to an event such as the Network Congestion (e.g., RAN congestion) by sending Nnef_EventExposure_Subscribe request (comprising: UE address, event ID(s)). In an example, the NEF may authorize the AF request. The NEF may interact with the PCF by triggering a Npcf_PolicyAuthorization_Subscribe request to the Network Congestion (e.g. RAN congestion) event. Upon reception of the subscribe request of Network Congestion for a UE address, the PCF may generate a QoS rule for RAN to report RAN's congestion. The PCC rule includes an indication that the PCC rule is used for RAN report information. The PCF may generate a QoS monitoring policy for network congestion measurement. The PCF may respond to the NEF a Npcf_Policy Authorization_Create response. The NEF may send a Nnef_AFsessionWithQoS_Create response message to the AF. In an example, the PCF may initiate SM Policy Association Modification Request (PCC rule) to the SMF. In an example, the SMF may map a QoS flow for the PCC rule from the PCF. In an example, the QoS flow's QoS profile may include the indication that the QoS flow is used for RAN report information. In an example, the SMF may generate the QoS Monitoring configuration for UPF to perform e.g., RAN congestion detection indication. The SMF may generate the QoS Monitoring configuration for RAN: RAN congestion measurement indication, measure frequency, report threshold. The SMF may reply with SM Policy Association Modification Response to the PCF. The SMF may initiate N4 Session Modification Request (QoS Monitoring configuration, QoS rule) to the UPF. In an example, upon reception of QoS Monitoring configuration, the UPF may enable the RAN's congestion detection and report. In an example, the UPF(s) may respond to the SMF. For SMF requested modification, the SMF may invoke Namf_Communication_N1N2MessageTransfer ([N2 SM information](PDU Session ID, QFI(s), QoS Profile(s), QoS Monitoring configuration), N1 SM container)). In an example, the AMF may send N2 ([N2 SM information received from SMF], NAS message (PDU Session ID, N1 SM container (PDU Session Modification Command))) Message to the (R)AN. In an example, upon reception of QoS flow's QoS profile and the indication that the QoS flow is used for RAN report information, the RAN may skip to map DRB for the QoS flow and make the QoS flow terminated between the RAN and the UPF. Upon reception of QoS Monitoring configuration, the RAN may enable the RAN congestion measurement and report. The (R)AN may acknowledge N2 PDU Session Request by sending a N2 PDU Session Ack Message to the AMF. The AMF may forward the N2 SM information and the User location Information received from the AN to the SMF via Nsmf_PDUSession_UpdateSMContext service operation. The SMF replies with a Nsmf_PDUSession_UpdateSMContext Response. The SMF may update N4 session of the UPF(s) that are involved by the PDU Session Modification by sending N4 Session Modification Request message to the UPF.

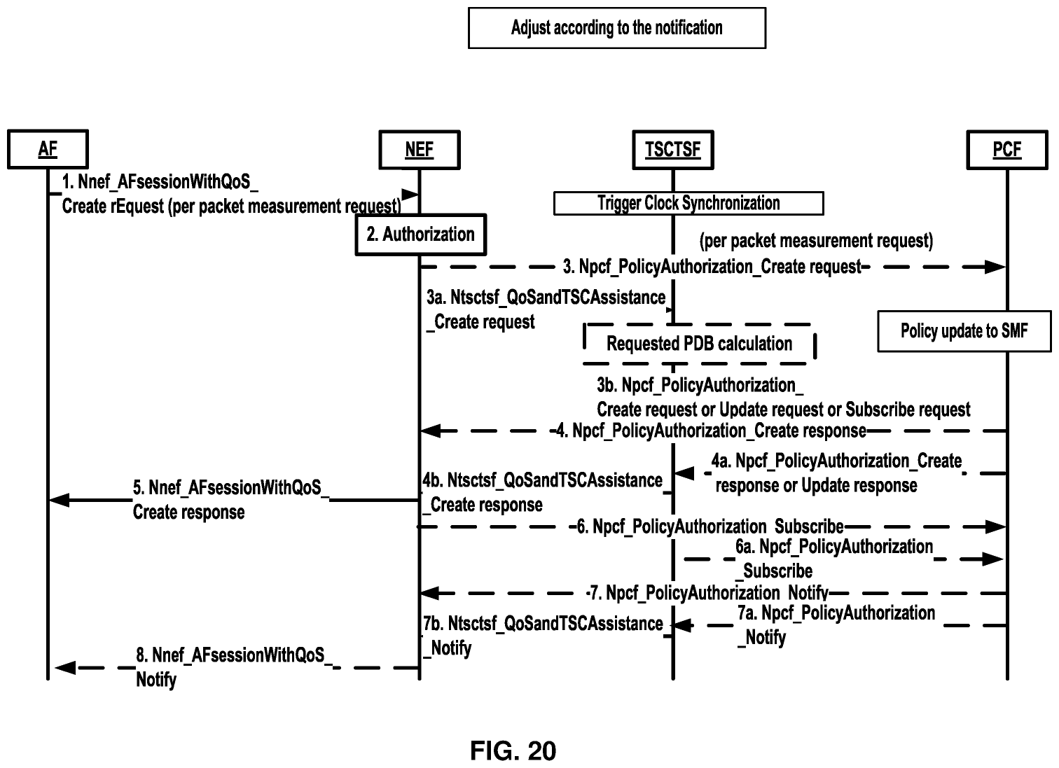

FIG. 19 and FIG. 20 illustrate an example configuration procedure for information exposure and information reporting in a network in accordance with embodiments of the present disclosure. The example embodiment may enhance the signaling performance of the network by triggering a PDU session modification or network initiated signaling to perform authorization and configuration of the per packet performance measurement.

In an example embodiment, the AF may sends a request to reserve resources for an AF session using Nnef_AFsessionWithQoS_Create request message that may comprise one or more elements of the configuration message sent from the AF to the NEF, per packet performance measurement information, UE address, AF Identifier, Flow description information or External Application Identifier, QoS Reference or individual QoS parameters, Alternative Service Requirements, and/or the like, to the NEF. In an example, the per packet performance measurement information may comprise the parameter indicating configuration of a per packet performance measurement. In an example, the per packet performance measurement information may comprise description of packets for which per packet monitoring is to be performed. For example, the description may comprise the identifier of the single packet, the packet header field such as the PPM marker as described in an example embodiment. In an example, a period of time or a traffic volume for the requested per packet measurement may be included in the AF request. In an example, a period of time or a traffic volume for the requested QoS may be included in the AF request. The AF may, instead of a QoS Reference, provide one or more of the following individual QoS parameters: Requested 5GS Delay (optional), Requested Priority (optional), Requested Guaranteed Bitrate, Requested Maximum Bitrate, Maximum Burst Size. Regardless of whether the AF request is formulated using a QoS Reference or individual QoS parameters, the AF may also provide one or more of the following parameters that describe the traffic characteristics flow direction, Burst Arrival Time at UE (uplink) or UPF (downlink), Periodicity, Time domain, Survival Time.

In an example, the NEF may assign a transaction reference ID to the Nnef_AFsessionWithQoS_Create request. The NEF authorizes the AF request and may apply policies to control the overall amount of QoS authorized for the AF. In an example, the NEF may determine whether to invoke the TSCTSF or to directly contact the PCF based on operator configuration. This determination may use the presence of the per packet performance measurement information, or a QoS Reference or individual QoS parameters in the AF request. The determination may also use the AF identifier or the presence of AF provided parameters that describe the traffic characteristics.

If the NEF determines to contact the PCF directly without invoking the TSCTSF, the NEF uses the UE address to discover the PCF from the BSF. The NEF forwards received parameters to the PCF in the Npcf_PolicyAuthorization_Create request. Any received period of time or traffic volume mapped and forwarded as sponsored data connectivity information.

If the AF is considered to be trusted by the operator, the AF uses the Npcf_PolicyAuthorization_Create request message to interact directly with PCF to request reserving resources for an AF session.

If the NEF determines to invoke the TSCTSF, the NEF forwards received parameters in the Ntsctsf_QoSandTSCAssistance_Create request message to the TSCTSF. Any received period of time or traffic volume is mapped and forwarded as sponsored data connectivity information.

If the AF is considered to be trusted by the operator, the AF uses the Ntsctsf_QoSandTSCAssistance_Create request message to interact directly with TSCTSF to request reserving resources for an AF session. A TSCTSF address may be locally configured (a single TSCTSF per DNN/S-NSSAI) in the NEF, PCF and trusted AF. Alternatively, the NEF uses the AF Identifier to determine the DNN/S-NSSAI and uses the DNN/S-NSSAI to discover the TSCTSF from the NRF.

The TSCTSF determines whether it has an AF session with a PCF for the given UE address. In this case the TSCTSF sends a Npcf_PolicyAuthorization_Update request message to the PCF and forwards the received parameters after executing the adjustment and mapping actions described below. If the TSCTSF does not have an AF-session for a given UE address, the TSCTSF discovers the PCF and a Npcf_PolicyAuthorization_Create request message to the PCF.

If the TSCTSF receives a Requested 5GS Delay, the TSCTSF calculates a Requested PDB by subtracting the UE-DS-TT Residence Time (either provided by the PCF or preconfigured at TSCTSF) from the Requested 5GS Delay and sends the Requested PDB to the PCF instead of the Requested 5GS Delay. If the TSCTSF receives any of the following parameters: flow direction, Burst Arrival Time, Periodicity, Time domain, Survival Time from the NEF, the TSCTSF determines the TSC Assistance Container and sends it to the PCF instead of these parameters.

In an example, for requests received from the NEF, the PCF determines whether the request is authorized and notifies the NEF if the request is not authorized. If the request is authorized, the PCF derives the required QoS parameters of the PCC rule based on the information provided by the NEF and determines whether this QoS is allowed (according to the PCF configuration) and notifies the result to the NEF. If the AF is considered to be trusted by the operator, the PCF sends the Npcf_PolicyAuthorization_Create response message directly to AF. If the PCF receives the individual QoS parameters instead of QoS Reference, the PCF determines a 5QI that matches the individual QoS.

In an example, if the request received from the NEF is for the per packet performance measurement, and the PCF authorize the request for the AF session, the PCF may determine that the SMF needs updated policy information, the PCF issues a Npcf_SMPolicyControl_UpdateNotify request with updated policy information about a PDU Session of the UE or the AF. In an example, the PCF may initiate SM policy association modification procedure.

In an example, if the AF is considered to be trusted by the operator, the TSCTSF sends the Ntsctsf_QoSandTSCAssistance_Create response message directly to AF. The NEF may send a Nnef_AFsessionWithQoS_Create response message (Transaction Reference ID, Result) to the AF. Result indicates whether the request is granted or not. The NEF may send a Npcf_PolicyAuthorization_Subscribe message to the PCF to subscribe to notifications of Resource allocation status and may subscribe to other events. The TSCTSF may send a Npcf_PolicyAuthorization_Subscribe message to the PCF to subscribe to notifications of Resource allocation status and may subscribe to other events. When the event condition is met, e.g., that the establishment of the transmission resources corresponding to the QoS update succeeded or failed, the PCF sends Npcf_PolicyAuthorization_Notify message to the NEF notifying about the event.

In an example, the AF may send Nnef_AFsessionWithQoS_Revoke request to NEF in order to revoke the AF request. The NEF authorizes the revoke request and triggers the Ntsctsf_QoSandTSCAssistance_Delete/Unsubscribe and/or Npcf_PolicyAuthorization_Delete and the Npcf_PolicyAuthorization_Unsubscribe operations for the AF request.

In an example embodiment, if the PCF determines that the SMF needs updated policy information, the PCF issues a Npcf_SMPolicyControl_UpdateNotify request with updated policy information about the PDU Session and perform the PCF initiated SM Policy Association Modification procedure.

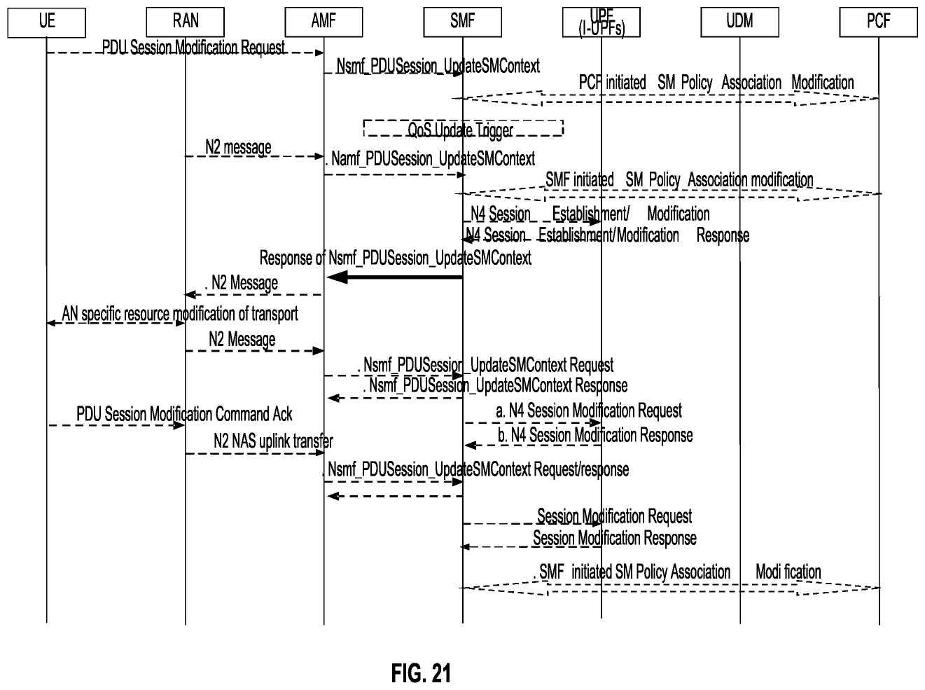

FIG. 21 illustrates an example configuration procedure based on a network triggered signaling procedure in a network in accordance with embodiments of the present disclosure. The example embodiment may enhance the signaling performance of the network by triggering a PDU session modification or network initiated signaling to perform authorization and configuration of the per packet performance measurement. In an example embodiment, an authorization of the request for per packet performance measurement by the PCF may trigger a network initiated signalling procedure such as a PDU session modification, service request procedure, and/or the like. In an example, the PCF may notify the authorization to the SMF and the SMF may trigger the signalling procedure.

In an example, during the PDU Session modification procedure, if the per packet QoS monitoring or the per packet performance measurement is triggered or requested, the following procedure may be performed. If the SMF determines the need for the per packet QoS monitoring or the per packet performance measurement or QoS Monitoring for a QoS flow according to the information received from the PCF, or based on SMF local policy, the SMF may include the per packet QoS monitoring or the per packet performance measurement indication and how frequently the per packet QoS monitoring or the per packet performance measurement and reporting to be performed, in Nsmf_PDUSession_Update Request message. In an example, according to the information received from the PCF, or based on SMF local policy, the SMF may determine the need for the per packet QoS monitoring or the per packet performance measurement or GTP-U Path Monitoring, the SMF may include per packet QoS monitoring policy or the per packet performance measurement policy, or QoS monitoring policy in Nsmf_PDUSession_Update Request message.

In an example, if the SMF (or I-SMF) received the per packet QoS monitoring or the per packet performance measurement indication, and may receive how frequently the per packet QoS monitoring or the per packet performance measurement and reporting to be performed in Nsmf_PDUSession_Update Request the SMF (or I-SMF) includes the per packet QoS monitoring or the per packet performance measurement indication and how frequently the per packet QoS monitoring or the per packet performance measurement and reporting to be performed in N2 SM message sent to the 5G AN.

In an example, if the SMF (or I-SMF) received the per packet QoS monitoring or the per packet performance measurement policy indication and may receive how frequently the per packet QoS monitoring or the per packet performance measurement and reporting to be performed in Nsmf_PDUSession_Update Request, the SMF (or I-SMF) includes such the per packet QoS monitoring or the per packet performance measurement policy also to UPF (or I-UPF) for GTP-U path monitoring and per packet performance measurement monitoring.

In an example, the SMF (or I-SMF) may send Nsmf_PDUSession_Update Response to the SMF. The SMF updates N4 session of the UPF PSA.

In an example, if the RAN provides over N2 the per packet QoS monitoring or the per packet performance measurement Result or the report with UL packet delay information comprising the single packet delays of RAN and N3 interface, the SMF (or I-SMF) forwards this information to the SMF in Nsmf_PDUSession_Update Request message. The SMF (or I-SMF) may forward monitoring report (for the per packet QoS monitoring or the per packet performance measurement (e.g., per GTP-U path, per QoS flow, or per PDU session)) from the UPF (or I-UPF) to the SMF.

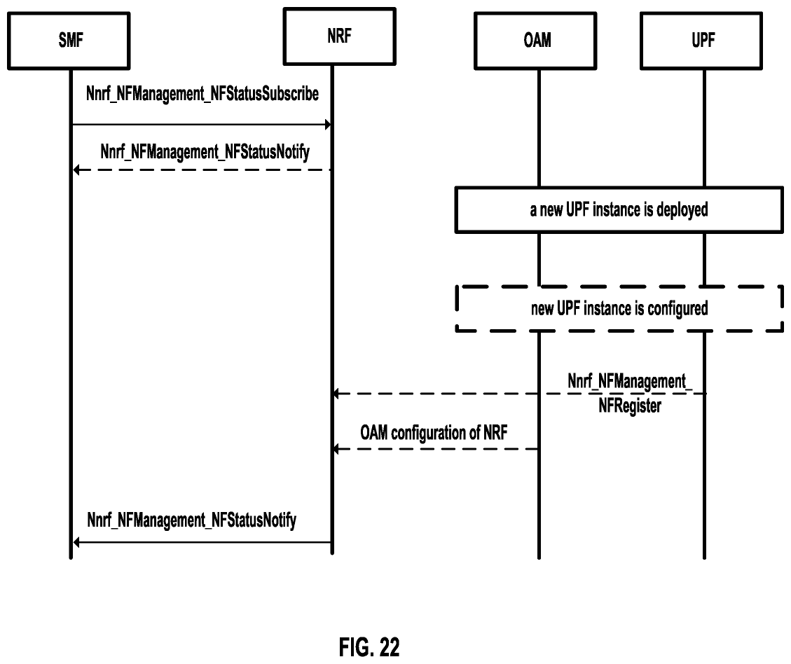

FIG. 22 illustrates an example procedure for configuration and allocation of network resources accordance with embodiments of the present disclosure. The example embodiment may enhance the performance of the network by selecting the network nodes that support per packet performance measurement functionality. In an example embodiment, the SMF or the core network node may be provisioned of available UPFs using the NRF. In an example embodiment, the SMF or the core network node may perform provisioning of available UPFs using the NRF. In an example, provisioning of available UPFs in SMF using the NRF may be as follows. This procedure may be employed prior to selecting the UPF for PDU Sessions and may be followed by N4 Node Level procedures where the UPF and the SMF exchange information such as the support of per packet performance measurement/reporting functionalities and capabilities. In an example, a UPF may register in the NRF. This registration phase may employ the Nnrf_NFManagement_NFRegister operation (e.g., send register message from UPF to the NRF). For the purpose of SMF provisioning of available UPFs, the SMF may employ the Nnrf_NFManagement_NFStatusSubscribe, Nnrf_NFManagement_NFStatusNotify and Nnrf_NFDiscovery services to learn about available UPFs. In an example, UPFs may be associated with UPF Provisioning Information in the NRF. The UPF Provisioning Information may comprise: a list of (S-NSSAI, DNN), UE IPv4 Address Ranges and/or IPv6 Prefix Range(s) per (S-NSSAI, DNN), per packet QoS monitoring or the per packet performance measurement capability/support indication, a SMF Area Identity the UPF can serve. The SMF Area Identity allows limiting the SMF provisioning of UPF(s) using NRF to those UPF(s) associated with a certain SMF Area Identity. This can e.g., be used if an SMF is only allowed to control UPF(s) configured in NRF as belonging to a certain SMF Area Identity. In an example, the UPF Provisioning Information may comprise the supported ATSSS steering functionality, i.e. whether MPTCP functionality or ATSSS-LL functionality or both are supported.

In an example, the UPF provisioning information may comprise the supported UPF event exposure service and supported Event IDs, e.g., per packet QoS monitoring or the per packet performance measurement capability/support indication to the AF or e.g., events for data collection to NWDAF by Nupf_EventExposure_Notify. The UPF Provisioning Information may comprise the supported UPF event exposure service and supported Event IDs, e.g. local notification of QoS Monitoring to AF or e.g., events for data collection to NWDAF by Nupf_EventExposure_Notify.

In an example embodiment as in FIG. 21, SMF provisioning of UPF instances using NRF may be performed as follows. This procedure may be employed when a SMF wants to get informed about UPFs available in the network and supporting a list of parameters. In an example, the SMF may issue (send) a Nnrf_NFManagement_NFStatusSubscribe Service Operation providing the target UPF Provisioning Information it is interested in. In an example, the NRF may send (issue) Nnrf_NFManagement_NFStatusNotify with the list of all UPFs that currently meet the SMF subscription. This notification indicates the subset of the target UPF Provisioning Information that is supported by each UPF (e.g., per packet QoS monitoring or the per packet performance measurement capability/support indication). In an example, when a new UPF instance is deployed, the UPF instance may be configured with the NRF identity to contact for registration and with its UPF Provisioning Information (e.g., comprising the per packet QoS monitoring or the per packet performance measurement capability/support indication). In an example, the UPF instance may send (issue) an Nnrf_NFManagement_NFRegister Request operation providing its NF type, the FQDN or IP address of its N4 interface and the UPF Provisioning Information. In an example, an OAM may register the UPF on the NRF indicating the same UPF Provisioning Information. Based on the subscription, the NRF may send (issue) Nnrf_NFManagement_NFStatusNotify to all SMFs with a subscription matching the UPF Provisioning Information of the new UPF.

In an example embodiment, UPF selection may be performed by the NRF or assisted by the NRF. In an example, the SMF may utilize the NRF to discover the UPF instance(s); In that case, the SMF may send a discovery request message (e.g., a discovery request, an Nnrf_NFDiscovery_Request message, and/or the like) to the NRF. The discovery request message may comprise one or more required capabilities. In an example, the one or more required capabilities may be the per packet QoS monitoring or the per packet performance measurement capability/support functionality, the traffic routing capability, the network function type of the network function, the list of supported S-NSSAIs, DNN, DNAI, connectivity requirements (e.g., N3 and/or intra PLMN N9, inter PLMN N9 and/or N6). In an example, upon receiving the discovery request message, the NRF may select the UPF based on the per packet QoS monitoring or the per packet performance measurement capability/support functionality and/or the one or more required capabilities. In an example, in response to receiving the discovery request message, the NRF may send a response message to the SMF. The response message may comprise the identifier e.g., the FQDN, and/or the IP address of the network function (the selected UPF) that supports per packet QoS monitoring or the per packet performance measurement capability/support functionality. In an example, the NRF may provide the SMF with information to assist UPF selection (e.g., including UPF location, the identifier of the UPF, UPF capacity, and UPF optional functionalities and capabilities, and/or the like).

In an example embodiment, SMF selection may be performed by the NRF or assisted by the NRF. In an example, the AMF (or a control plane network node such as NEF) may utilize the NRF to discover the SMF instance(s) that support operations such as per packet performance measurement; In that case, the AMF (or a control plane network node) may send a discovery request message (e.g., a discovery request, an Nnrf_NFDiscovery_Request message, and/or the like) to the NRF. The discovery request message may comprise one or more required capabilities. In an example, the one or more required capabilities may be the per packet QoS monitoring or the per packet performance measurement capability/support functionality, the traffic routing capability, the network function type of the network function, the list of supported S-NSSAIs, DNN, DNAI, connectivity requirements (e.g., N3 and/or intra PLMN N9, inter PLMN N9 and/or N6). In an example, upon receiving the discovery request message, the NRF may select the SMF based on the per packet QoS monitoring or the per packet performance measurement capability/support functionality and/or the one or more required capabilities. In an example, in response to receiving the discovery request message, the NRF may send a response message to the AMF (or a control plane network node) in response to the discovery request message. The response message may comprise the identifier e.g., the FQDN, and/or the IP address of the network function (the selected SMF) that supports per packet QoS monitoring or the per packet performance measurement capability/support functionality. In an example, the NRF may provide the AMF (or a control plane network node) with information to assist SMF selection (e.g., including SMF location, the identifier of the SMF, SMF capacity, and SMF optional functionalities and capabilities, and/or the like).

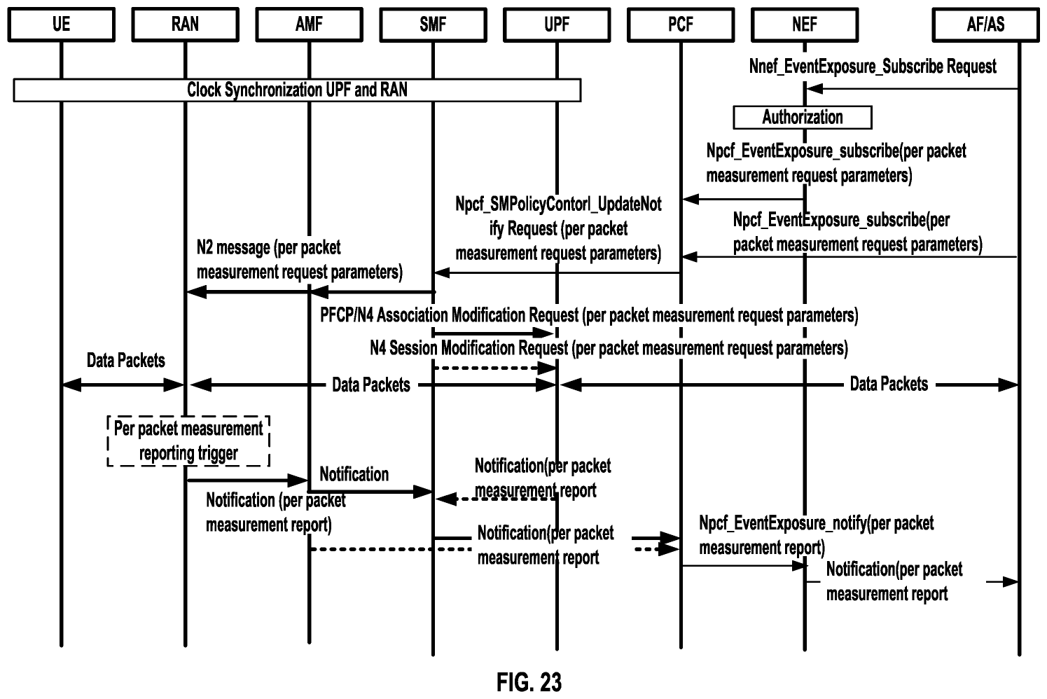

In an example embodiment as depicted in FIG. 23, the AF may send a request to the NEF. The request may be Nnef_EventExposure_Subscribe Request, a session create request such as AFSessionWithQoS Create request to subscribe the events notifications, receiving the report, and/or the like, which may comprise a request for receiving the performance measurement report for the single packet. In an example, the request (e.g., the session create request, Nnef_EventExposure_Subscribe Request, and/or the like) may comprise a request for per packet performance measurement, or a request send the performance measurement report for the single packet. In an example, the request (e.g., the session create request, Nnef_EventExposure_Subscribe Request, and/or the like) may comprise a parameter indicating configuration of the per packet performance measurement. In an example, the parameter may comprise at least one of an indication to start per packet performance monitoring, an indication to stop per packet performance monitoring, an indication of uplink or downlink direction, a time duration of per packet monitoring, a periodicity of per packet monitoring, a periodicity of per packet reporting, a condition for per packet reporting, a packet count for per packet monitoring, and/or the like.

In an example, the AF may send this subscription message to request that the network send the performance measurement report for the single packet.

In an example, the AF may send a request to send the performance measurement report for the single packet to the NEF, the PCF, the UPF, and/or the like.

In an example embodiment, the NEF (and/or the AF) may send to the PCF a message to send the performance measurement report for the single packet or to request or subscribe to an event exposure (notification). In an example, the message may be (comprise) a message/procedure from an Npcf_EventExposure service. In an example, the service may enable an NF to subscribe and get notified about PCF events for a single packet, a PDU session, a GTP-U path, a QoS flow, a network slice (S-NSSAI), a DNN, a group of UE(s) or any UE accessing a combination of (DNN, S-NSSAI), and/or the like. In an example, the following service operations may be employed for the Npcf_EventExposure service:
Npcf_EventExposure_Subscribe.
Npcf_EventExposure_UnSubscribe.
Npcf_EventExposure_Notify.

In an example, the Npcf_EventExposure_Subscribe message may comprise the following. The consumer NF may employ this service operation to subscribe to, modify event reporting, or request send the performance measurement report for the single packet.

In an example, the Npcf_EventExposure_Subscribe message may comprise at least one of: NF ID, Target of Event Reporting (Internal Group Identifier or indication that any UE accessing a combination of (DNN, S-NSSAI) is targeted, (set of) Event ID(s) (e.g., associated with performance measurement of a single packet, user plane congestion, RAN congestion, and/or the like associated with the network slice or DNN), Notification Target Address (+Notification Correlation ID) and Event Reporting Information.

In an example, the NEF or the NF consumer may subscribe to an event notification by invoking Npcf_EventExposure to the PCF. The PCF may allocate a Subscription Correlation ID for the subscription and responds to the consumer NF with the Subscription Correlation ID. Event receiving NF ID may identify the NF that may receive the event reporting. In an example, the event may comprise the report, or the performance measurement report for the single packet.

In an example, an Npcf_EventExposure_Unsubscribe service operation may be employed to unsubscribe for the event for a group of UE(s) or any UE accessing a combination of (DNN, S-NSSAI).

In an example, the Npcf_EventExposure_Notify message may comprise at least one of the event ID (e.g., associated with performance measurement of a single packet, associated with the event, user plane congestion, RAN congestion, and/or the like), access information associated with the event, the network slice ID (S-NSSAI) associated with the event, DNN ID associated with the event, corresponding UE ID (e.g., GPSI), application ID associated with the event, Notification Correlation Information, time stamp, event specific information, and/or the like.

In an example, when the PCF detects the event subscribed by the NF consumer, the PCF reports the subscribed event together with the Notification Target Address (+Notification Correlation ID) to the Event Receiving NF (e.g., the NEF, AF, and/or the like).

In an example embodiment, the AMF may receive from the RAN node the report, or the performance measurement report for the single packet. For example, the RAN node may send the report, or the performance measurement report for the single packet to the AMF when a trigger condition is met. In an example, the trigger condition may comprise a delay value threshold for reporting e.g., if the delay of a single packet exceeded the threshold, the reporting may be performed. In an example, the AMF may send the report, or the performance measurement report for the single packet to the SMF. In an example, the SMF may send the report, or the performance measurement report for the single packet to the AF. In an example, the SMF may send the report, or the performance measurement report for the single packet to the NEF and the NEF may notify the AF with one or more elements of the report, or the performance measurement report for the single packet.

In an example embodiment, the SMF may receive from the PCF a request for receiving the performance measurement report for the single packet. The request may be a request message for event exposure. In an example, the request message may comprise at least one of the request for receiving the performance measurement report for the single packet, the parameter indicating configuration of the per packet performance measurement, and/or the like. In an example, the SMF may send a message (e.g., a node configuration message) to the UPF to configure the UPF to report per packet performance measurement for the single packet. In an example, the message from the SMF to the UPF may be an N4 association message, packet flow control protocol (PFCP) association message, an N4 association request, N4 association setup/establishment request, N4 association update/modification request, a PFCP association request, a PFCP association setup/establishment request, a PFCP association update/modification request, and/or the like. In an example, the node configuration message sent from the SMF to the UPF may comprise the request for receiving the performance measurement report for the single packet, the parameter indicating configuration of the per packet performance measurement, and/or the like.

In an example embodiment, a PFCP association (or N4 association) may be set up between the CP function and the UP function prior to establishing PFCP sessions (or N4 sessions, PDU sessions, and/or the like) on that UP function. In an example, one PFCP association may be setup between a given pair of CP and UP functions, even if the CP and/or UP function exposes multiple IP addresses. A single PFCP association may also be setup between a SMF set (e.g., one or more SMFs) and a UPF. The CP function and the UP function may support the PFCP association setup procedure initiated by the CP function. The CP function and the UP function may additionally support the PFCP Association Setup procedure initiated by the UP function. A CP function may have PFCP Associations set up with multiple UP functions. A UP function may have PFCP Associations set up with multiple CP functions. A CP function or a UP function may be identified by a unique Node ID. A Node ID may be set to an FQDN or an IP address. When set to an IP address, the node ID may indicate that the CP/UP function may expose one IP address for the PFCP Association signalling. The PFCP entities may accept any new IP address allocated as part of F-SEID other than the one(s) communicated in the Node Id.

In an example, the CP function may be at least one of the SMF, the PCF, the NEF, the AMF, and/or the like. In an example, the UP function may be at least one of the UPF, PGW, SGW, RAN node, and/or the like.

In an example, when a PFCP Association is established with a UP function, the CP function:
may provision node related parameters (i.e. parameters that apply to all PFCP sessions) in the UP function, if any, e.g., PFDs;
may provision the UP function with the list of features (affecting the UP function behaviour) the CP function supports, if any, e.g., support of per packet performance measurement, monitoring and reporting, support of user plane congestion reporting, support of load and/or overload control, and/or the like.
may check the responsiveness of the UP function using the Heartbeat procedures.
may establish PFCP sessions on that UP function;
may refrain from attempting to establish new PFCP sessions on the UP function, if the UP function has indicated that user plane resources associated with the UPF are congested, user plane resources of the network slice on the UPF are congested, the UPF may shut down gracefully, and/or the like.

In an example, when a PFCP Association is established with a CP function, the UP function:
may update the CP function with the list of features it supports;
may update the CP function with its load and/or overload control information, if load and/or overload control is supported by the CP and UP functions;
may update the CP function with congestion level information associated with user plane resources/connections, congestion level information (of user plane resources) associated with a network slice and/or DNN, and/or the like.
may accept PFCP Session related messages from that CP function (unless prevented by other reasons, e.g., user plane congestion, overload, and/or the like);
may check the responsiveness of the CP function using the Heartbeat procedures.
may indicate to the CP function if it will shut down within a graceful period and, when possible, if it fails and becomes out of service;
may report UE IP address usage information to the CP function, if UE IP addresses are allocated by the UP function and the UE IP Address Usage Reporting feature is supported by the CP function.

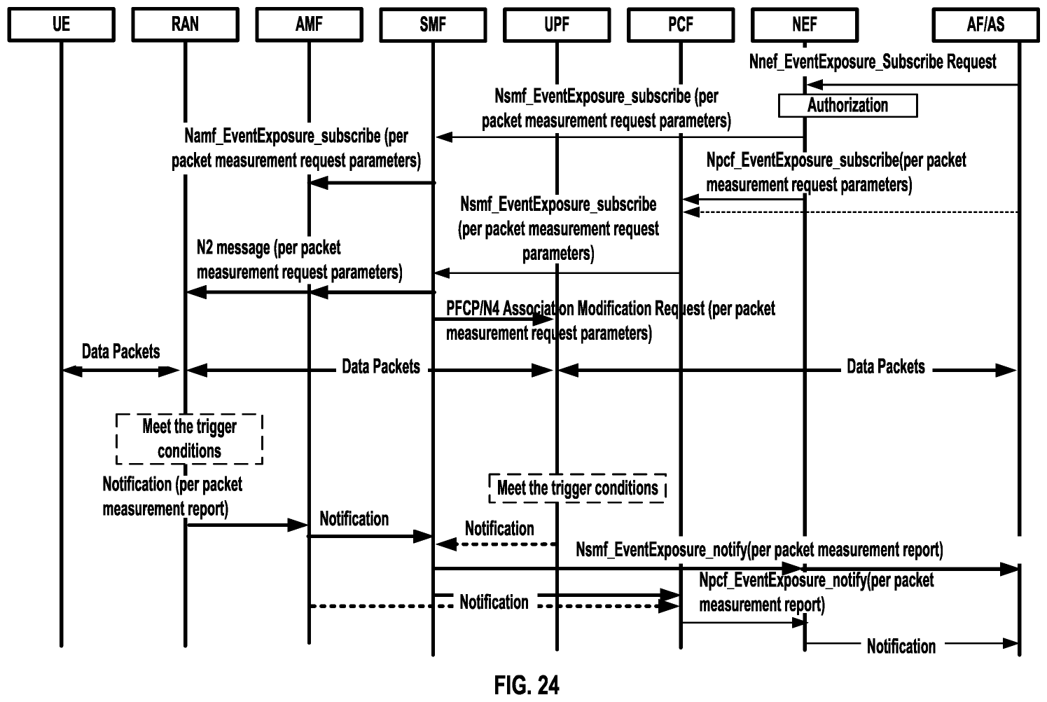

In an example as depicted in FIG. 24, Event exposure services of SMF and/or the AMF may be employed to configure the network to perform per packet performance measurement, monitoring, and reporting (e.g., on a per packet granularity). The example embodiment may enhance the signaling performance of the network by configuring the network to report performance of the network or delay on a per packet basis since the flow level average may not properly assist in detection of network failures. In an example, the configuration may be performed via event exposure services offered by the AMF, and the SMF. In an example, the NEF may send to the SMF an Nsmf_eventExposure_subscribe message that may comprise at least one of the request to report per packet measurement data of a single packet, the parameter indicating configuration of the per packet performance measurement, and/or the like. In an example, the NEF may send to the AMF, an Namf_eventExposure_subscribe message that may comprise at least one of the request to report per packet measurement data of a single packet, the parameter indicating configuration of the per packet performance measurement, and/or the like.

In an example, the AMF in response to receiving the Namf_eventExposure_subscribe message, may configure the RAN node to report per packet performance measurement as per an example embodiment. In an example, the AMF may receive the report (e.g., the per packet performance measurement report as described in example embodiments) from the RAN node. The AMF may send an Namf_eventExposure_notify message to the NEF or the AF comprising the report. The NEF may send the report to the AF or the AS.

In an example as depicted in FIG. 24, the SMF in response to receiving the Nsmf_eventExposure_subscribe message, may configure the UPF node to perform per packet performance measurement, monitoring, and reporting as per an example embodiment (e.g., via N4/PFCP association procedures, the N4/PFCP session procedures, and/or the like). In an example, the SMF may receive the report (e.g., e.g., the per packet performance measurement report as described in example embodiments) from the UPF node. The SMF may send an Nsmf_eventExposure_notify message to the NEF or the AF comprising the report. In an example, the SMF may determine or calculate a performance metric such as delay of the single packet based on the report received from the RAN node and the UPF node. The SMF may send an Nsmf_eventExposure_notify message to the NEF or the AF comprising the delay value. The NEF may send the report or the delay value of the single packet to the AF or the AS.

In an example, the PCF in response to receiving the Npcf_eventExposure_subscribe message, may send a message to the SMF to request per packet performance measurement, monitoring and reporting. In an example, the SMF may configure the UPF node to perform per packet performance measurement, monitoring, and reporting as per an example embodiment (e.g., via N4/PFCP association procedures, the N4/PFCP session procedures, and/or the like). In an example, the SMF may receive the report as described in example embodiments) from the UPF node. The SMF may send a message to the PCF comprising the report or the delay value. The PCF may send the Npcf_eventExposure_notify message to the NEF or the AF comprising the report or the delay value. The NEF may send the report or the delay value to the AF or the AS.

In an example embodiment of the present disclosure, the SMF may request the UPF to perform the per packet performance measurement, monitoring, and reporting during a PFCP session establishment or a PFCP session modification procedure. The SMF may provision one or more QoS Monitoring per packet control Information IEs to instruct the UPF to monitor the packet delay of the single packet. The SMF may request the UPF to stop the on-going QoS monitoring, when needed. The UPF may report the QoS monitoring result of the single packet to the SMF by sending per packet QoS Monitoring Report IEs to the SMF or by reporting the QoS monitoring events directly to the Local NEF or AF. In an example, the QoS may refer to performance measures, delay, and/or the like.

In an example embodiment, if the per packet performance measurement, monitoring, and reporting is required, the SMF may provision at least one of the following IEs included in the QoS Monitoring per packet Information IE:
the parameter indicating configuration of the per packet performance measurement,
the identification parameter of the single packet;
one or more QFI IEs indicating the QoS flow(s) that the single packet may belong to;
a Requested QoS Monitoring IE indicating a request to monitor the downlink packet delay, uplink packet delay, and/or the round trip packet delay between the UPF (PSA) and the RAN node;
a Reporting Frequency IE indicating the frequency for the reporting, such as event triggered, periodic, and/or when the PDU Session is released;
a Packet Delay Thresholds IE indicating thresholds for the downlink packet delay, uplink packet delay, and/or the round trip packet delay to generate the per packet QoS monitoring reports to the CP function node, if the Event Triggered per packet QoS monitoring reporting is required in the reporting frequency.
a Minimum Wait Time IE, to indicate the minimum waiting time between two consecutive reports, if the Event Triggered QoS monitoring reporting is required in the reporting frequency;
a Measurement Period IE, indicating the period to generate periodic usage reports to the CP function if the periodic per packet QoS monitoring reporting is required in the reporting frequency.

In an example, the SMF may require the UPF to stop the on-going per packet QoS monitoring, by sending a PFCP Modification Request with the Remove session reporting rule (SRR) IE, or by sending a PFCP Modification Request with the Update SRR IE within which the previous QoS Monitoring per packet Control IE is removed. Upon receiving such a PFCP Modification Request message, the UPF may stop the on-going QoS monitoring.

In an example, if the Periodic per packet QoS monitoring reporting is required in the reporting frequency, the UPF may generate per packet QoS monitoring report based on the Measurement Period. The UPF may send the per packet QoS Monitoring Report IE to the SMF in PFCP Session Report Request; several per packet QoS Monitoring Report IEs may be present to report the packet delay(s) for multiple single packets (individual packets). The UPF may include the delay value (Downlink, Uplink and/or Round trip) in the per packet QoS Monitoring Measurement IE in the per packet QoS Monitoring Report IE. In an example, the UPF may continue to apply all the provisioned SRR(s) and perform the related per packet QoS monitoring measurement(s), until getting any further instruction from the CP function. When receiving a new threshold (Packet Delay Thresholds, Minimum Wait Time and/or Measurement Period) from the SMF for a measurement that is already ongoing in the UPF, the UPF may consider its ongoing measurements against the new threshold to determine when to send its next per packet QoS monitoring report to the SMF or to the Local NEF or AF. When receiving instruction from the SMF to stop the on-going per packet QoS monitoring, the UPF may generate a per packet QoS monitoring report to the SMF or to the Local NEF or AF (if direct reporting of QoS monitoring event applies), to report the detected single packet delay. At the PFCP session termination, the UPF may include a per packet QoS Monitoring Report IE in the PFCP Session Deletion Response or the UPF may send a per packet QoS monitoring event directly to the Local NEF or AF (if direct reporting of QoS monitoring event applies), if the reporting frequency requests a report to be generated at the PFCP session termination. If the Event Triggered per packet QoS monitoring reporting is required in the reporting frequency, and no time stamp is received in uplink packet for a delay exceeding the Packet Delay Thresholds, the UPF may generate a per packet QoS monitoring report indicating a single packet delay measurement failure to the SMF or to the Local NEF or AF (if direct reporting of QoS monitoring event applies).

In an example embodiment, the SMF may request the UPF to perform the per QoS flow per UE QoS monitoring during a PFCP session establishment or a PFCP session modification procedure. The SMF may provision one or more QoS Monitoring per QoS flow control Information IEs to instruct the UPF to monitor the packet delay(s) of QoS flows. The SMF may request the UPF to stop the on-going QoS monitoring when needed. The UPF may report the QoS monitoring result of the QoS flows to the SMF by sending QoS Monitoring Report IEs to the SMF, or by reporting the QoS monitoring events directly to the Local NEF or AF. In an example, if the per QoS Flow per UE QoS monitoring is required, the SMF may provision the following IEs included in the QoS Monitoring per QoS flow Control Information IE:
one or more QFI IEs indicating the QoS flow(s) required for the QoS monitoring;
a Requested QoS Monitoring IE indicating a request to monitor the downlink packet delay, uplink packet delay, and/or the round trip packet delay between the UPF (PSA) and UE;
a Reporting Frequency IE indicating the frequency for the reporting, such as event triggered, periodic, and/or when the PDU Session is released;
a Packet Delay Thresholds IE indicating thresholds for the downlink packet delay, uplink packet delay, and/or the round trip packet delay to generate the QoS monitoring reports to the CP function, if the Event Triggered QoS monitoring reporting is required in the reporting frequency.
a Minimum Wait Time IE, to indicate the minimum waiting time between two consecutive reports, if the Event Triggered QoS monitoring reporting is required in the reporting frequency;
a Measurement Period IE, indicating the period to generate periodic usage reports to the CP function if the periodic QoS monitoring reporting is required in the reporting frequency.

In an example, the SMF may require the UPF to stop the on-going QoS monitoring, by sending a PFCP Modification Request with the Remove session reporting rule (SRR) IE, or by sending a PFCP Modification Request with the Update SRR IE within which the previous QoS Monitoring per QoS flow Control IE is removed. Upon receiving such a PFCP Modification Request message, the UPF may stop the on-going QoS monitoring.

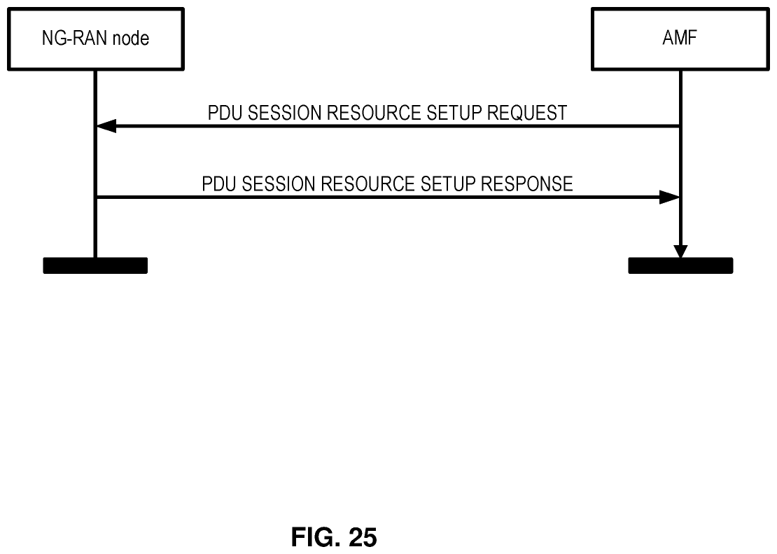

In an example embodiment, configuration of the RAN node may employ signalling between the AMF and the RAN node as depicted in FIG. 25. In an example, a procedure such as the PDU Session Resource Setup procedure may be employed. In an example, the RAN node may be an NG-RAN node. The PDU SESSION RESOURCE SETUP REQUEST message may contain the information required by the NG-RAN node to setup the PDU session related NG-RAN configuration consisting of at least one PDU session resource and include each PDU session resource to setup in the PDU Session Resource Setup Request List IE. Upon reception of the PDU SESSION RESOURCE SETUP REQUEST message, if resources are available for the requested configuration, the NG-RAN node may execute the requested NG-RAN configuration and allocate associated resources over NG and over Uu for each PDU session listed in the PDU Session Resource Setup Request List IE.

In an example, for each PDU session in the PDU SESSION RESOURCE SETUP REQUEST message, if the Additional QoS Flow Information IE is included in the QoS Flow Level QoS Parameters IE in the PDU Session Resource Setup Request Transfer IE of the PDU SESSION RESOURCE SETUP REQUEST message, the NG-RAN node may consider it for the DRB allocation process. For each PDU session in the PDU SESSION RESOURCE SETUP REQUEST message, if the Alternative QoS Parameters Set List IE is included in the GBR QoS Flow Information IE in the PDU Session Resource Setup Request Transfer IE of the PDU SESSION RESOURCE SETUP REQUEST message, the NG-RAN node may accept the setup of the QoS flow when notification control has been enabled if the requested QoS parameters or at least one of the alternative QoS parameters sets can be fulfilled at the time of setup. In case the NG-RAN node accepts the setup fulfilling one of the alternative QoS parameters it may indicate the alternative QoS parameters set which it currently fulfils in the Current QoS Parameters Set Index IE within the PDU Session Resource Setup Response Transfer IE of the PDU SESSION RESOURCE SETUP RESPONSE message. For each QoS flow which has been successfully established, the NG-RAN node may, if supported, store the Redundant QoS Flow Indicator IE if included in the PDU Session Resource Setup Request Transfer IE contained in the PDU SESSION RESOURCE SETUP REQUEST message and consider it for the redundant transmission.

In an example, for each QoS flow which has been successfully established, if the QoS Monitoring Request IE was included in the QoS Flow Level QoS Parameters IE contained in the PDU SESSION RESOURCE SETUP REQUEST message, the NG-RAN node may store this information, and, if supported, perform delay measurement and QoS monitoring for the QoS flow. If the QoS Monitoring Reporting Frequency IE was included in the QoS Flow Level QoS Parameters IE contained in the PDU SESSION RESOURCE SETUP REQUEST message, the NG-RAN node may store this information and, if supported, use it for RAN part delay reporting.

In an example, the PDU SESSION RESOURCE SETUP REQUEST message may comprise a per packet Level QoS Parameters IE. In an example, the AMF may receive the configuration message from the SMF, PCF, NEF, and/or the like. The configuration message may comprise the request for per packet performance measurement of a QoS flow, the parameter indicating configuration of the per packet performance measurement, and/or the like. In an example, for each QoS flow which has been successfully established, if a per packet QoS Monitoring Request IE was included in the QoS Flow Level QoS Parameters IE or the per packet Level QoS Parameters IE contained in the PDU SESSION RESOURCE SETUP REQUEST message (that may comprise the request for per packet performance measurement of a QoS flow, the parameter indicating configuration of the per packet performance measurement, and/or the like), the NG-RAN node may store this information, and, if supported, perform delay measurement and QoS monitoring for the single packet of the QoS flow based on at least one of the request for per packet performance measurement of a QoS flow, the parameter indicating configuration of the per packet performance measurement, and/or the like. If the per packet QoS Monitoring Reporting Frequency IE was included in the per packet QoS Parameters IE contained in the PDU SESSION RESOURCE SETUP REQUEST message, the NG-RAN node may store this information and, if supported, use it for RAN part delay reporting.

In an example embodiment, the configuration message, the N4 message sent from the SMF to the UPF, the N2 message sent from the AMF to the RAN node (or N3IWF), the configuration message sent from the NEF to the UPF, and/or the like may comprise an identifier (e.g., address, IP address, FQDN, and/or the like) of the network or an identifier of an application that receives the per packet performance measurement/report. For example, the network node may be the PPPM, the SMF, the NEF, AF id, application id, and/or the like.

In an example embodiment, the report message may comprise an identifier (e.g., address, IP address, FQDN, and/or the like) of the network or an identifier of an application that receives the per packet performance measurement/report. For example, the network node may be the PPPM, the SMF, the NEF, AF id, application id, and/or the like.

In an example embodiment, a user plane function (UPF) may receive from a network node, a message requesting a per packet performance measurement of a QoS flow. In an example, the message may comprise a parameter indicating configuration of the per packet performance measurement. In an example, the UPF may send to the network node, a report comprising: an identification parameter of a single packet of the QoS flow, performance measurement data of the single packet, and/or the like.

In an example, the UPF may receive from a base station a data packet. The UPF may send the report associated with the packet. In an example, the parameter may comprise at least one of: an indication to start per packet performance monitoring; an indication to stop per packet performance monitoring; an indication of uplink or downlink direction; a time duration of per packet monitoring; a header field indication for the per packet performance measurement; a periodicity of per packet monitoring; a periodicity of per packet reporting; a condition for per packet reporting; a packet count for per packet monitoring, and/or the like. In an example, the message may comprise a packet filter set (e.g., the packet filter set) comprising the identification parameter of the packet. In an example, the identification may uniquely identify a group of fragments of a single IP packet (or a packet, a frame, and/or the like). In an example, the message may comprise a per QoS flow per UE QoS monitoring IE. In an example, the message may comprise a per packet per UE QoS/delay monitoring IE. In an example, the message may be an N4/PFCP session establishment/modification request. In an example, the message may be an N4/PFCP association establishment/modification request. In an example, the UPF may receive from the SMF, an indication to start monitoring of per packet delay. In an example, the UPF may receive from the SMF, an indication to stop monitoring of per packet delay. In an example, the network node may be at least one of: a session management function (SMF); a network exposure function (NEF); an application function (AF); a TSCTSF; a PCF, and/or the like. In an example, the UPF may receive from the SMF, a packet detection rule comprising a packet header field and/or value for detection of single packets subject to per packet performance measurement and reporting. In an example, the UPF may receive from the SMF, at least one of: one or more QoS Monitoring per packet control Information IEs to instruct the UPF to monitor the packet delay of the single packet; one or more QoS Monitoring per QoS flow control Information IEs to instruct the UPF to monitor the packet delay(s) of QoS flows. In an example, the QoS Monitoring per packet Information IE may comprise at least one of: the parameter indicating configuration of the per packet performance measurement; the identification parameter of the single packet; one or more QFI IEs indicating the QoS flow(s) that the single packet may belong to; a Requested QoS Monitoring IE indicating a request to monitor the downlink packet delay, uplink packet delay, and/or the round trip packet delay between the UPF (PSA) and the RAN node; a Reporting Frequency IE indicating the frequency for the reporting, such as event triggered, periodic, and/or when the PDU Session is released; a Packet Delay Thresholds IE indicating thresholds for the downlink packet delay, uplink packet delay, and/or the round trip packet delay to generate the per packet QoS monitoring reports to the CP function node, if the Event Triggered per packet QoS monitoring reporting is required in the reporting frequency a Minimum Wait Time IE, to indicate the minimum waiting time between two consecutive reports, if the Event Triggered QoS monitoring reporting is required in the reporting frequency; a Measurement Period IE, indicating the period to generate periodic usage reports to the CP function if the periodic per packet QoS monitoring reporting is required in the reporting frequency. In an example, the UPF may send to the SMF at least one of: per packet QoS Monitoring Report IEs; and (per QoS flow) QoS Monitoring Report IEs.

In an example embodiment, a user plane function (UPF) may receive from a session management function (SMF), a message requesting a per packet performance measurement request, the message comprising a parameter indicating configuration of the per packet performance measurement. In an example, the UPF may send to the SMF, a report comprising: an identification parameter of a packet, performance measurement data associated with the packet.

In an example embodiment, a session management function (SMF) may receive from a core network node, a first message indicating a per packet performance measurement request, the first message comprising a parameter indicating configuration of the per packet performance measurement. In an example, the SMF may send to the UPF, a second message indicating the per packet performance measurement request, the second message comprising the parameter indicating configuration of the per packet performance measurement In an example, the SMF may receive from the UPF, a first report comprising: a first identification parameter of the packet, performance measurement data associated with the packet, and/or the like. In an example, the SMF may receive from a base station, a second report comprising: performance measurement data associated with the packet at the base station, a second identification parameter of the packet, and/or the like. In an example, the SMF may send to the core network node and based on the first report and the second report, per packet measurement information. In an example, the SMF may send to the core network node and based on the first identification parameter being equal to the second identification parameter, per packet measurement information.

In an example embodiment, a session management function (SMF) may receive from a core network node, a first message indicating a per packet performance measurement request, the first message comprising: an identification parameter of a packet, a parameter indicating configuration of the per packet performance measurement, and/or the like. In an example, the SMF may determine to configure a user plane function for monitoring and reporting of the per packet performance. In an example, the SMF may send to the UPF, a second message indicating the per packet performance measurement request. The second message may comprise: the identification parameter of a packet, the parameter indicating configuration of the per packet performance measurement, and/or the like. In an example, the SMF may receive from the UPF, a first report comprising: a first identification parameter of the packet, performance measurement data associated with the packet and/or the like. In an example, the SMF may receive from a base station via an access and mobility management function (AMF), a second report comprising: a second identification parameter of the packet; and performance measurement data associated with the packet. In an example, the SMF may send to the core network node and based on the first report and the second report, per packet measurement information.

In an example, the parameter may comprise at least one of: an indication to start per packet performance monitoring; an indication to stop per packet performance monitoring; an indication of uplink or downlink direction; a time duration of per packet monitoring; a periodicity of per packet monitoring; a periodicity of per packet reporting; a condition for per packet reporting; a packet count for per packet monitoring; and a header field indication for the per packet performance measurement. In an example, the first message may comprise a packet filter set comprising an identification of a packet (e.g., an IP packet, an Ethernet frame, and/or the like). In an example, the identification uniquely identifies a group of fragments of a single packet (e.g., IP packet, Ethernet frame, and/or the like). In an example, the second message may comprise the packet filter set. In an example, the second message may comprise a per QoS flow per UE QoS monitoring IE. In an example, the second message may comprise a per packet per UE QoS/delay monitoring IE. In an example, the second message may be an N4/PFCP session establishment/modification request. In an example, the second message may be an N4/PFCP association establishment/modification request. In an example, the SMF may send to the UPF, an indication to start monitoring of per packet delay. In an example, the first report may comprise a first time stamp value. In an example, the second report may comprise a second time stamp value. In an example, calculation of delay value by the SMF and based on a time stamp value may be performed. In an example, the SMF may transmit the calculated delay value to a network node.

In an example embodiment, an access and mobility management function (AMF) may receive from a core network node, a first message indicating a per packet performance measurement request, the first message comprising: an identification parameter of a packet, a parameter indicating configuration of the per packet performance measurement, and/or the like. In an example, the AMF may send to a base station, a second message indicating the per packet performance measurement request, the second message comprising: the identification parameter of a packet, the parameter indicating configuration of the per packet performance measurement, and/or the like. In an example, the AMF may receive from the base station, a report comprising performance measurement data associated with the packet. In an example, the AMF may send to the core network node, the report.

In an example embodiment, an access and mobility management function (AMF) may receive from a core network node, a first message indicating a per packet performance measurement request, the first message comprising: an identification parameter of a packet, a parameter indicating configuration of the per packet performance measurement, and/or the like. In an example, the AMF may send to a base station, a second message indicating the per packet performance measurement request, the second message comprising: the identification parameter of a packet, and the parameter indicating configuration of the per packet performance measurement. In an example, the AMF may receive from the base station, a report comprising performance measurement data associated with the packet. In an example, the AMF may send to the core network node, the report.

In an example embodiment, an access and mobility management function (AMF) may receive from a core network node, a first message indicating start of a per packet performance measurement request for an uplink packet direction, the first message comprising a parameter indicating configuration of the per packet performance measurement. In an example, the AMF may send to a base station, a second message indicating start of the per packet performance measurement request for the uplink packet direction, the second message comprising the parameter indicating configuration of the per packet performance measurement. In an example, the AMF may receive from the base station, a report comprising performance measurement data associated with the uplink packet direction. In an example, the AMF may send to the core network node, the report.

In an example, the report may comprise a time stamp associated with the packet. In an example, the parameter may comprise at least one of: an indication to start per packet performance monitoring; an indication to stop per packet performance monitoring; an indication of uplink or downlink direction; a time duration of per packet monitoring; a periodicity of per packet monitoring; a periodicity of per packet reporting; a condition for per packet reporting; a packet count for per packet monitoring; and a header field indication for the per packet performance measurement.

In some aspects, the techniques described herein relate to a method including: receiving, by a user plane function (UPF) from a network node, a message requesting a per packet performance measurement of a QoS flow, the message including a parameter indicating configuration of the per packet performance measurement; and sending, by the UPF to the network node, a report including: an identification parameter of a single packet of the QoS flow; and performance measurement data of the single packet.

In some aspects, the techniques described herein relate to a method, further including: receiving by the UPF from a base station a data packet; and sending by the UPF to the network node the report.

In some aspects, the techniques described herein relate to a method, wherein the parameter includes at least one of: an indication to start per packet performance monitoring; an indication to stop per packet performance monitoring; an indication of uplink or downlink direction; a time duration of per packet monitoring; a header field indication for the per packet performance measurement; a periodicity of per packet monitoring; a periodicity of per packet reporting; a condition for per packet reporting; and a packet count for per packet monitoring.

In some aspects, the techniques described herein relate to a method, wherein the message includes a packet filter set including the identification parameter of the packet.

In some aspects, the techniques described herein relate to a method, wherein the identification uniquely identifies a group of fragments of a single IP packet.

In some aspects, the techniques described herein relate to a method, wherein the message includes a per QoS flow per UE QoS monitoring IE.

In some aspects, the techniques described herein relate to a method, wherein the message includes a per packet per UE QoS/delay monitoring IE.

In some aspects, the techniques described herein relate to a method, wherein the message is an N4/PFCP session establishment/modification request.

In some aspects, the techniques described herein relate to a method, wherein the message is an N4/PFCP association establishment/modification request.

In some aspects, the techniques described herein relate to a method, further including receiving, by the UPF from the SMF, an indication to start monitoring of per packet delay.

In some aspects, the techniques described herein relate to a method, further including receiving, by the UPF from the SMF, an indication to stop monitoring of per packet delay.

In some aspects, the techniques described herein relate to a method, wherein the network node is at least one of: a session management function (SMF); a network exposure function (NEF); an application function (AF); a TSCTSF; and a PCF.

In some aspects, the techniques described herein relate to a method, further including receiving by the UPF from the SMF, a packet detection rule including a packet header field and/or value for detection of single packets subject to per packet performance measurement and reporting.

In some aspects, the techniques described herein relate to a method, further including receiving by the UPF from the SMF, at least one of: one or more QoS Monitoring per packet control Information IEs to instruct the UPF to monitor the packet delay of the single packet; and one or more QoS Monitoring per QoS flow control Information IEs to instruct the UPF to monitor the packet delay(s) of QoS flows.

In some aspects, the techniques described herein relate to a method wherein the QoS Monitoring per packet Information IE includes at least one of: the parameter indicating configuration of the per packet performance measurement; the identification parameter of the single packet; one or more QFI IEs indicating the QoS flow(s) that the single packet may belong to; a Requested QoS Monitoring IE indicating a request to monitor the downlink packet delay, uplink packet delay, and/or the round trip packet delay between the UPF (PSA) and the RAN node; a Reporting Frequency IE indicating the frequency for the reporting, such as event triggered, periodic, and/or when the PDU Session is released; a Packet Delay Thresholds IE indicating thresholds for the downlink packet delay, uplink packet delay, and/or the round trip packet delay to generate the per packet QoS monitoring reports to the CP function node, if the Event Triggered per packet QoS monitoring reporting is required in the reporting frequency. a Minimum Wait Time IE, to indicate the minimum waiting time between two consecutive reports, if the Event Triggered QoS monitoring reporting is required in the reporting frequency; and a Measurement Period IE, indicating the period to generate periodic usage reports to the CP function if the periodic per packet QoS monitoring reporting is required in the reporting frequency.

In some aspects, the techniques described herein relate to a method, further including sending by the UPF to the SMF at least one of: per packet QoS Monitoring Report IEs; and (per QoS flow) QoS Monitoring Report IEs.

In some aspects, the techniques described herein relate to a method including: receiving, by a user plane function (UPF) from a network node, a message requesting a per packet performance measurement, the message including a parameter indicating configuration of the per packet performance measurement.

In some aspects, the techniques described herein relate to a method including: sending, by a user plane function (UPF) to the network node, a report including: an identification parameter of a packet; and performance measurement data associated with the packet.

In some aspects, the techniques described herein relate to a method including: receiving, by a session management function (SMF) from a core network node, a first message indicating a per packet performance measurement request, the first message including: an identification parameter of a packet; and a parameter indicating configuration of the per packet performance measurement; determining, by the SMF to configure a user plane function for monitoring and reporting of the per packet performance; sending, by the SMF to the UPF, a second message indicating the per packet performance measurement request, the second message including: the identification parameter of a packet; and the parameter indicating configuration of the per packet performance measurement; receiving, by the SMF from the UPF, a first report including: a first identification parameter of the packet; and performance measurement data associated with the packet; receiving, by the SMF from a base station via an access and mobility management function (AMF), a second report including: a second identification parameter of the packet; and performance measurement data associated with the packet; sending, by the SMF to the core network node and based on the first report and the second report, per packet measurement information.

In some aspects, the techniques described herein relate to a method, wherein the parameter includes at least one of: an indication to start per packet performance monitoring; an indication to stop per packet performance monitoring; an indication of uplink or downlink direction; a time duration of per packet monitoring; a periodicity of per packet monitoring; a periodicity of per packet reporting; a condition for per packet reporting; a packet count for per packet monitoring; and a header field indication for the per packet performance measurement.

In some aspects, the techniques described herein relate to a method, wherein the first message includes a packet filter set including an identification of an IP packet.

In some aspects, the techniques described herein relate to a method, wherein the identification uniquely identifies a group of fragments of a single IP packet.

In some aspects, the techniques described herein relate to a method, wherein the second message includes the packet filter set.

In some aspects, the techniques described herein relate to a method, wherein the second message includes a per QoS flow per UE QoS monitoring IE.

In some aspects, the techniques described herein relate to a method, wherein the second message includes a per packet per UE QoS/delay monitoring IE.

In some aspects, the techniques described herein relate to a method, wherein the second message is an N4/PFCP session establishment/modification request.

In some aspects, the techniques described herein relate to a method, wherein the second message is an N4/PFCP association establishment/modification request.

In some aspects, the techniques described herein relate to a method, further including sending, by the SMF to the UPF, an indication to start monitoring of per packet delay.

In some aspects, the techniques described herein relate to a method, wherein the first report includes a first time stamp value.

In some aspects, the techniques described herein relate to a method, wherein the second report includes a second time stamp value.

In some aspects, the techniques described herein relate to a method, further including: calculation of delay value by the SMF and based on a time stamp value; and transmitting the calculated delay value to a network node.

In some aspects, the techniques described herein relate to a method including: AMF DL measurement receiving, by an access and mobility management function (AMF), from a core network node, a first message indicating a per packet performance measurement request, the first message including: an identification parameter of a packet; and a parameter indicating configuration of the per packet performance measurement; sending, by the AMF to a base station, a second message indicating the per packet performance measurement request, the second message including: the identification parameter of a packet; and the parameter indicating configuration of the per packet performance measurement; receiving, by the AMF from the base station, a report including performance measurement data associated with the packet; and sending, by the AMF to the core network node, the report.

In some aspects, the techniques described herein relate to a method including: receiving, by an access and mobility management function (AMF), from a core network node, a first message indicating a per packet performance measurement request, the first message including: an identification parameter of a packet; and a parameter indicating configuration of the per packet performance measurement; sending, by the AMF to a base station, a second message indicating the per packet performance measurement request, the second message including: the identification parameter of a packet; and the parameter indicating configuration of the per packet performance measurement; receiving, by the AMF from the base station, a report including performance measurement data associated with the packet; and sending, by the AMF to the core network node, the report.

In some aspects, the techniques described herein relate to a method including: receiving, by an access and mobility management function (AMF), from a core network node, a first message indicating start of a per packet performance measurement request for an uplink packet direction, the first message including a parameter indicating configuration of the per packet performance measurement; sending, by the AMF to a base station, a second message indicating start of the per packet performance measurement request for the uplink packet direction, the second message including the parameter indicating configuration of the per packet performance measurement; receiving, by the AMF from the base station, a report including performance measurement data associated with the uplink packet direction; and sending, by the AMF to the core network node, the report.

In some aspects, the techniques described herein relate to a method, wherein the report includes a time stamp associated with the packet.

In some aspects, the techniques described herein relate to a method, wherein the parameter includes at least one of: an indication to start per packet performance monitoring; an indication to stop per packet performance monitoring; an indication of uplink or downlink direction; a time duration of per packet monitoring; a periodicity of per packet monitoring; a periodicity of per packet reporting; a condition for per packet reporting; a packet count for per packet monitoring; and a header field indication for the per packet performance measurement.

What is claimed is:

1. A method comprising:
receiving, by a user plane function (UPF) from a network node, a message requesting a per packet performance measurement, the message comprising a parameter indicating configuration of the per packet performance measurement.

2. The method of claim 1, further comprising sending, by the UPF to the network node, a report comprising:
an identification parameter of a single packet of the QoS flow; and
performance measurement data of the single packet.

3. The method of claim 2, further comprising receiving by the UPF from a base station a data packet.

4. The method of claim 2, wherein the message comprises a packet filter set comprising the identification parameter of the packet.

5. The method of claim 1, wherein the message comprises at least one of:
a per QoS flow per UE QoS monitoring information element (IE); or
a per packet per UE QoS/delay monitoring IE.

6. The method of claim 1, further comprising receiving, by the UPF from the network node, an indication to:
start monitoring of per packet delay; or
stop monitoring of per packet delay.

7. The method of claim 1, wherein the network node comprises at least one of:
a session management function (SMF);
a network exposure function (NEF);
an application function (AF);
a TSCTSF; and
a PCF.

8. A user plane function (UPF) comprising one or more processors; and memory storing instructions that, when executed by the one or more processors, cause the UPF to:
receive, from a network node, a message requesting a per packet performance measurement, the message comprising a parameter indicating configuration of the per packet performance measurement.

9. The UPF of claim 8, wherein the instructions further cause the UPF to send, to the network node, a report comprising:
an identification parameter of a single packet of the QoS flow; and
performance measurement data of the single packet.

10. The UPF of claim 9, wherein the instructions further cause the UPF to receive, from a base station, a data packet.

11. The UPF of claim 9, wherein the message comprises a packet filter set comprising the identification parameter of the packet.

12. The UPF of claim 8, wherein the message comprises at least one of:
a per QoS flow per UE QoS monitoring information element (IE); or
a per packet per UE QoS/delay monitoring IE.

13. The UPF of claim 8, wherein the instructions further cause the UPF to receive, from the network node, an indication to:
start monitoring of per packet delay; or
stop monitoring of per packet delay.

14. The UPF of claim 8, wherein the network node comprises at least one of:
a session management function (SMF);
a network exposure function (NEF);
an application function (AF);
a TSCTSF; and
a PCF.

15. A non-transitory computer-readable medium comprising memory storing instructions that, when executed by one or more processors, cause a user plane function (UPF) to:
receive, from a network node, a message requesting a per packet performance measurement, the message comprising a parameter indicating configuration of the per packet performance measurement.

16. The non-transitory computer-readable medium of claim 15, wherein the instructions further cause the UPF to send, to the network node, a report comprising:
an identification parameter of a single packet of the QoS flow; and
performance measurement data of the single packet.

17. The non-transitory computer-readable medium of claim 16, wherein the instructions further cause the UPF to receive, from a base station, a data packet.

18. The non-transitory computer-readable medium of claim 16, wherein the message comprises a packet filter set comprising the identification parameter of the packet.

19. The non-transitory computer-readable medium of claim 15, wherein the message comprises at least one of:
a per QoS flow per UE QoS monitoring information element (IE); or
a per packet per UE QoS/delay monitoring IE.

20. The non-transitory computer-readable medium of claim 15, wherein the instructions further cause the UPF to receive, from the network node, an indication to:
start monitoring of per packet delay; or
stop monitoring of per packet delay.
